(19) United States
(12) Patent Application Publication
(10) Pub. No.: US 2023/0256522 A1
(43) Pub. Date: Aug. 17, 2023

(54) HANDHELD POWERED POCKET HOLE DRILL SYSTEM

(71) Applicant: Kreg Enterprises, Inc., Ankeny, IA (US)

(72) Inventors: Neil M. Holland, Cambridge, IA (US); Timothy J. Forbes, Des Moines, IA (US); Scott Schaaf, Ankeny, IA (US); Nathan Scott Combs, Slater, IA (US)

(21) Appl. No.: 18/182,670

(22) Filed: Mar. 13, 2023

Related U.S. Application Data
(63) Continuation-in-part of application No. 17/694,797, filed on Mar. 15, 2022.
(60) Provisional application No. 63/489,813, filed on Mar. 13, 2023.
(60) Provisional application No. 63/319,513, filed on Mar. 14, 2022.
(60) Provisional application No. 63/319,513, filed on Mar. 14, 2022.
(60) Provisional application No. 63/241,777, filed on Sep. 8, 2021.
(60) Provisional application No. 63/161,547, filed on Mar. 16, 2021.

(51) Int. Cl. B23B 47/28; B23B 49/00

(52) U.S. Cl. CPC B23B 47/287; B23B 49/005; B23B 2247/10

(57) ABSTRACT

A handheld powered pocket hole drilling system is provided. The system includes a base assembly having a plate. The plate has a drill bit opening extending through the plate. The system includes a drilling assembly and a drill bit connected to the drilling assembly. A drill guide assembly is operably connected to the base assembly and the drilling assembly. The drilling assembly is movable along the drill guide assembly to extend and retract the drill bit through the drill bit opening at an angle. An actuating assembly is operably connected to the drilling assembly. The actuating assembly is configured to move the drilling assembly and drill bit between a retracted position and an extended position. In some arrangements, the actuating assembly moves a drilling assembly and drill bit rearward and downward to the extended position and a handle of the actuating assembly is moved forward and downward.

### CROSS REFERENCE TO RELATED APPLICATION

This application claims priority to U.S. Provisional Patent Application No. 63/489,813, filed Mar. 13, 2023 and titled “HANDHELD POWERED POCKET HOLE DRILL SYSTEM”, which is fully incorporated by reference herein. This application also claims priority to U.S. Provisional Patent Application No. 63/319,513, filed Mar. 14, 2022 and titled “HANDHELD POWERED POCKET HOLE DRILL SYSTEM”, which is fully incorporated by reference herein. This application is a continuation-in-part utility patent application of U.S. patent application Ser. No. 17/694,797, filed Mar. 15, 2022 and titled “HANDHELD POWERED POCKET HOLE DRILL SYSTEM”, which claims priority to U.S. Provisional Patent Application No. 63/319,513, filed Mar. 14, 2022 and titled “HANDHELD POWERED POCKET HOLE DRILL SYSTEM”, to U.S. Provisional Patent Application No. 63/241,777, filed Sep. 8, 2021 and titled “HANDHELD POWERED POCKET HOLE DRILL SYSTEM”, and to U.S. Provisional Patent Application No. 63/161,547, filed Mar. 16, 2021 and titled “HANDHELD POWERED POCKET HOLE DRILL SYSTEM”, each of the foregoing are hereby fully incorporated by reference herein. This application is also related to U.S. Pat. No. 10,183,338, titled CAM LOCK FENCE SYSTEM AND METHOD OF USE, and which issued Jan. 22, 2019, the entirety of which is hereby fully incorporated by reference herein.

### FIELD OF THE DISCLOSURE

This disclosure relates generally to woodworking tools. More specifically and without limitation, this disclosure relates to a handheld drilling system that provides a plurality of improved functions as well as ease of use.

### Overview

Pocket hole wood joinery involves joining boards by inserting a fastener at an angle through the edge of one workpiece into an adjoining workpiece, thereby joining the two workpieces together. Such joints are commonly used for face frames, cabinet boxes, leg-to-rail joinery in chairs and tables, and so forth. Drill guides or jigs are used to drill the holes through which the fasteners or pocket screws are inserted into the adjoining workpiece.

To facilitate the formation of pocket hole joinery, a crafts person may utilize various pocket hole jigs and drilling systems. Pocket hole jigs are configured to clamp a workpiece in place and help guide a drill bit at an angle into a workpiece thereby forming a pocket hole in the workpiece. The pocket hole formed by this process is configured to receive a screw that is used to screw two workpieces together. However, many pocket hole jigs can be difficult to properly align with a workpiece and can be unnecessarily time consuming and/or unnecessarily inefficient to use when a larger number of pocket holes must be formed. Some stationary drilling systems are configured to quickly form pocket holes. However, these systems are large, heavy, and generally difficult to transport to and use at a worksite.

For the reasons stated above, and for other reasons stated below which will become apparent to those skilled in the art upon reading and understanding the disclosure, there is a need in the art for a pocket hole drilling system that improves upon the state of the art.

Thus, it is an object of at least one embodiment of the disclosure to provide a pocket hole drilling system that improves upon the state of the art.

Another object of at least one embodiment of the disclosure is to provide a pocket hole drilling system that is easy to use.

Yet another object of at least one embodiment of the disclosure is to provide a pocket hole drilling system that is fast and efficient to use.

Another object of at least one embodiment of the disclosure is to provide a pocket hole drilling system that is portable.

Yet another object of at least one embodiment of the disclosure is to provide a pocket hole drilling system that is light weight.

Another object of at least one embodiment of the disclosure is to provide a pocket hole drilling system that is handheld.

Yet another object of at least one embodiment of the disclosure is to provide a pocket hole drilling system that is cost effective.

Another object of at least one embodiment of the disclosure is to provide a pocket hole drilling system that forms accurate pocket holes.

Yet another object of at least one embodiment of the disclosure is to provide a pocket hole drilling system that is safe to use.

Another object of at least one embodiment of the disclosure is to provide a pocket hole drilling system that has a durable design.

Yet another object of at least one embodiment of the disclosure is to provide a pocket hole drilling system that has a long useful life.

Another object of at least one embodiment of the disclosure is to provide a pocket hole drilling system that provides additional functionality for pocket hole jigs and pocket hole joinery. Yet another object of at least one embodiment of the disclosure is to provide a pocket hole drilling system that has a wide variety of uses.

Another object of at least one embodiment of the disclosure is to provide a pocket hole drilling system that has a wide variety of applications.

Yet another object of at least one embodiment of the disclosure is to provide a pocket hole drilling system that prevents or reduces relative movement between the pocket hole jig and the workpiece.

Another object of at least one embodiment of the disclosure is to provide a pocket hole drilling system that avoids the need to clamp the system to a workpiece.

Yet another object of at least one embodiment of the disclosure is to provide a pocket hole drilling system that facilitates the formation of aesthetically pleasing finished products.

Another object of at least one embodiment of the disclosure is to provide a pocket hole drilling system that forms a pocket hole with a single movement of a handle.

Yet another object of at least one embodiment of the disclosure is to provide a pocket hole drilling system that facilitates stable placement when used horizontally.

Another object of at least one embodiment of the disclosure is to provide a pocket hole drilling system that facilitates stable placement when used vertically.

Yet another object of at least one embodiment of the disclosure is to provide a pocket hole drilling system that facilitates easy removal of chips and debris during use.

Another object of at least one embodiment of the disclosure is to provide a pocket hole drilling system that is comfortable to use.

Yet another object of at least one embodiment of the disclosure is to provide a pocket hole drilling system that is more stable than other pocket hole jigs.

Another object of at least one embodiment of the disclosure is to provide a pocket hole drilling system that improves the ergonomics of use.

Yet another object of at least one embodiment of the disclosure is to provide a pocket hole drilling system that easily adjusts to workpieces of various thicknesses.

These and other objects, features, or advantages of at least one embodiment will become apparent from the specification, figures, and claims.

### SUMMARY

In one or more arrangements, a handheld powered pocket hole drilling system is provided. The system includes a base assembly having a plate. The plate has a drill bit opening extending through the plate. The system includes a drilling assembly and a drill bit connected to the drilling assembly. A drill guide assembly is operably connected to the base assembly and the drilling assembly. The drilling assembly is movable along the drill guide assembly to extend and retract the drill bit through the drill bit opening at an angle. An actuating assembly is operably connected to the drilling assembly. The actuating assembly is configured to move the drilling assembly between a retracted position and an extended position. In the extended position, the drill bit extends through the drill bit opening to facilitate drilling a pocket hole in a workpiece. In the retracted position, the drill bit does not extend through the drill bit opening.

In one or more arrangements, a lip is operably connected to the base assembly. When a lower surface of the plate is placed on a workpiece with the lip placed against an edge of the workpiece, the drill bit is positioned to drill a pocket hole in the workpiece when the drilling assembly is moved to the extended position.

In one or more arrangements, the actuating assembly includes a lever having a first handle. When the first handle is moved away from the lip, the actuating assembly moves the drilling assembly toward the lip to the extended position. Conversely, when the first handle is moved toward the lip, the actuating assembly moves the drilling assembly away from the lip to the retracted position. In one or more arrangements, when the first handle is moved away from the lip, the actuating assembly is configured and arranged to transfer a downward force to the base assembly, thereby increasing frictional forces between the plate and the workpiece. In one or more arrangements, when the first handle is moved away from the lip, the actuating assembly is configured and arranged to transfer a lateral force to the lip, thereby increasing frictional forces between the lip and the workpiece.

In one or more arrangements, the system includes an adjustable lip assembly having a sliding lip member, a drill stop assembly, and a rear adjustment assembly. In one or more arrangements, the rear adjustment assembly is configured to simultaneously adjust positions of the sliding lip member and the drill stop assembly to accommodate drilling of pocket holes in workpieces of various thicknesses.

In one or more arrangements, the system includes a front support assembly configured to support a front end of the system in an elevated position above a worktable. In one or more arrangements, the front support assembly includes a pair of extendable support legs that can be moved downward to hold the front end of system at a desired height so the system is correctly positioned on the workpiece for drilling pocket holes.

In one or more arrangements, the system includes one or more retractable guides configured to facilitate positioning of the system on a workpiece.

In one or more arrangements, the system includes an alignment window configured to facilitate positioning of the system for drilling a pocket hole at a desired location on a workpiece. In the arrangement shown, as one example, the alignment window includes a cutout in the rearward edge of the base assembly. In one or more arrangements, the alignment window includes an indicator that indicates the position at which a pocket hole will be formed.

In one or more arrangements, the system includes a safety interlock system configured to disable operation of the system unless the plate is placed on top of the workpiece with sufficient pressure.

In one or more arrangements, the system includes a dust collection system configured to collect dust and/or wood shavings generated from the drilling of pocket holes. In one or more arrangements, the dust collection system is configured to transport dust and/or wood shavings for collection using airflow generated by a cooling fan of the drill motor.

### BRIEF DESCRIPTION OF THE DRAWINGS

FIG. 1 shows an exploded upper rear left perspective view of a pocket hole drilling system, in accordance with one or more arrangements.

FIG. 2 shows an upper rear left perspective view of a pocket hole drilling system, in accordance with one or more arrangements.

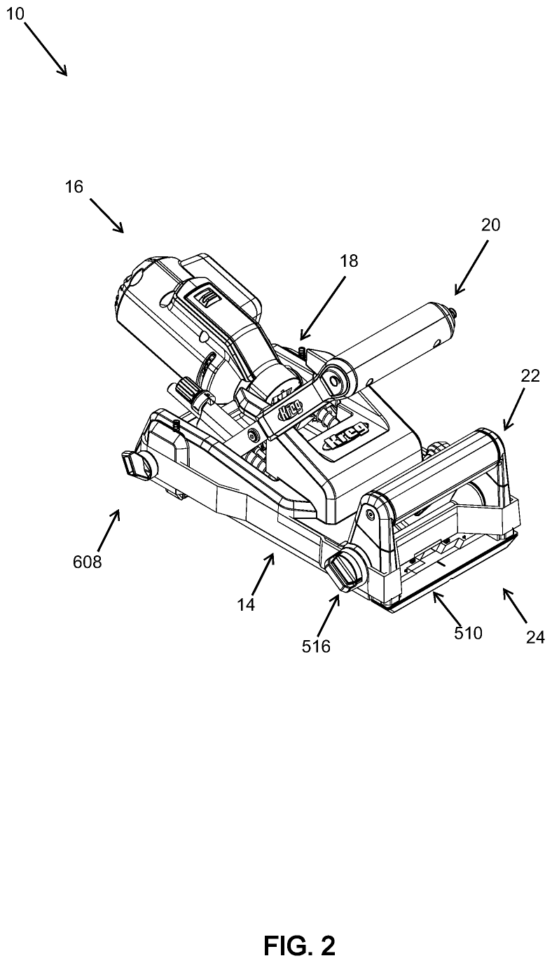

FIG. 3 shows an upper rear right perspective view of a pocket hole drilling system, in accordance with one or more arrangements.

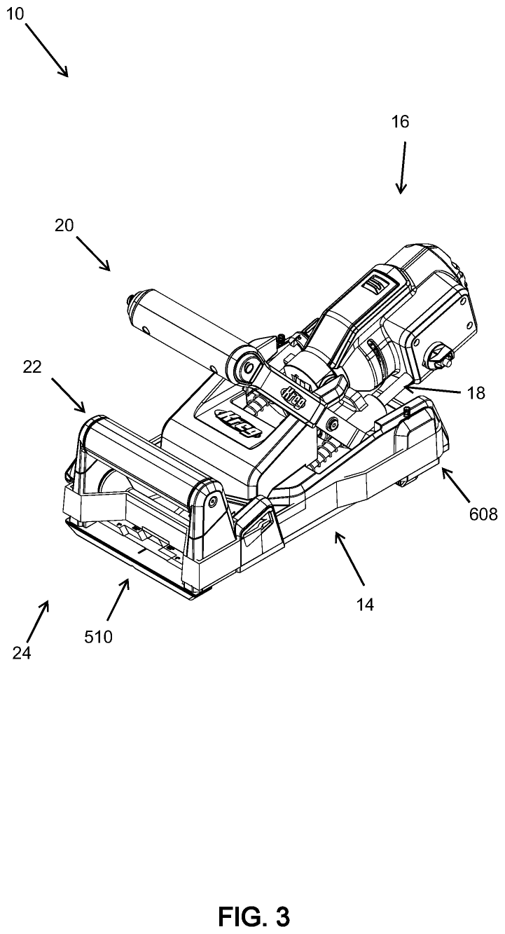

FIG. 4 shows an upper front right perspective view of a pocket hole drilling system, in accordance with one or more arrangements.

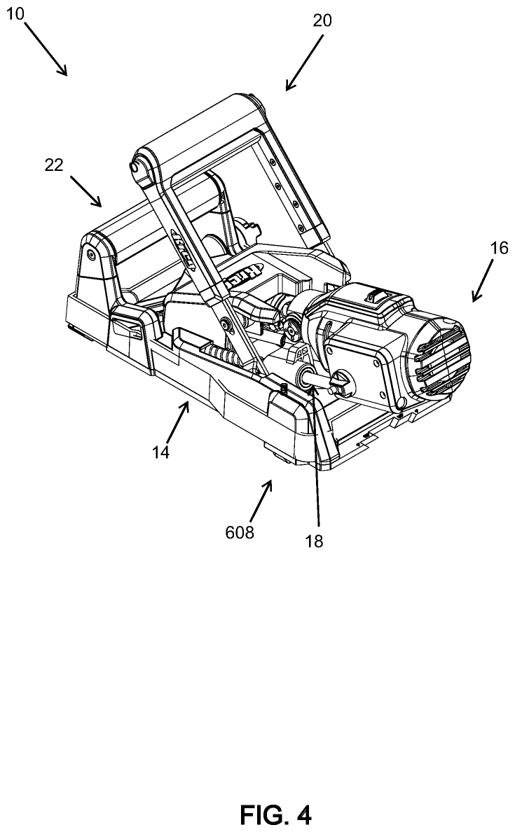

FIG. 5 shows an upper front left perspective view of a pocket hole drilling system, in accordance with one or more arrangements.

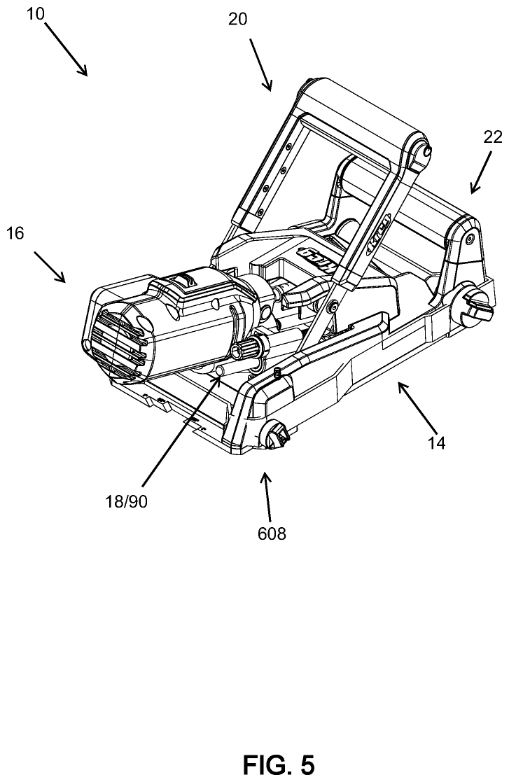

FIG. 6 shows a lower left perspective view of a pocket hole drilling system, in accordance with one or more arrangements.

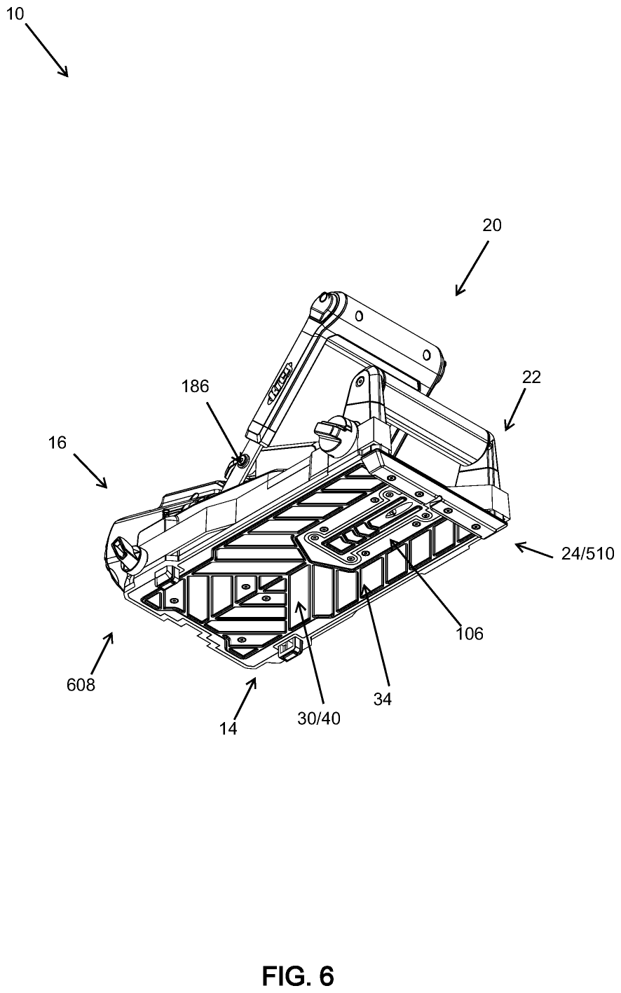

FIG. 7 shows a lower rear right perspective view of a pocket hole drilling system, in accordance with one or more arrangements.

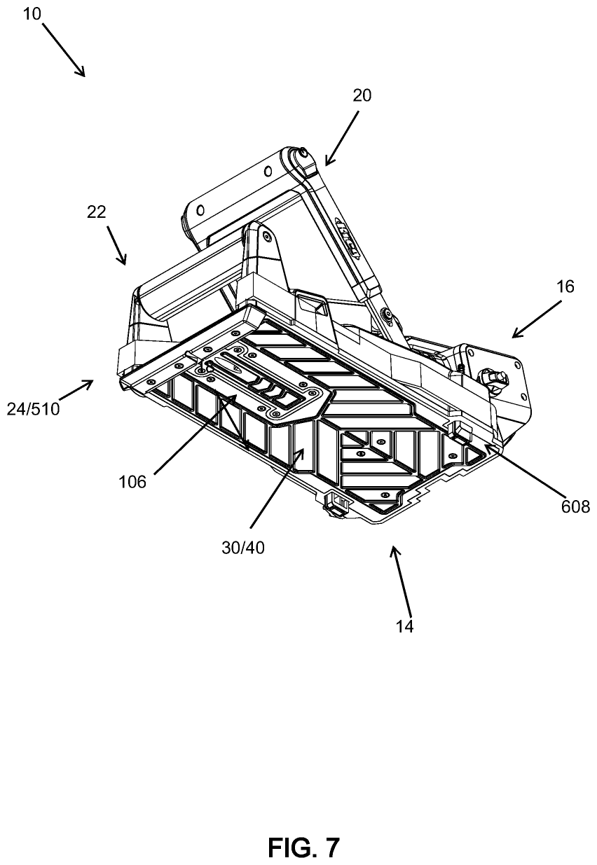

FIG. 8 shows an upper front left perspective view of a pocket hole drilling system, in accordance with one or more arrangements; the view showing the system with the housing omitted.

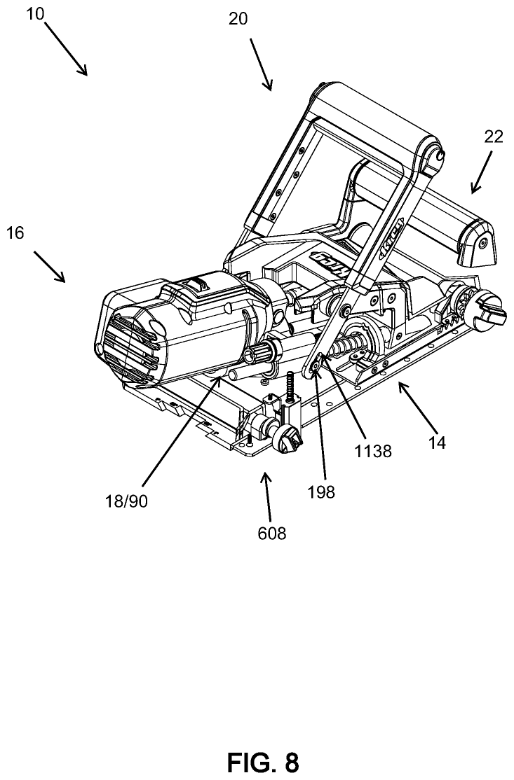

FIG. 9 shows a left side view of a pocket hole drilling system, in accordance with one or more arrangements; the view showing a handle of an actuating assembly in a rearward position and a drilling assembly in a retracted position.

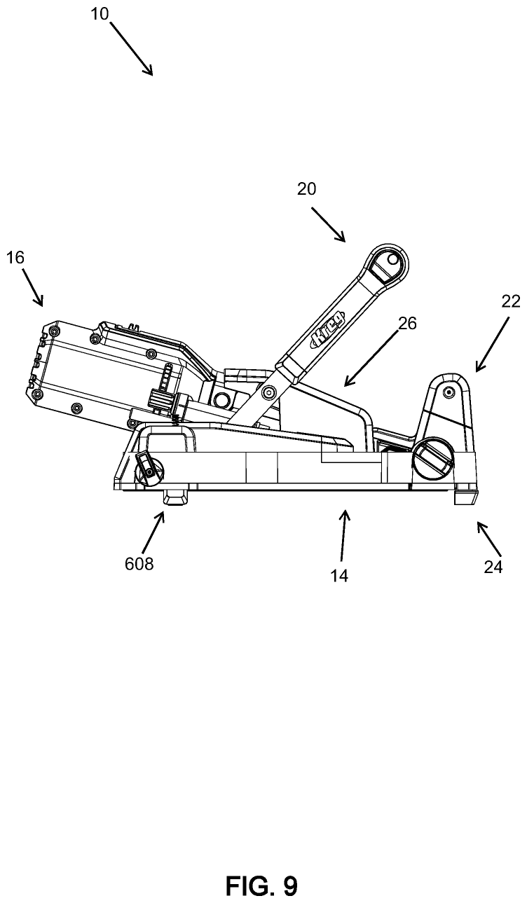

FIG. 10 shows a right side view of a pocket hole drilling system, in accordance with one or more arrangements; the view showing a handle of an actuating assembly in a rearward position and a drilling assembly in a retracted position.

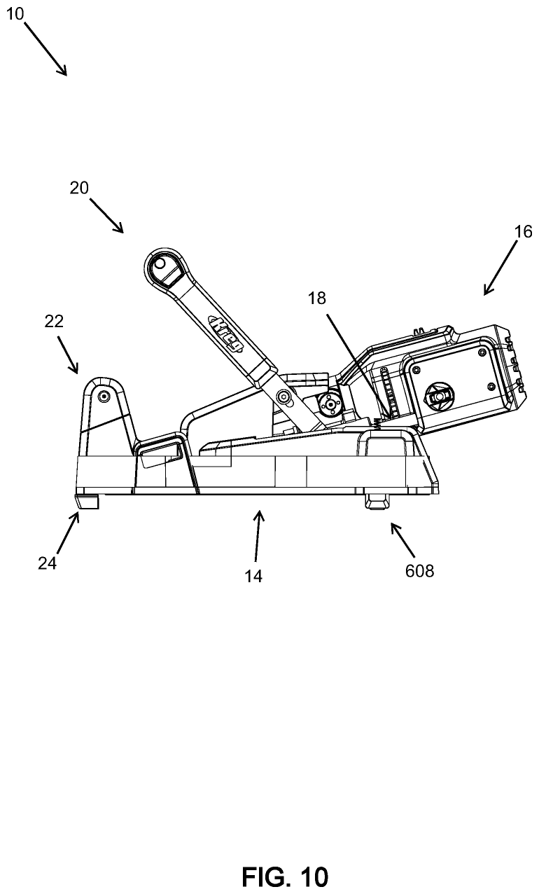

FIG. 11 shows a rear view of a pocket hole drilling system, in accordance with one or more arrangements.

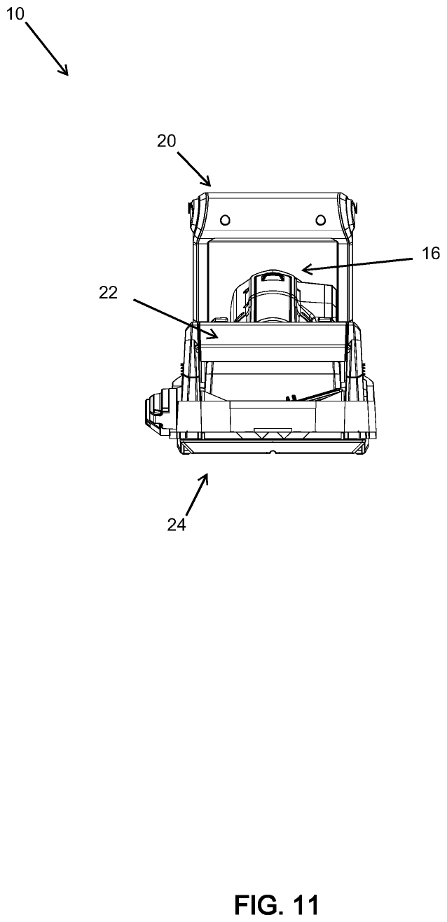

FIG. 12 shows a front view of a pocket hole drilling system, in accordance with one or more arrangements.

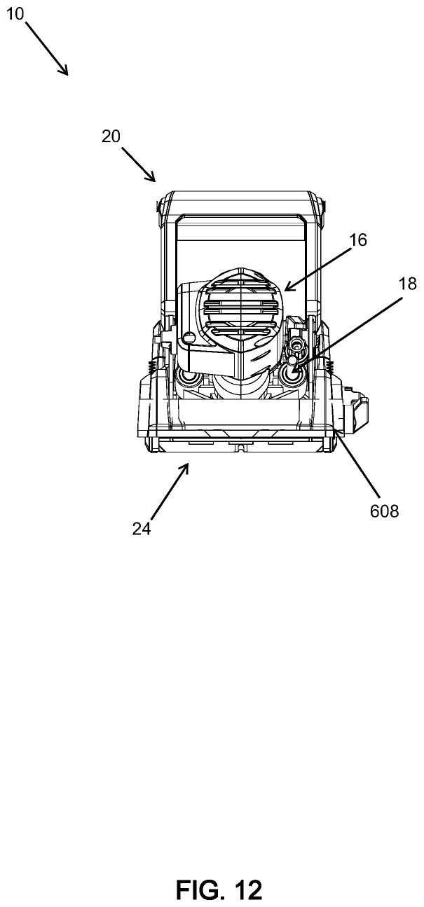

FIG. 13 shows an upper rear left perspective view of a base, drill guide assembly, and actuating assembly of a pocket hole drilling system, in accordance with one or more arrangements.

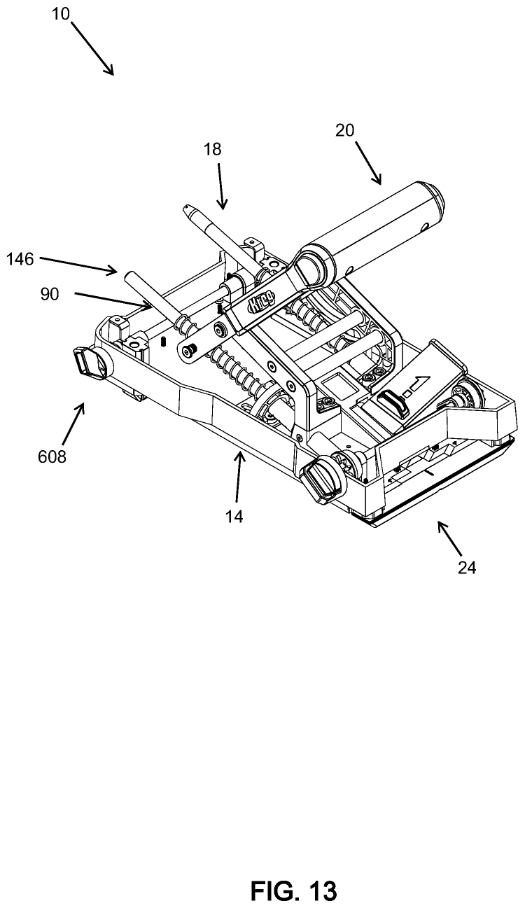

FIG. 14 shows an upper rear right perspective view of a base, drill guide assembly, and actuating assembly of a pocket hole drilling system, in accordance with one or more arrangements.

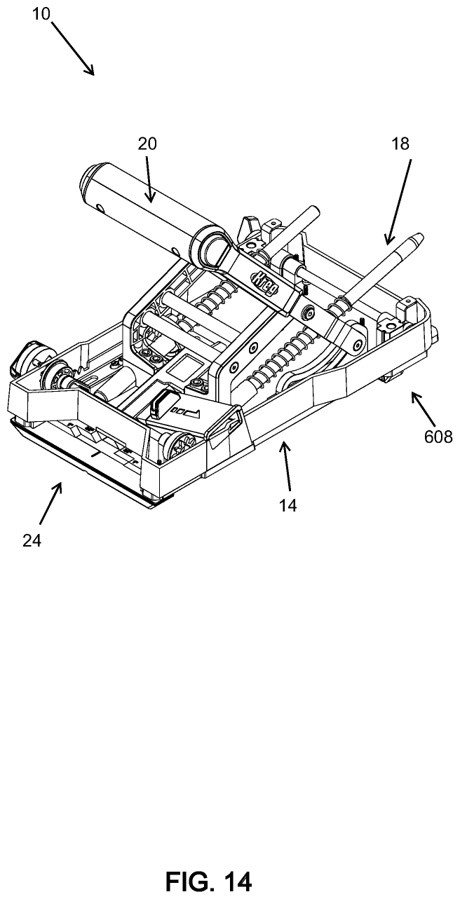

FIG. 15 shows an upper front right perspective view of a base, drill guide assembly, and actuating assembly of a pocket hole drilling system, in accordance with one or more arrangements.

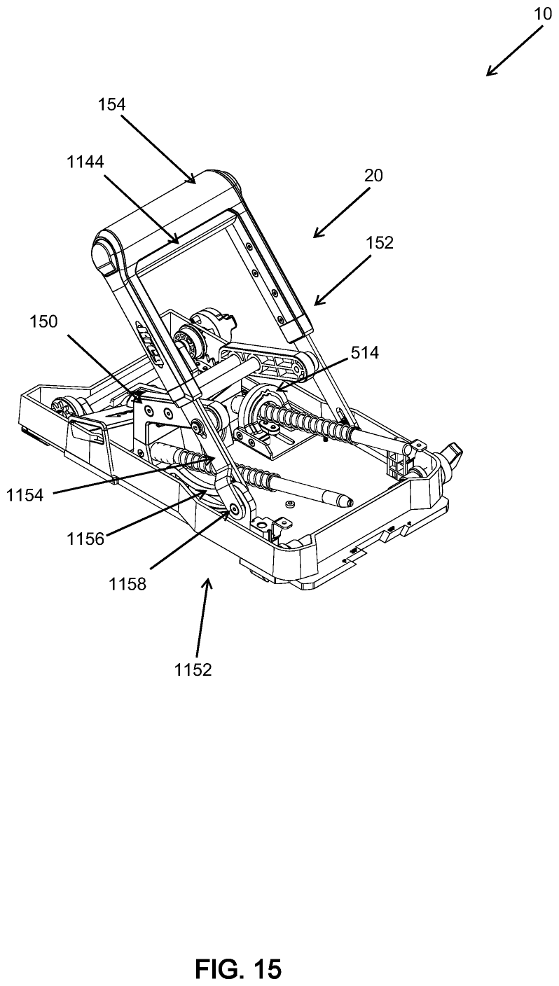

FIG. 16 shows an upper front left perspective view of a base, drill guide assembly, and actuating assembly of a pocket hole drilling system, in accordance with one or more arrangements.

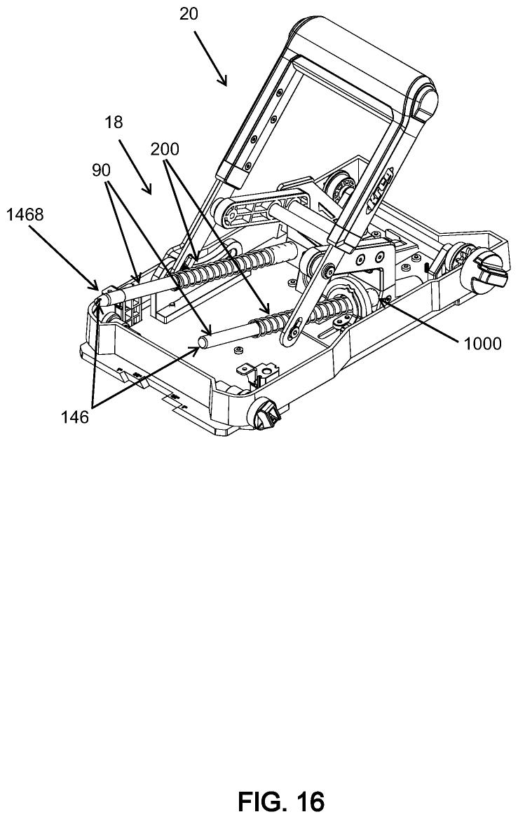

FIG. 17 shows an upper rear right perspective view of a base of a pocket hole drilling system, in accordance with one or more arrangements.

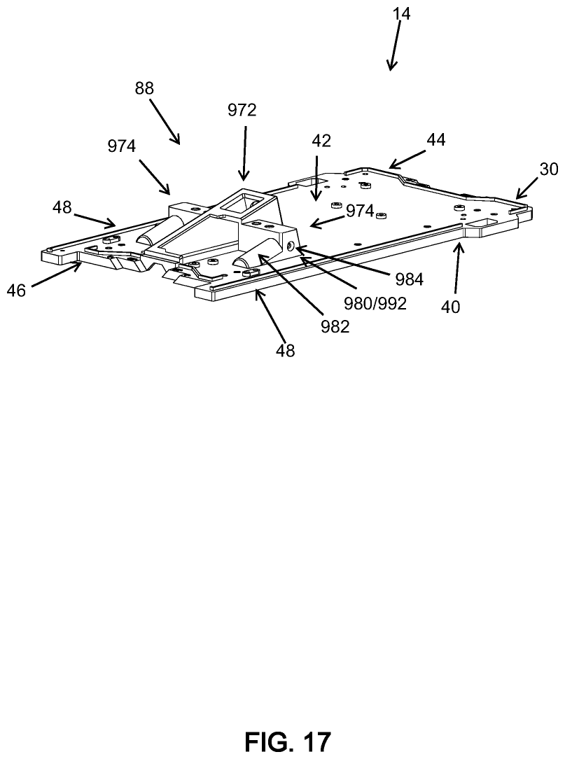

FIG. 18 shows a partial upper rear right perspective view of a base of a pocket hole drilling system, in accordance with one or more arrangements; the view showing a close up view of a guide block of the base.

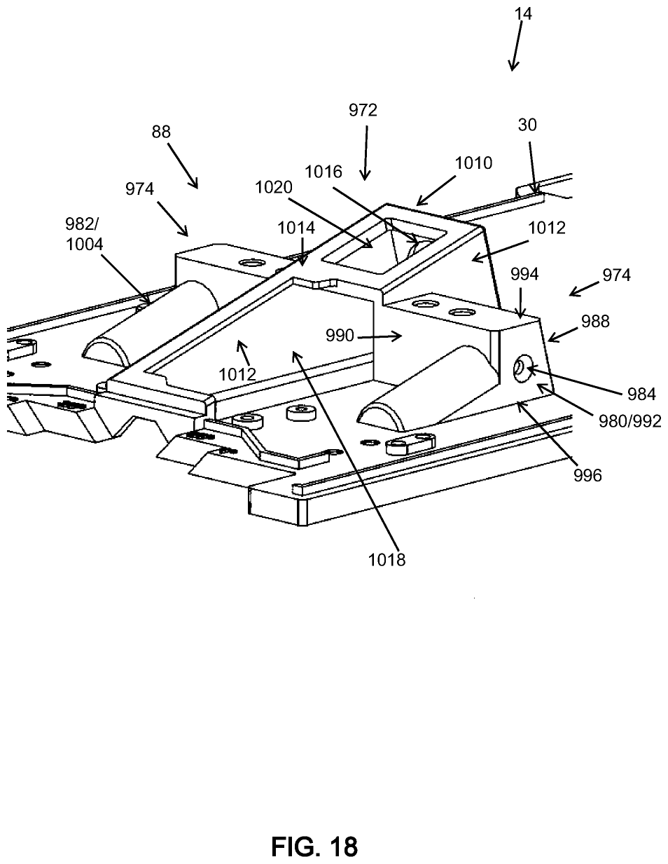

FIG. 19 shows a left view of drill bit guide of a guide block of a base of a pocket hole drilling system, in accordance with one or more arrangements.

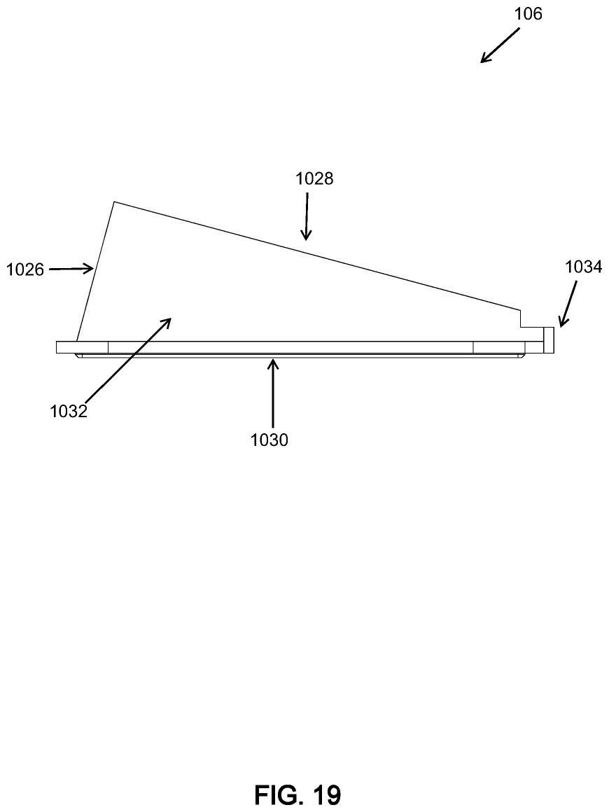

FIG. 20 shows a right view of drill bit guide of a guide block of a base of a pocket hole drilling system, in accordance with one or more arrangements.

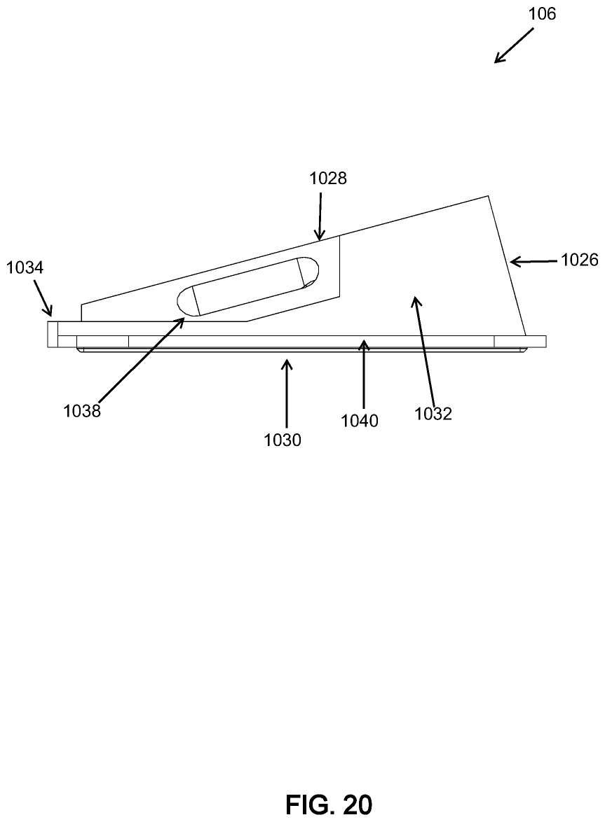

FIG. 21 shows a rear view of drill bit guide of a guide block of a base of a pocket hole drilling system, in accordance with one or more arrangements.

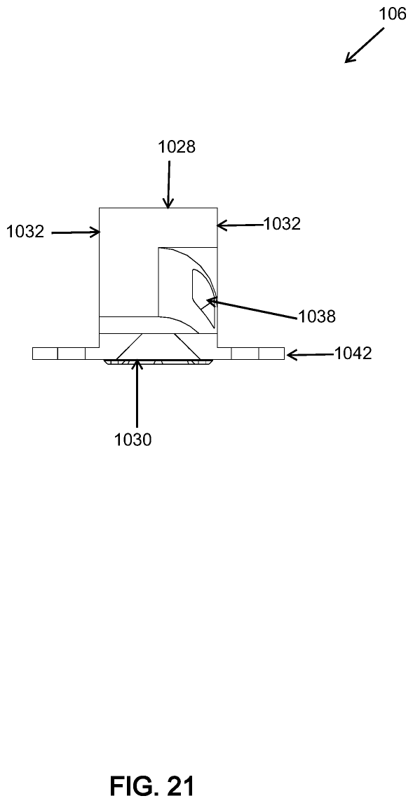

FIG. 22 shows a front view of drill bit guide of a guide block of a base of a pocket hole drilling system, in accordance with one or more arrangements.

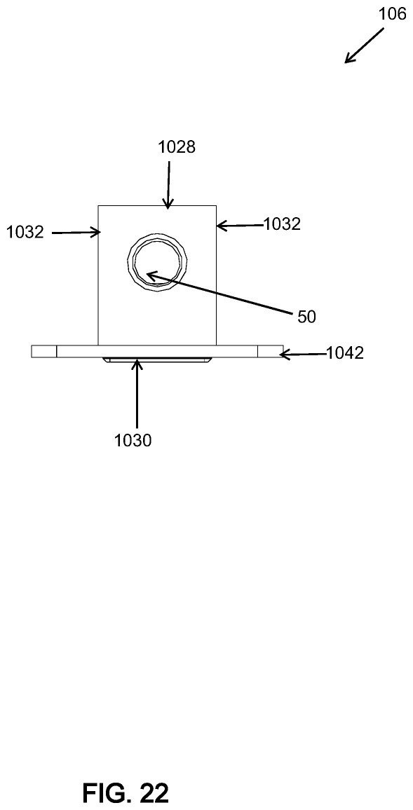

FIG. 23 shows a top view of drill bit guide of a guide block of a base of a pocket hole drilling system, in accordance with one or more arrangements.

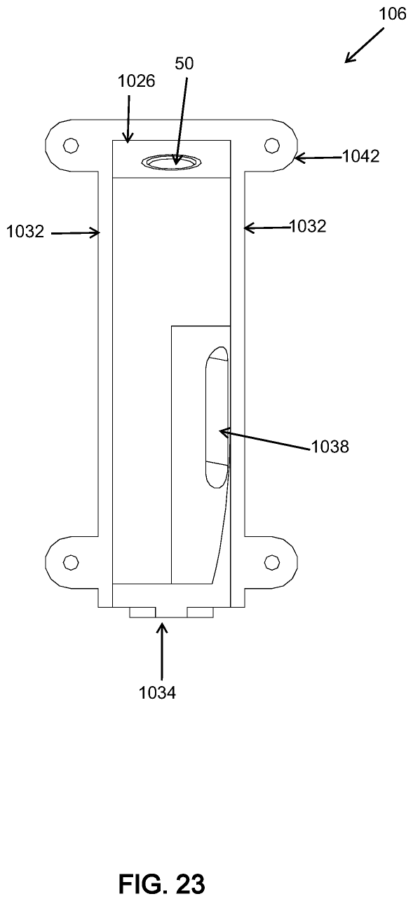

FIG. 24 shows a bottom view of drill bit guide of a guide block of a base of a pocket hole drilling system, in accordance with one or more arrangements.

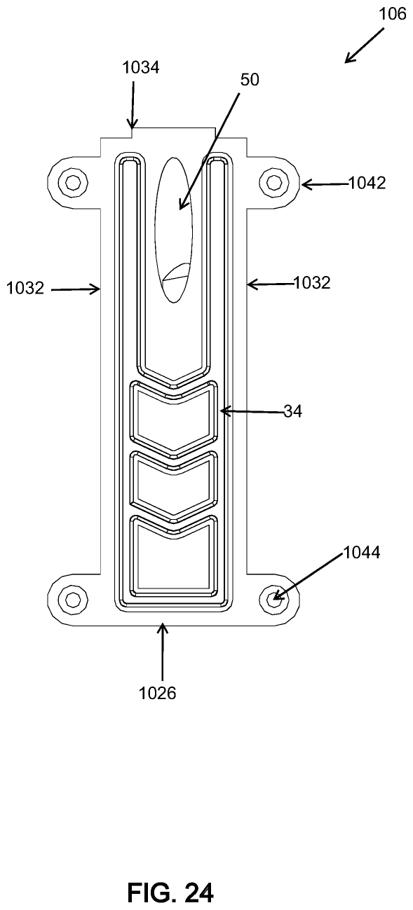

FIG. 25 shows a lower front right perspective view of a base, drill guide assembly, and actuating assembly of a pocket hole drilling system, in accordance with one or more arrangements.

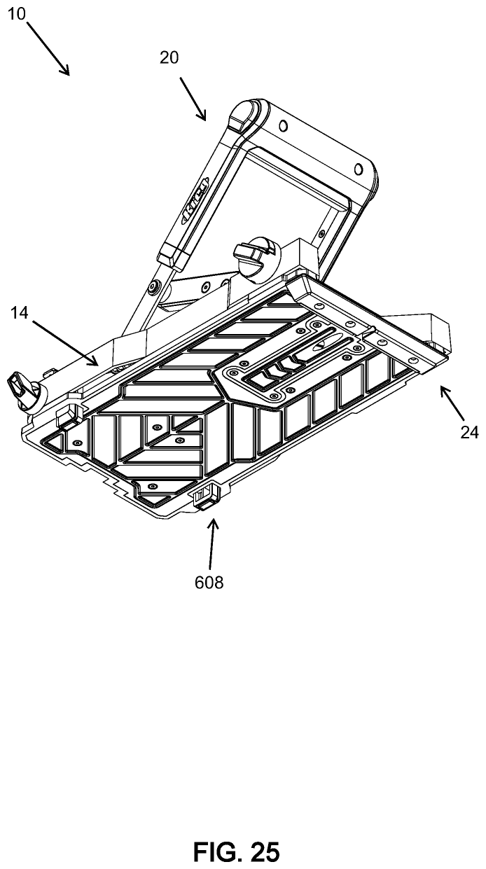

FIG. 26 shows a lower front left perspective view of a base, drill guide assembly, and actuating assembly of a pocket hole drilling system, in accordance with one or more arrangements.

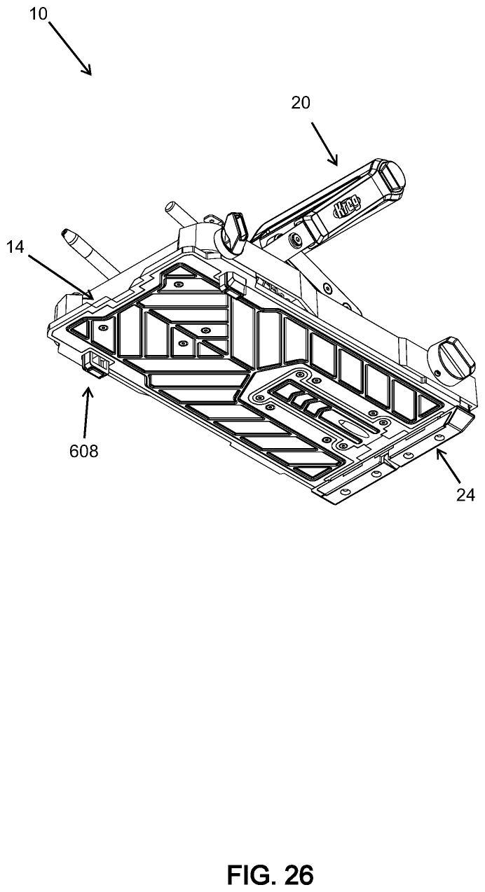

FIG. 27 shows a lower front right perspective view of a base, drill guide assembly, and actuating assembly of a pocket hole drilling system, in accordance with one or more arrangements.

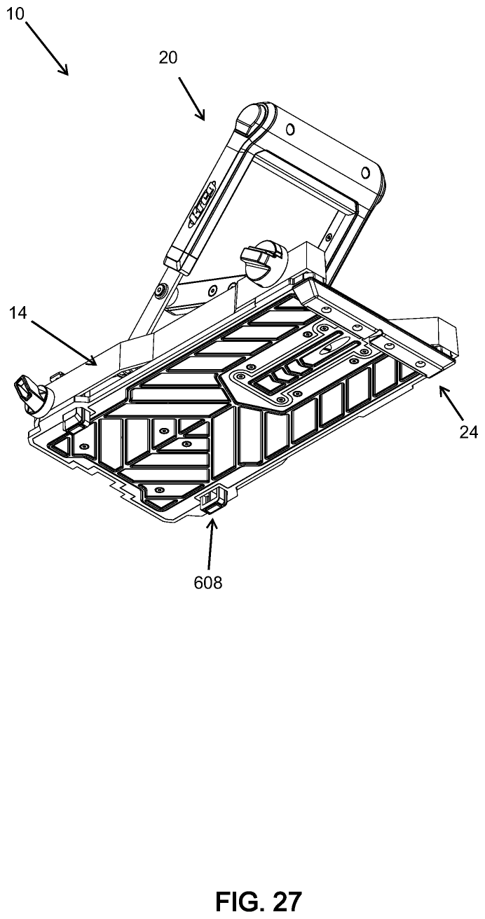

FIG. 28 shows a lower front left perspective view of a base, drill guide assembly, and actuating assembly of a pocket hole drilling system, in accordance with one or more arrangements.

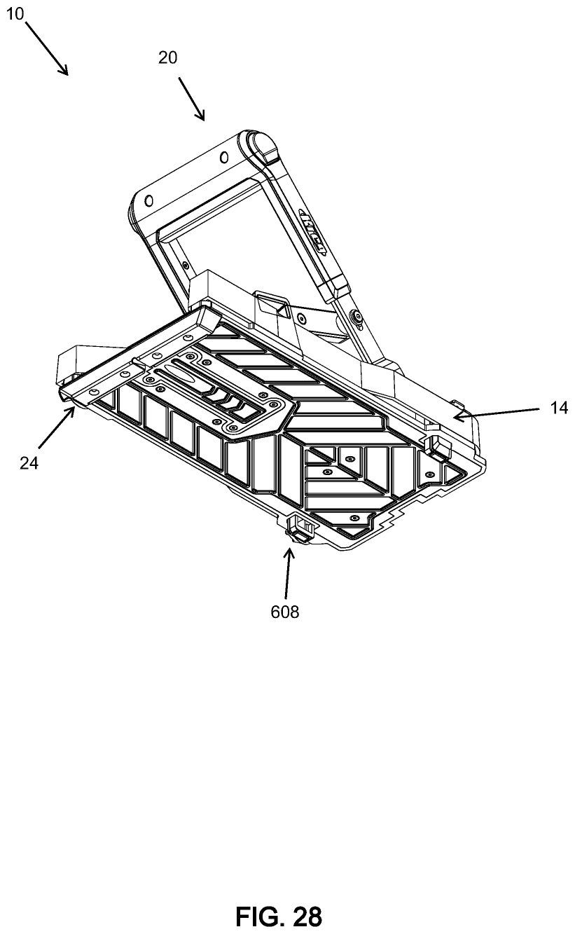

FIG. 29 shows a left view of a base, drill guide assembly, and actuating assembly of a pocket hole drilling system, in accordance with one or more arrangements; the view showing a handle of an actuating assembly in a rearward position and a drilling assembly in a retracted position.

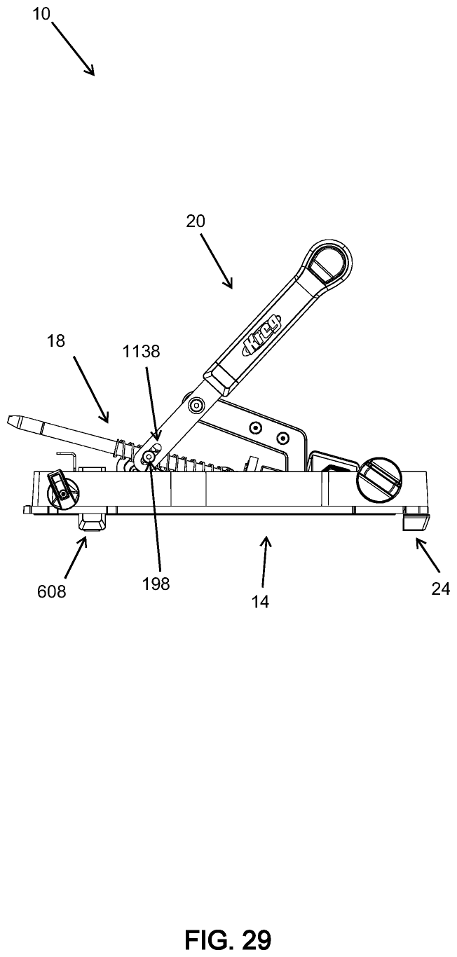

FIG. 30 shows a right view of a base, drill guide assembly, and actuating assembly of a pocket hole drilling system, in accordance with one or more arrangements; the view showing a handle of an actuating assembly in a rearward position and a drilling assembly in a retracted position.

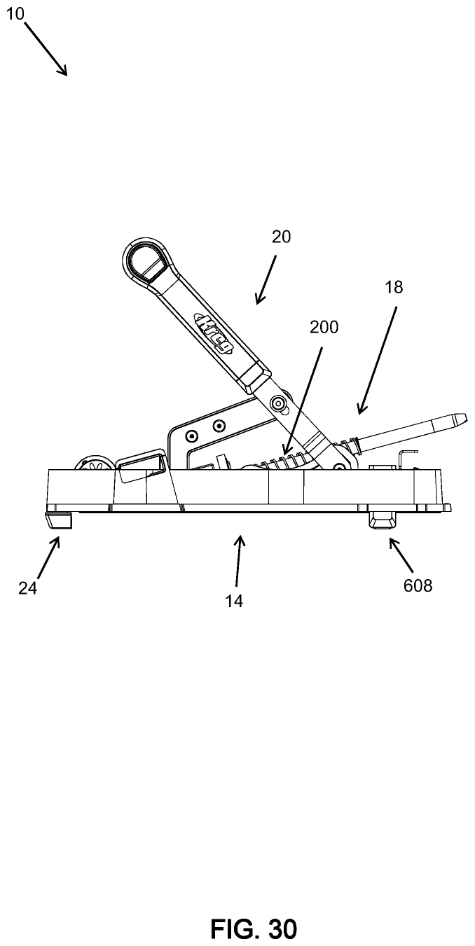

FIG. 31 shows a rear view of a base, drill guide assembly, and actuating assembly of a pocket hole drilling system, in accordance with one or more arrangements; the view showing a handle of an actuating assembly in a rearward position and a drilling assembly in a retracted position.

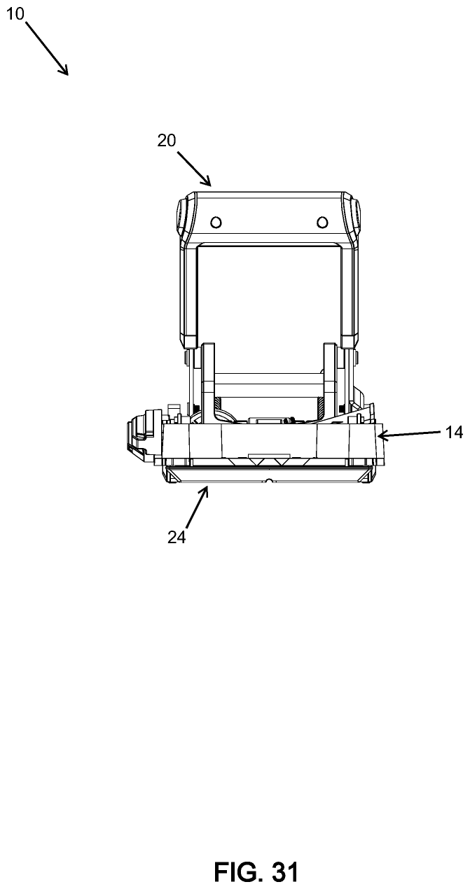

FIG. 32 shows a front view of a base, drill guide assembly, and actuating assembly of a pocket hole drilling system, in accordance with one or more arrangements; the view showing a handle of an actuating assembly in a rearward position and a drilling assembly in a retracted position.

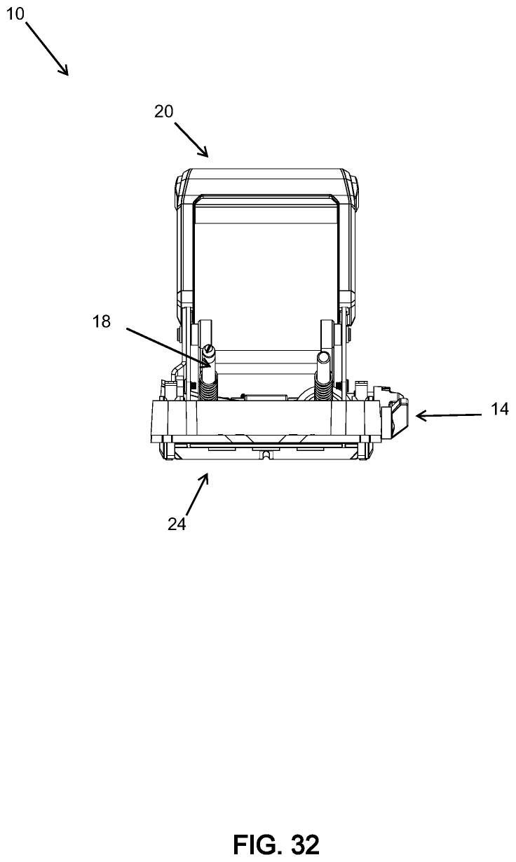

FIG. 33 shows a top view of a base, drill guide assembly, and actuating assembly of a pocket hole drilling system, in accordance with one or more arrangements; the view showing a handle of an actuating assembly in a rearward position and a drilling assembly in a retracted position.

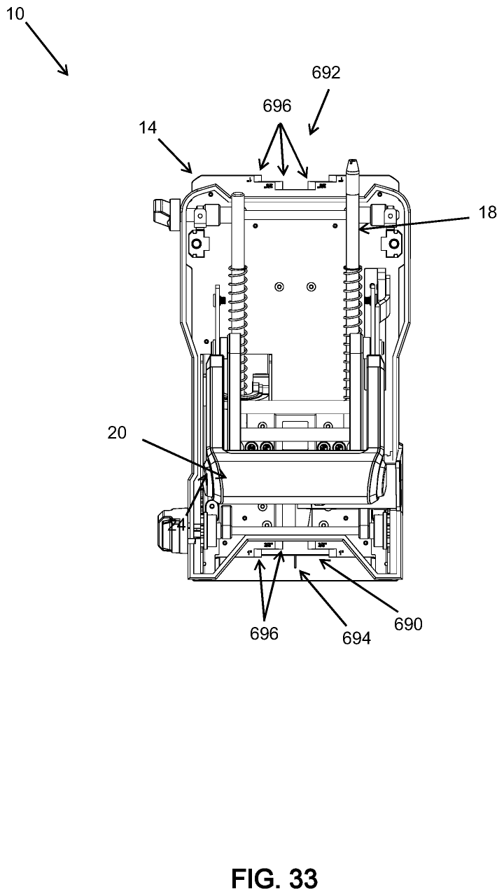

FIG. 34 shows a bottom view of a base, drill guide assembly, and actuating assembly of a pocket hole drilling system, in accordance with one or more arrangements; the view showing a handle of an actuating assembly in a rearward position and a drilling assembly in a retracted position.

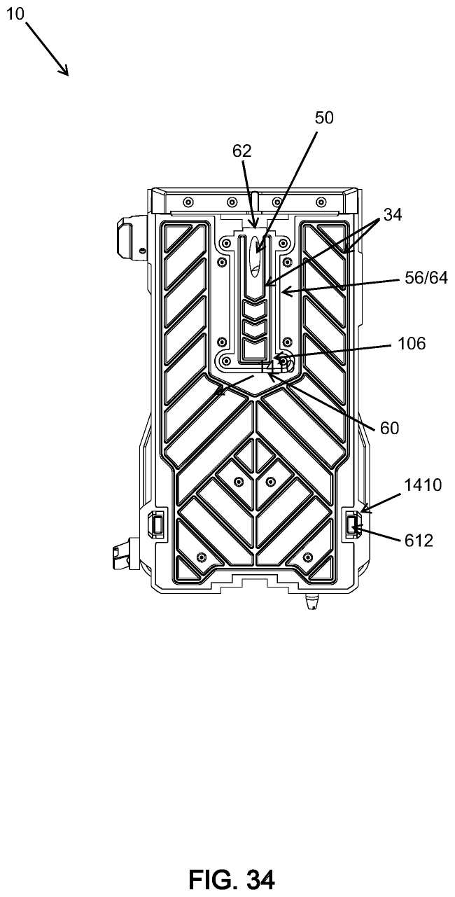

FIG. 35 shows an upper front left perspective view of a pocket hole drilling system, in accordance with one or more arrangements; the view showing the system with the housing omitted and a drill motor of a drilling assembly detached from a collar assembly connected to a drilling guide assembly.

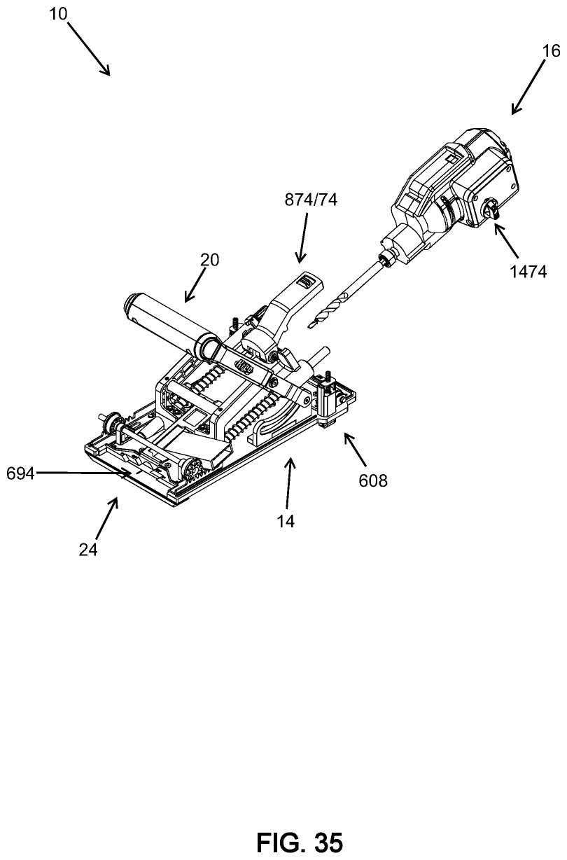

FIG. 36 shows a partial upper rear right perspective view of a pocket hole drilling system, in accordance with one or more arrangements; the view showing the system with the housing omitted and a drill motor inserted into a collar assembly of a drilling assembly with a clamp assembly unclamped.

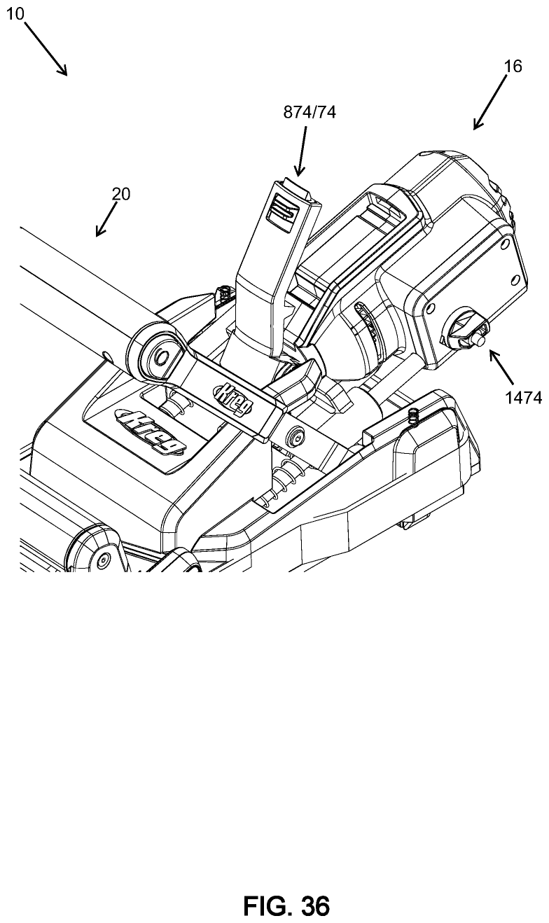

FIG. 37 shows a front view of a collar assembly for used in a pocket hole drilling system, in accordance with one or more arrangements.

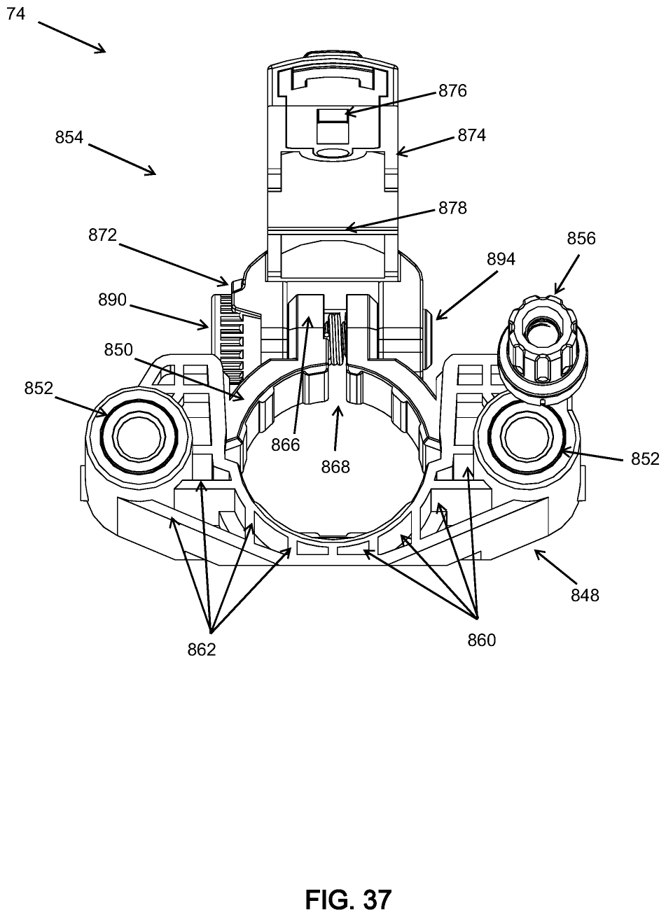

FIG. 38 shows a rear view of a collar assembly for used in a pocket hole drilling system, in accordance with one or more arrangements.

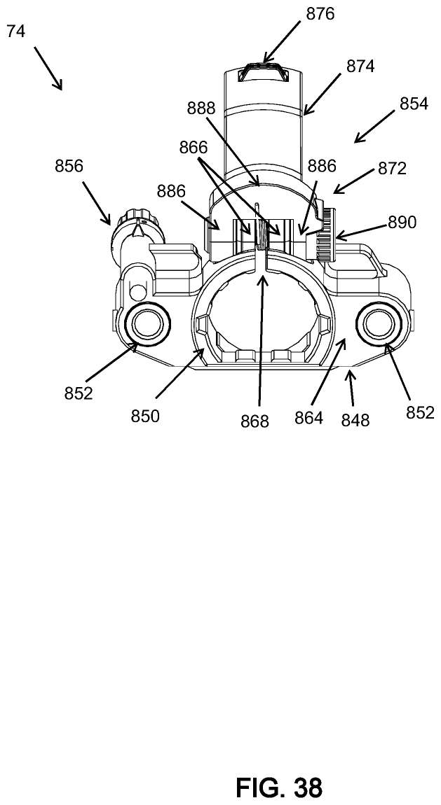

FIG. 39 shows a partial right view of a collar assembly for used in a pocket hole drilling system, in accordance with one or more arrangements; the view showing a lever of a clamping assembly of the collar assembly moved to an unclamped position.

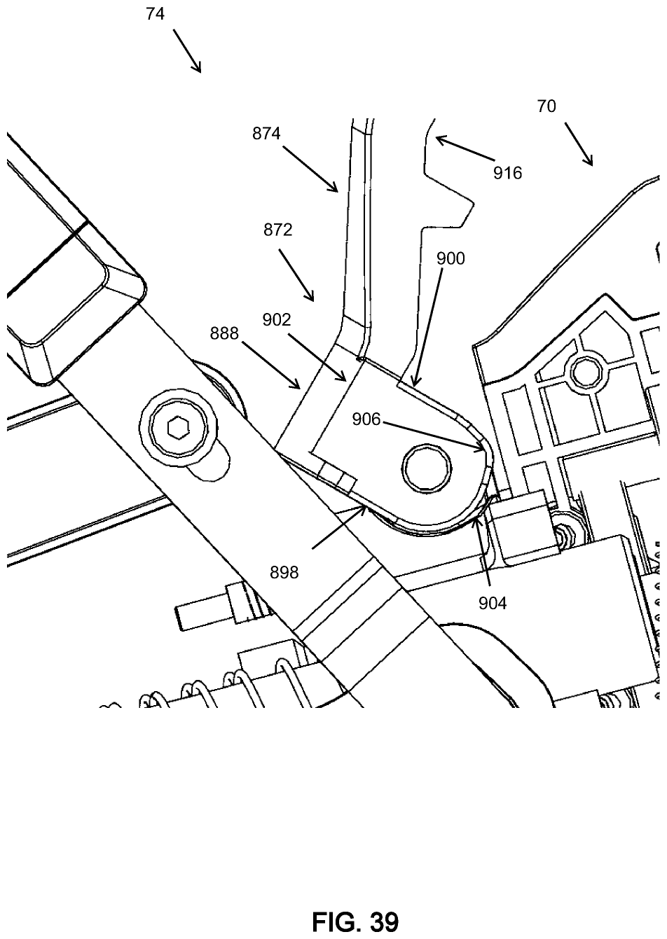

FIG. 40 shows a partial right view of a collar assembly for used in a pocket hole drilling system, in accordance with one or more arrangements; the view showing a lever of a clamping assembly of the collar assembly moved to an unclamped position.

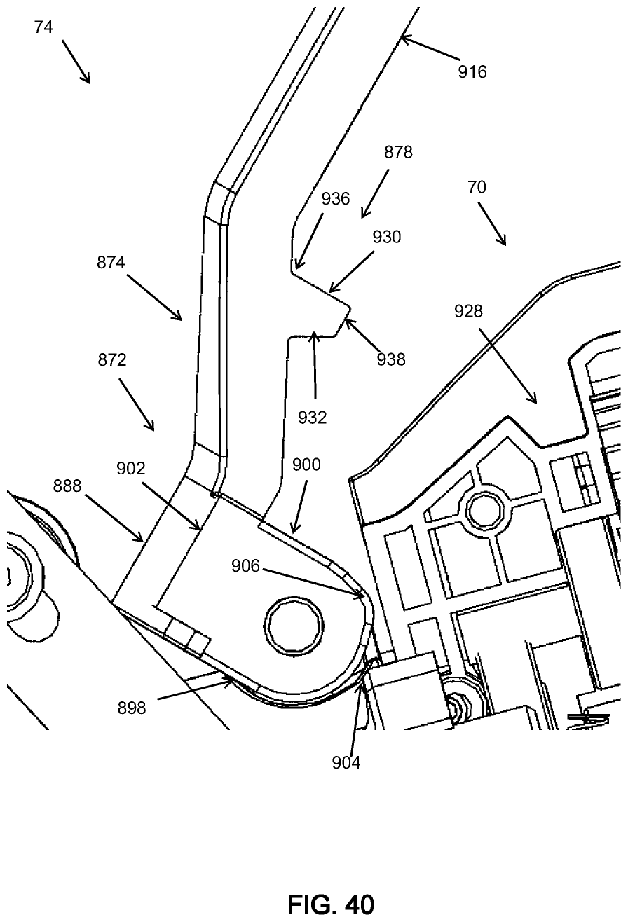

FIG. 41 shows a lower front right perspective view of a collar assembly of a drilling assembly of a pocket hole drilling system, in accordance with one or more arrangements.

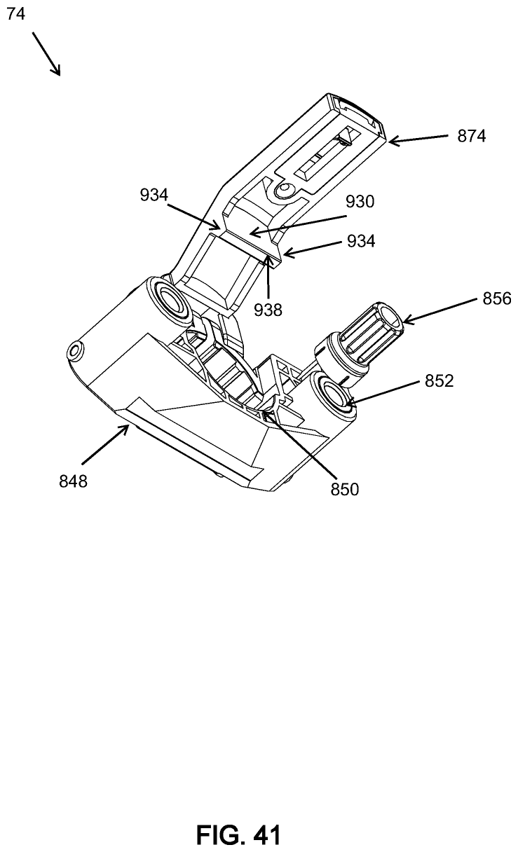

FIG. 42 shows a lower front left perspective view of a collar assembly of a drilling assembly of a pocket hole drilling system, in accordance with one or more arrangements.

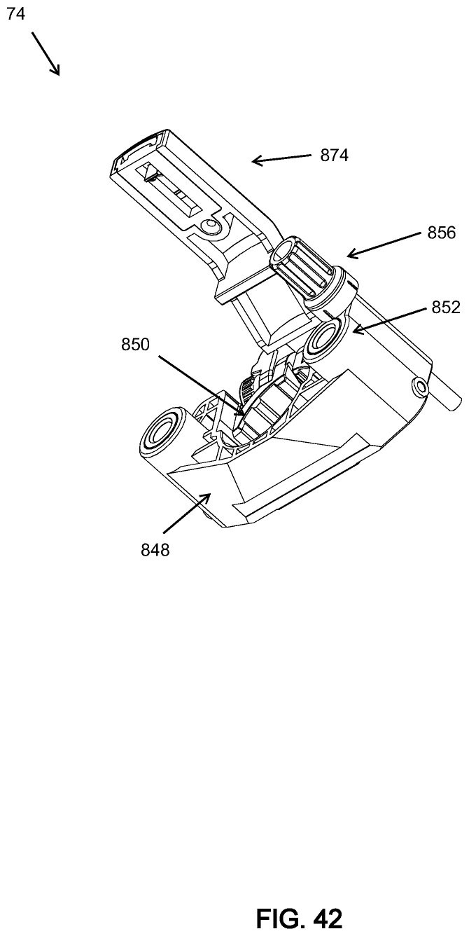

FIG. 43 shows a lower rear right perspective view of a collar assembly of a drilling assembly of a pocket hole drilling system, in accordance with one or more arrangements.

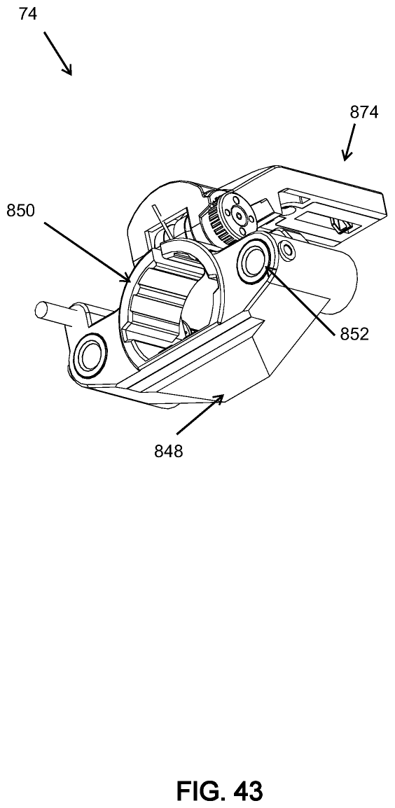

FIG. 44 shows a lower rear left perspective view of a collar assembly of a drilling assembly of a pocket hole drilling system, in accordance with one or more arrangements.

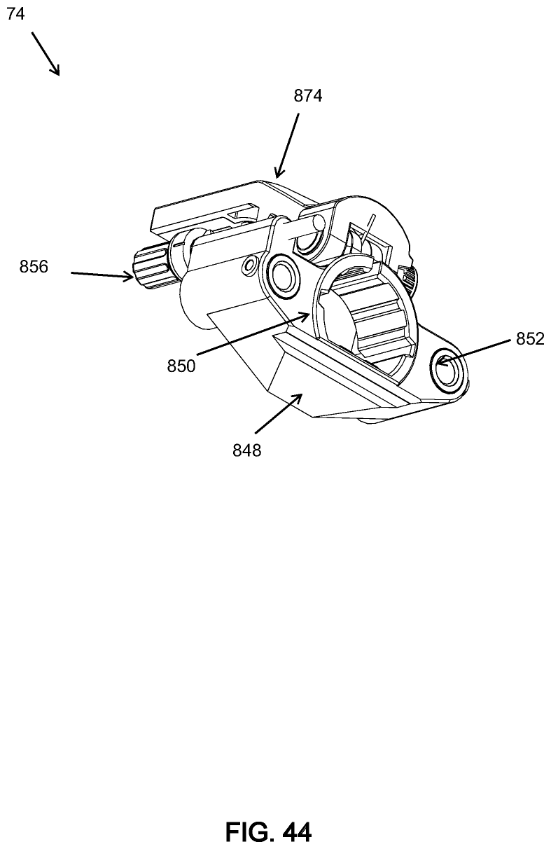

FIG. 45 shows a bottom view of a collar assembly of a drilling assembly of a pocket hole drilling system, in accordance with one or more arrangements.

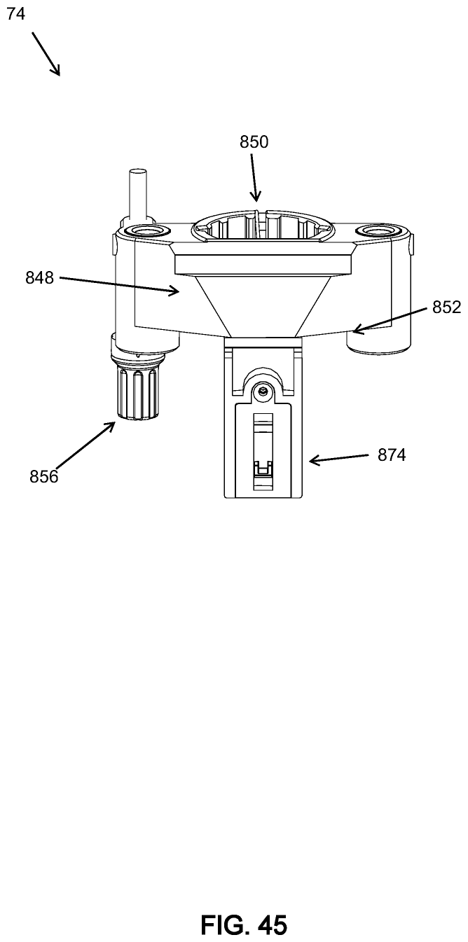

FIG. 46 shows a right view of a collar assembly for used in a pocket hole drilling system, in accordance with one or more arrangements; the view showing a lever of a clamping assembly of the collar assembly moved to a clamped position.

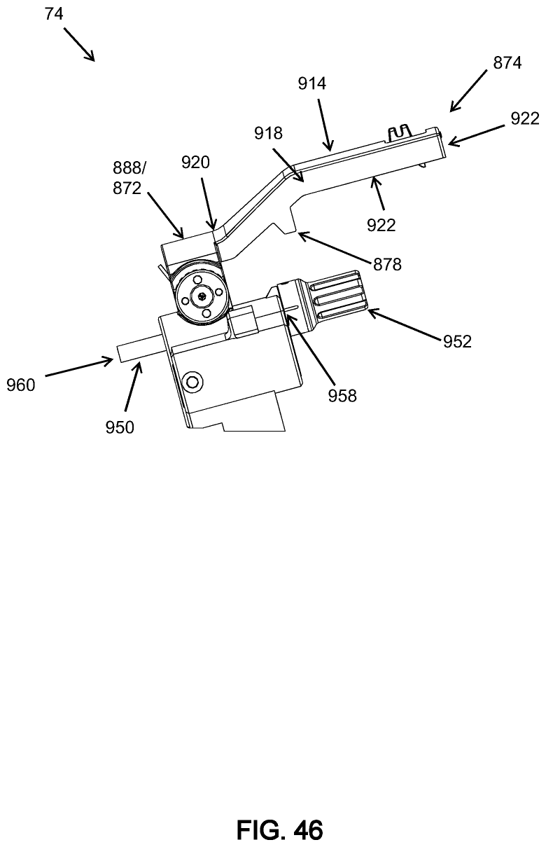

FIG. 47 shows a left view of a collar assembly for used in a pocket hole drilling system, in accordance with one or more arrangements; the view showing a lever of a clamping assembly of the collar assembly moved to a clamped position.

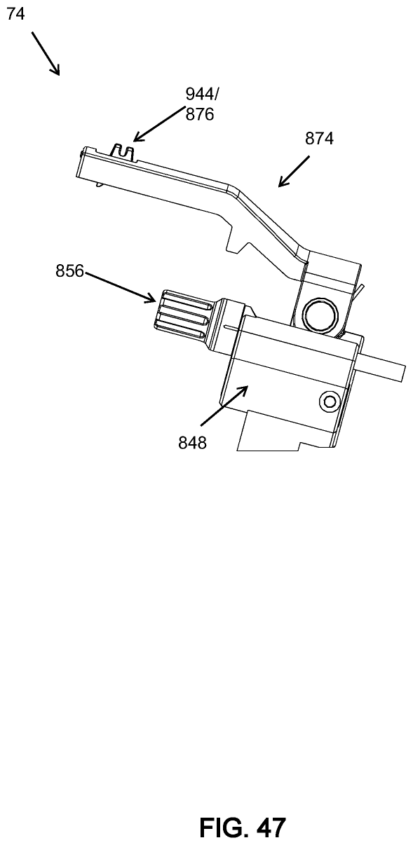

FIG. 48 shows an upper front right perspective view of a collar assembly for used in a pocket hole drilling system, in accordance with one or more arrangements; the view showing a lever of a clamping assembly of the collar assembly moved to a clamped position.

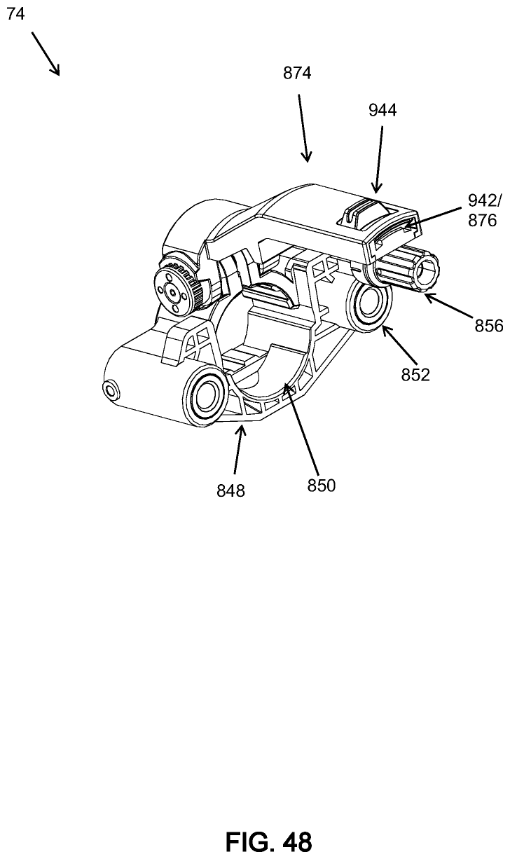

FIG. 49 shows an upper front left perspective view of a collar assembly for used in a pocket hole drilling system, in accordance with one or more arrangements; the view showing a lever of a clamping assembly of the collar assembly moved to a clamped position.

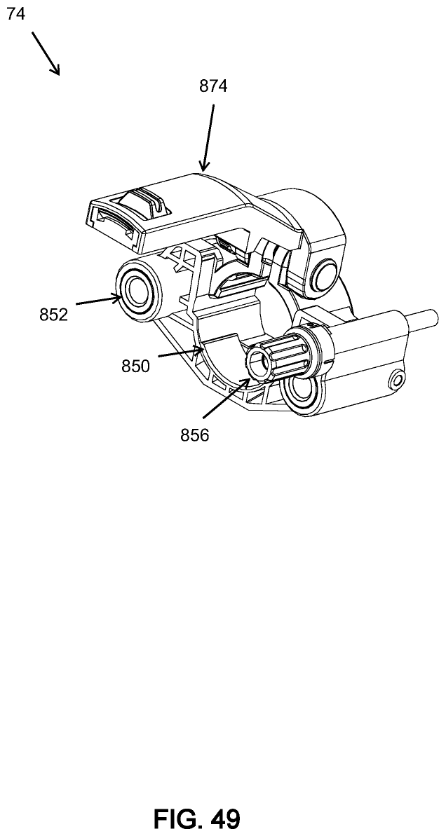

FIG. 50 shows an upper rear right perspective view of a collar assembly for used in a pocket hole drilling system, in accordance with one or more arrangements; the view showing a lever of a clamping assembly of the collar assembly moved to a clamped position.

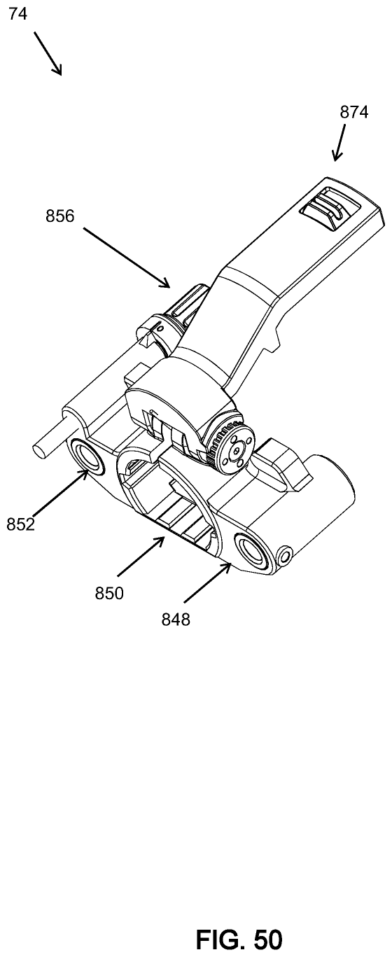

FIG. 51 shows an upper rear left perspective view of a collar assembly for used in a pocket hole drilling system, in accordance with one or more arrangements; the view showing a lever of a clamping assembly of the collar assembly moved to a clamped position.

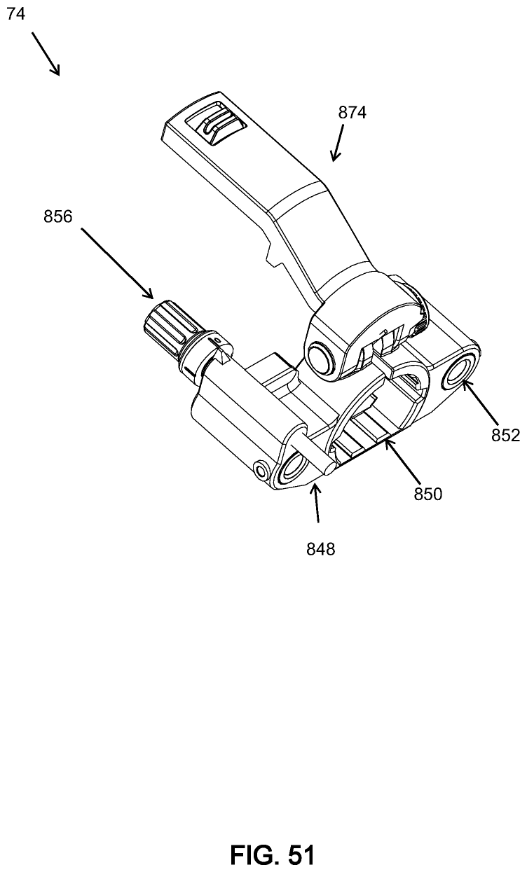

FIG. 52 shows a top view of a collar assembly for used in a pocket hole drilling system, in accordance with one or more arrangements; the view showing a lever of a clamping assembly of the collar assembly moved to a clamped position.

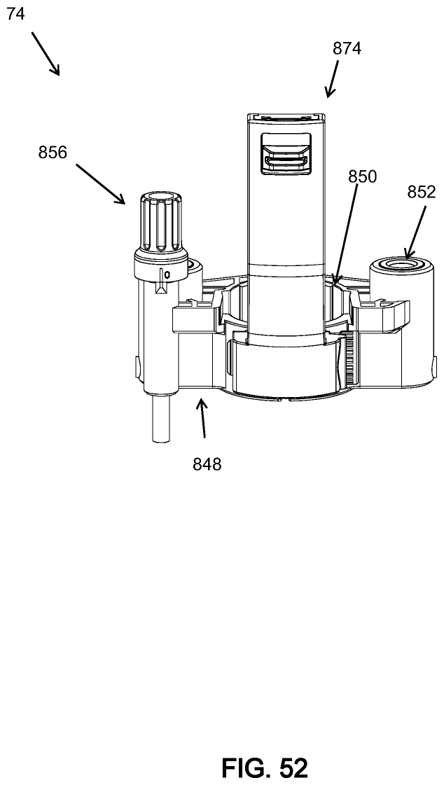

FIG. 53 shows a right view of a pocket hole drilling system, in accordance with one or more arrangements; the view showing switching assembly of drilling assembly; the switching assembly configured to engage drill motor when drilling assembly is moved out of a fully retracted position and disengage drill motor when drilling assembly is returned to the fully retracted position; the view showing the drilling assembly moved just outside of the retracted position.

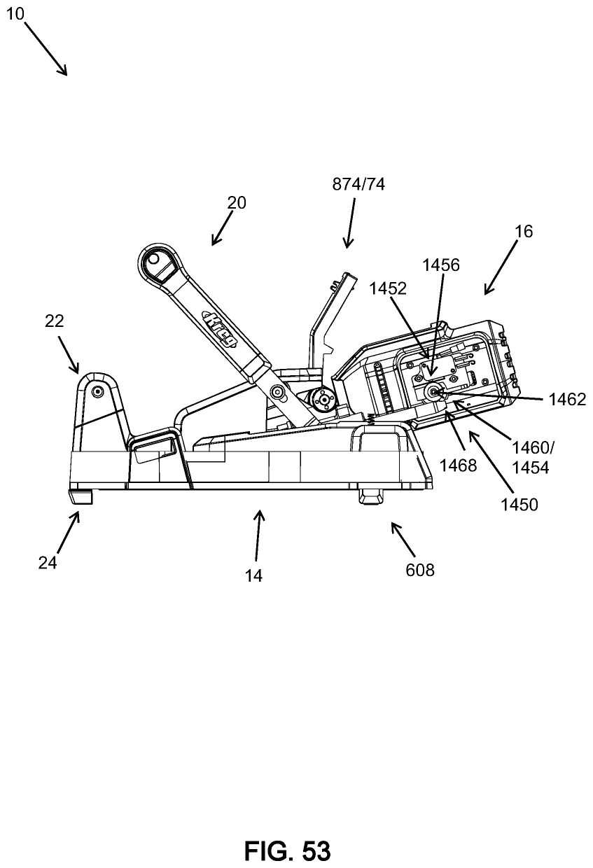

FIG. 54 shows an upper front right perspective view of a pocket hole drilling system, in accordance with one or more arrangements; the view showing switching assembly of drilling assembly; the switching assembly configured to engage drill motor when drilling assembly is moved out of a fully retracted position and disengage drill motor when drilling assembly is returned to the fully retracted position; the view showing the drilling assembly moved forward to an extended position.

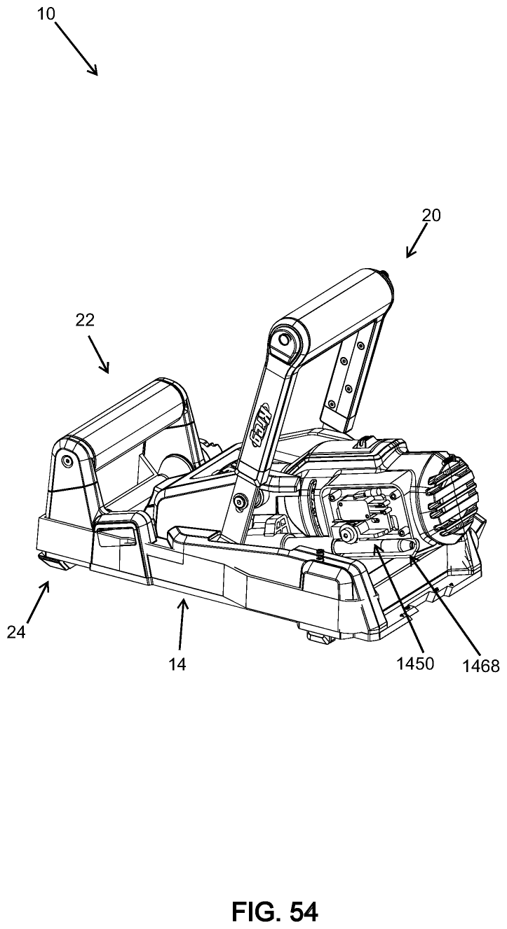

FIG. 55 shows a partial right view of a pocket hole drilling system, in accordance with one or more arrangements; the view showing switching assembly of drilling assembly; the switching assembly configured to engage drill motor when drilling assembly is moved out of a fully retracted position and disengage drill motor when drilling assembly is returned to the fully retracted position; the view showing the drilling assembly moved forward to an extended position.

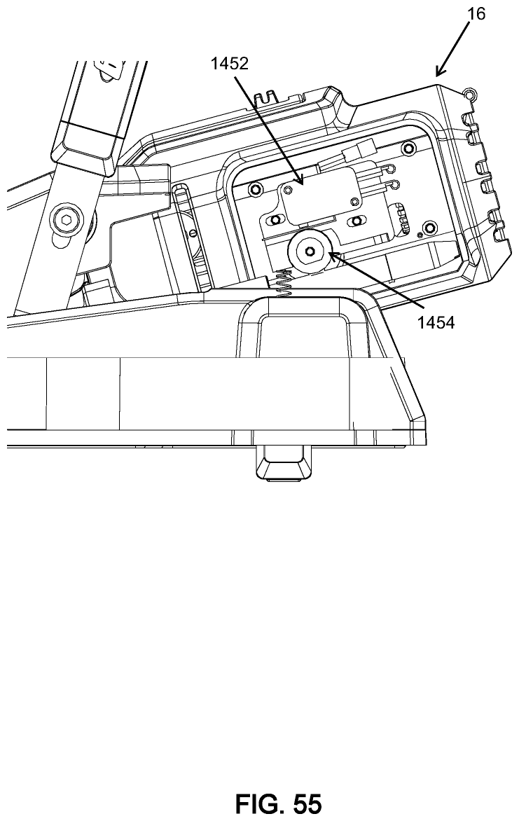

FIG. 56 shows upper front right perspective view of a pocket hole drilling system, in accordance with one or more arrangements; the view showing switching assembly of drilling assembly; the switching assembly configured to engage drill motor when drilling assembly is moved out of a fully retracted position and disengage drill motor when drilling assembly is returned to the fully retracted position; the view showing the drilling assembly moved forward to an extended position.

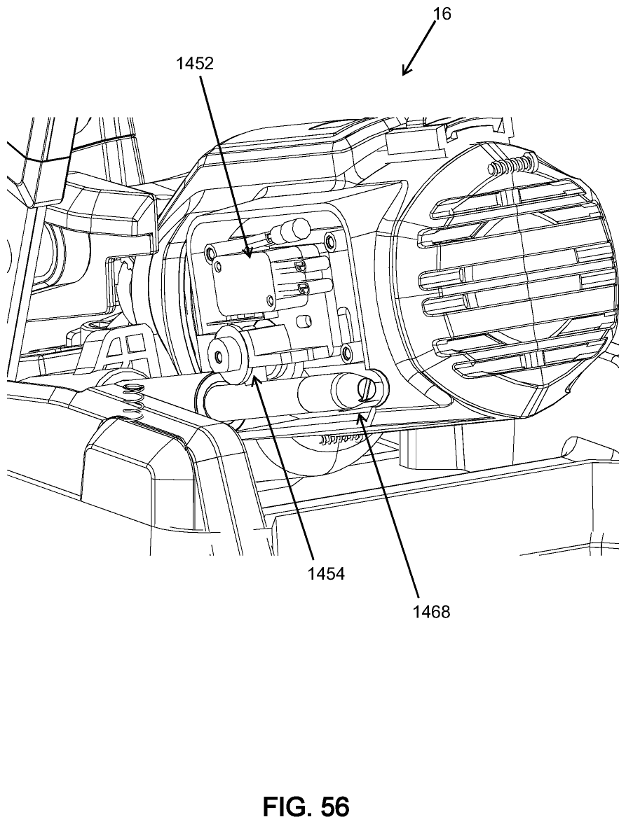

FIG. 57 shows an exploded upper rear left perspective view of a fulcrum assembly of a bracket assembly of a pocket hole drilling system, in accordance with one or more arrangements.

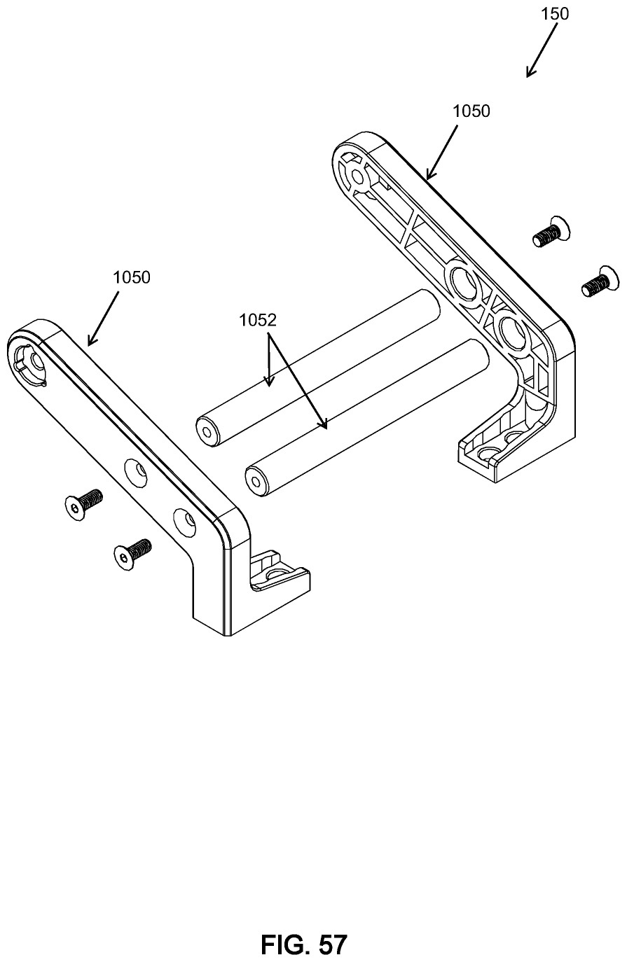

FIG. 58 shows an upper rear left perspective view of a fulcrum assembly of a bracket assembly of a pocket hole drilling system, in accordance with one or more arrangements.

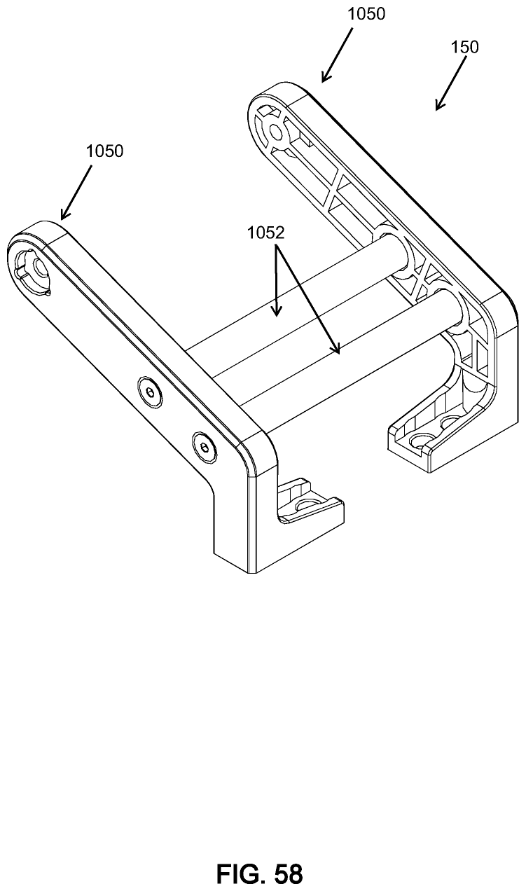

FIG. 59 shows an upper rear right perspective view of a fulcrum assembly of a bracket assembly of a pocket hole drilling system, in accordance with one or more arrangements.

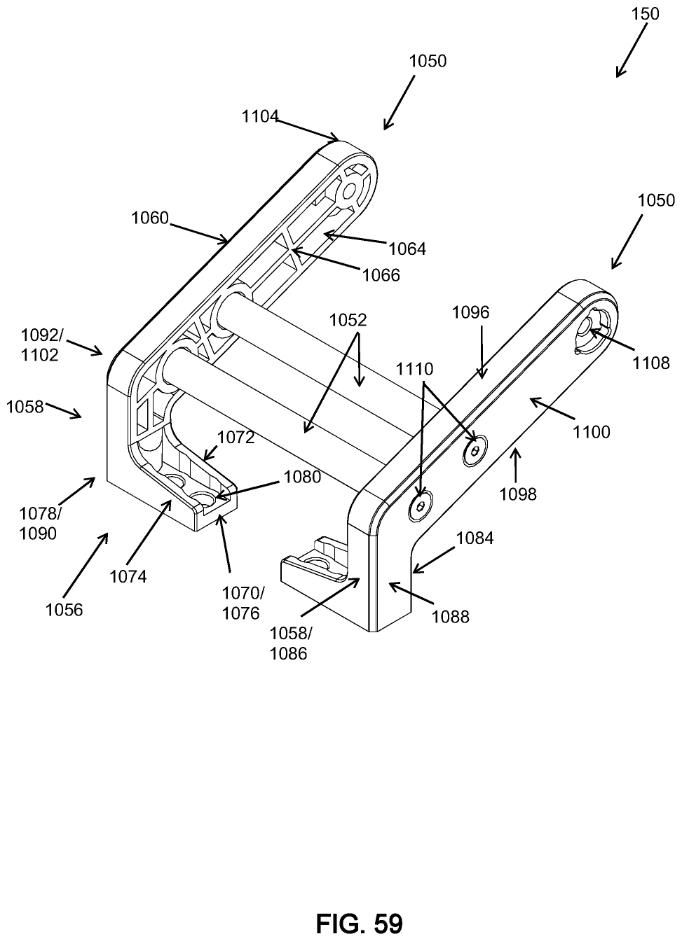

FIG. 60 shows an upper front right perspective view of a fulcrum assembly of a bracket assembly of a pocket hole drilling system, in accordance with one or more arrangements.

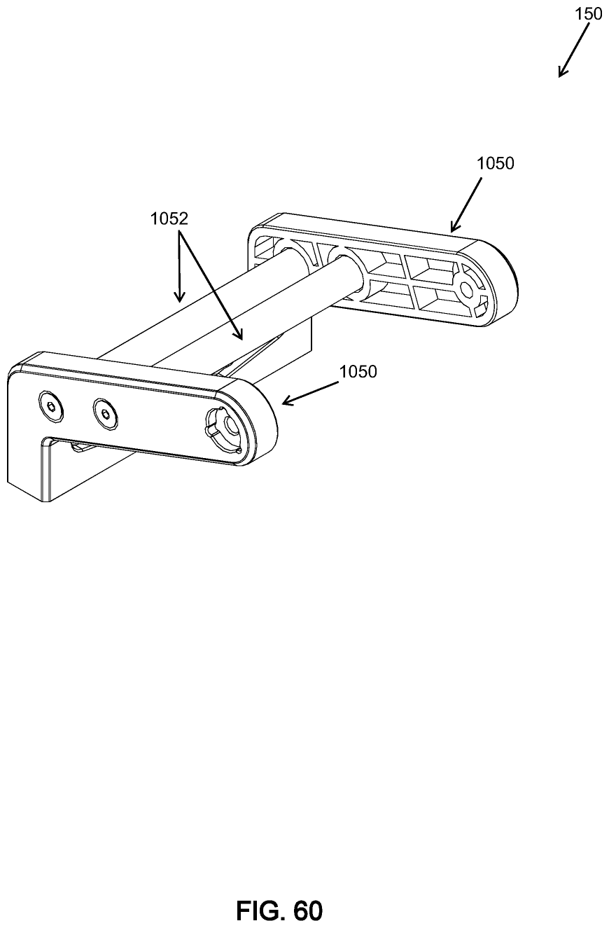

FIG. 61 shows an upper front left perspective view of a fulcrum assembly of a bracket assembly of a pocket hole drilling system, in accordance with one or more arrangements.

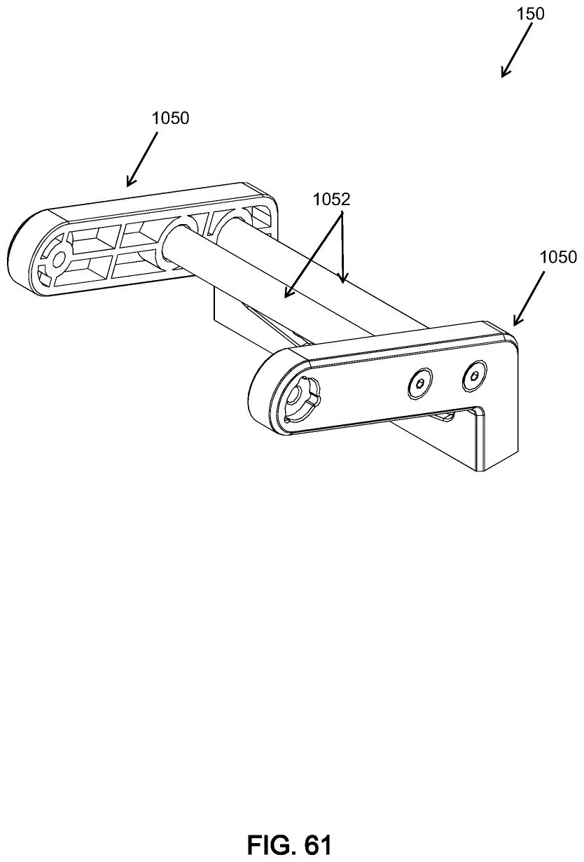

FIG. 62 shows a lower front left perspective view of a fulcrum assembly of a bracket assembly of a pocket hole drilling system, in accordance with one or more arrangements.

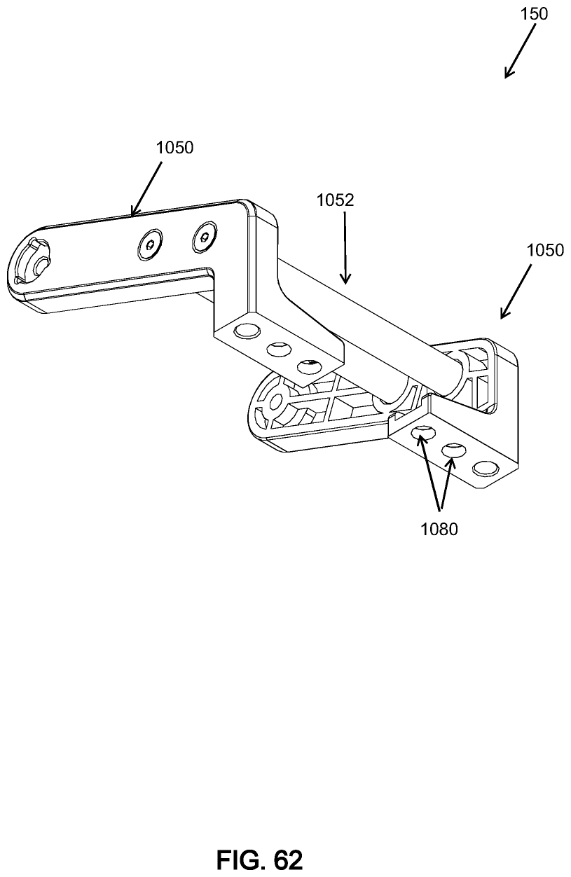

FIG. 63 shows a lower front right perspective view of a fulcrum assembly of a bracket assembly of a pocket hole drilling system, in accordance with one or more arrangements.

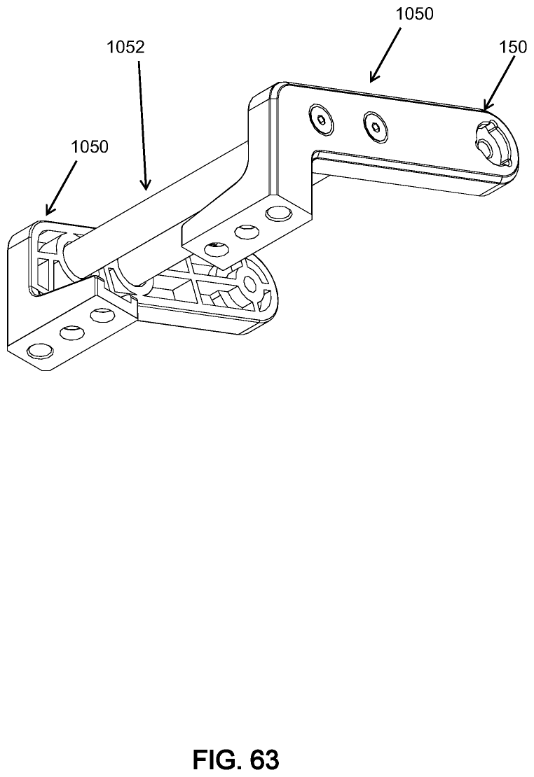

FIG. 64 shows a lower front left perspective view of a fulcrum assembly of a bracket assembly of a pocket hole drilling system, in accordance with one or more arrangements.

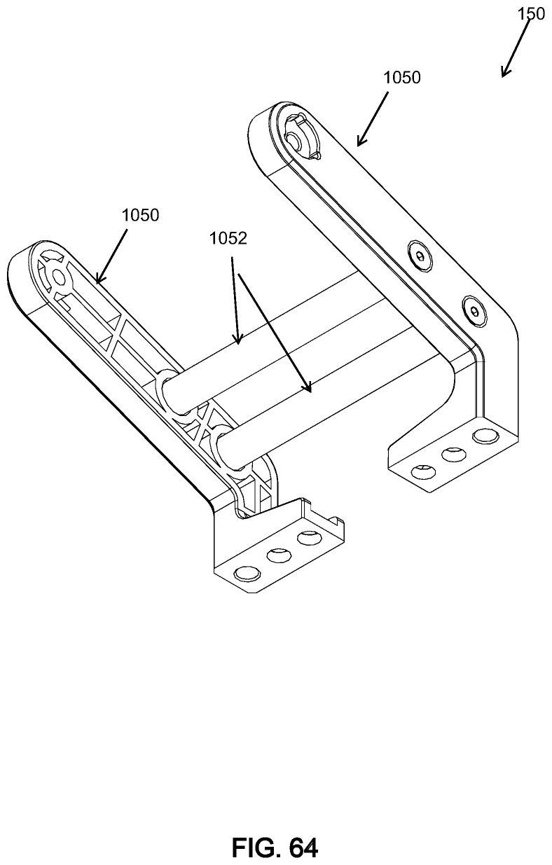

FIG. 65 shows a lower front right perspective view of a fulcrum assembly of a bracket assembly of a pocket hole drilling system, in accordance with one or more arrangements.

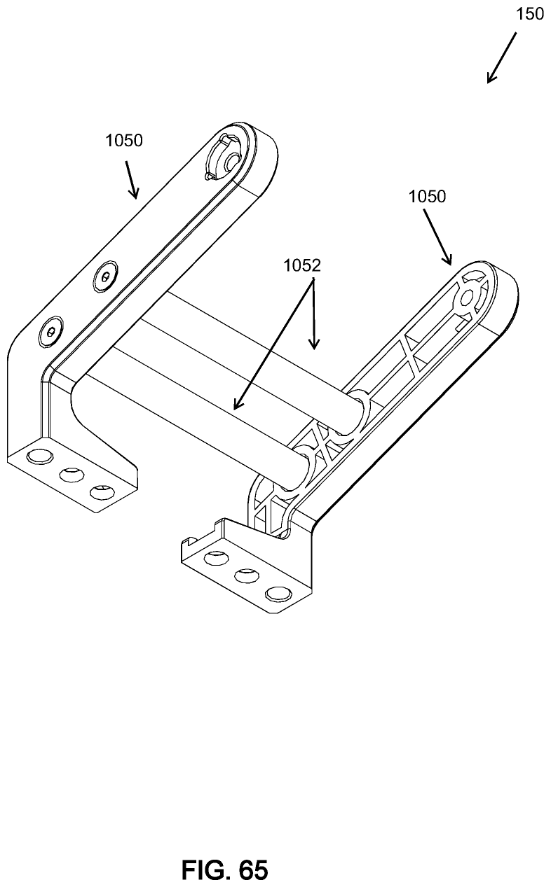

FIG. 66 shows a left view of a fulcrum assembly of a bracket assembly of a pocket hole drilling system, in accordance with one or more arrangements.

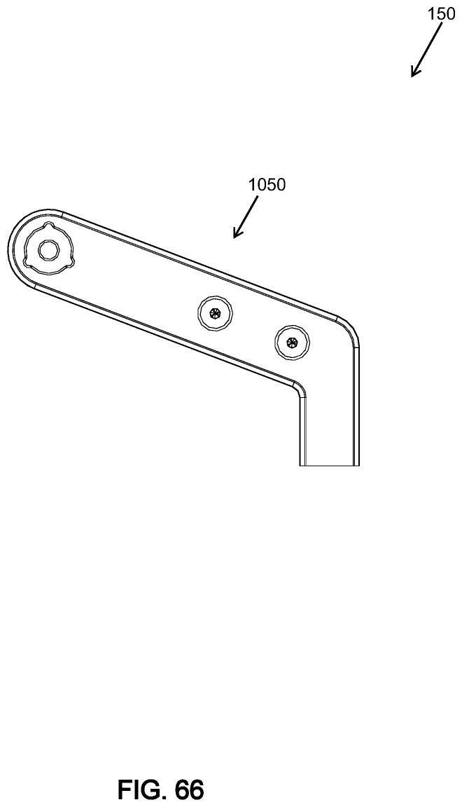

FIG. 67 shows a right view of a fulcrum assembly of a bracket assembly of a pocket hole drilling system, in accordance with one or more arrangements.

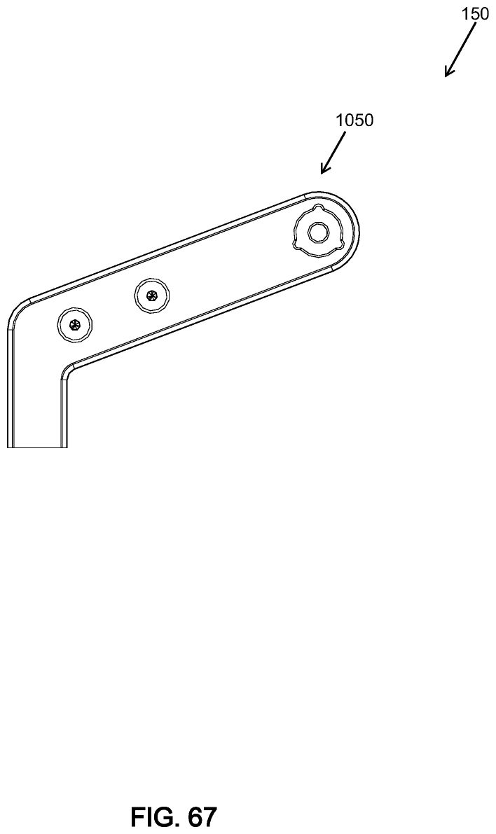

FIG. 68 shows a top view of a fulcrum assembly of a bracket assembly of a pocket hole drilling system, in accordance with one or more arrangements.

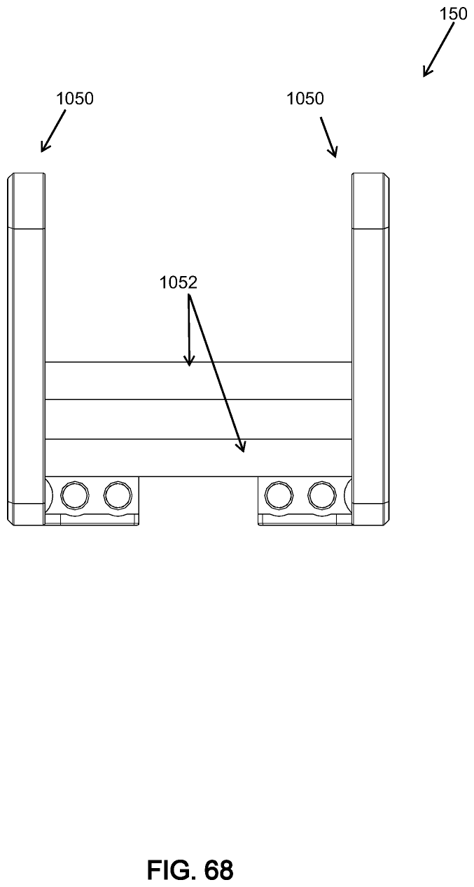

FIG. 69 shows a bottom view of a fulcrum assembly of a bracket assembly of a pocket hole drilling system, in accordance with one or more arrangements.

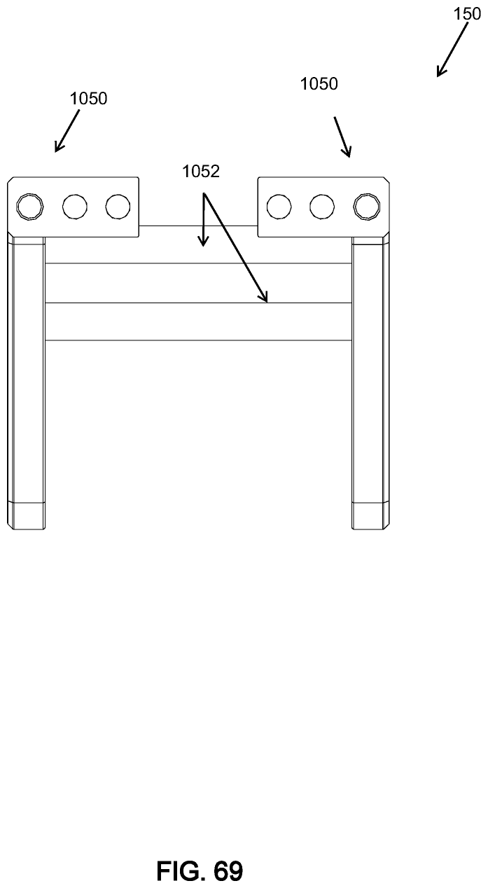

FIG. 70 shows a rear view of a fulcrum assembly of a bracket assembly of a pocket hole drilling system, in accordance with one or more arrangements.

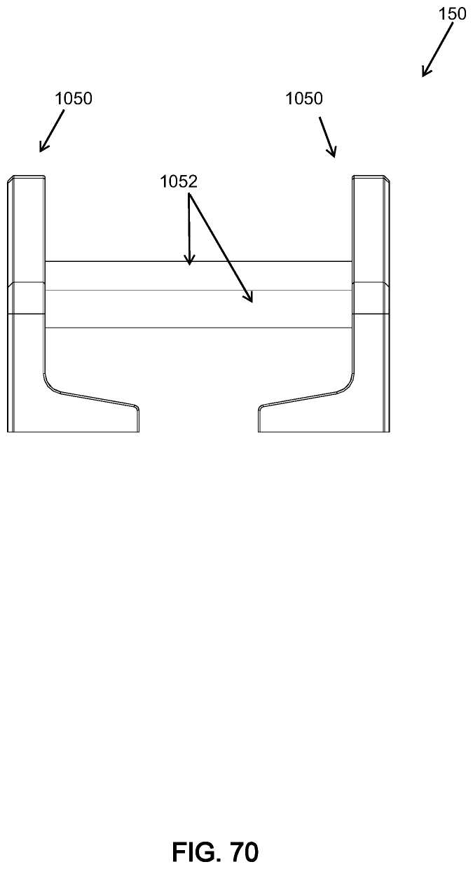

FIG. 71 shows a front view of a fulcrum assembly of a bracket assembly of a pocket hole drilling system, in accordance with one or more arrangements.

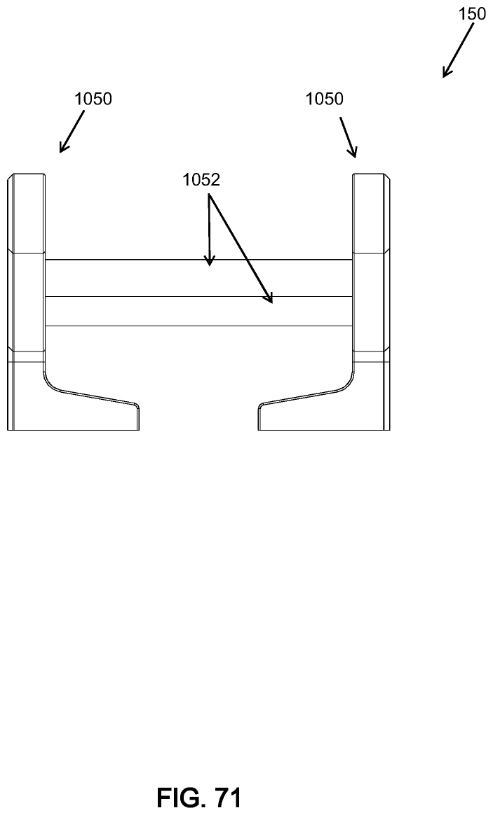

FIG. 72 shows an upper rear left view of a left arm of a fulcrum assembly of a bracket assembly of a pocket hole drilling system, in accordance with one or more arrangements.

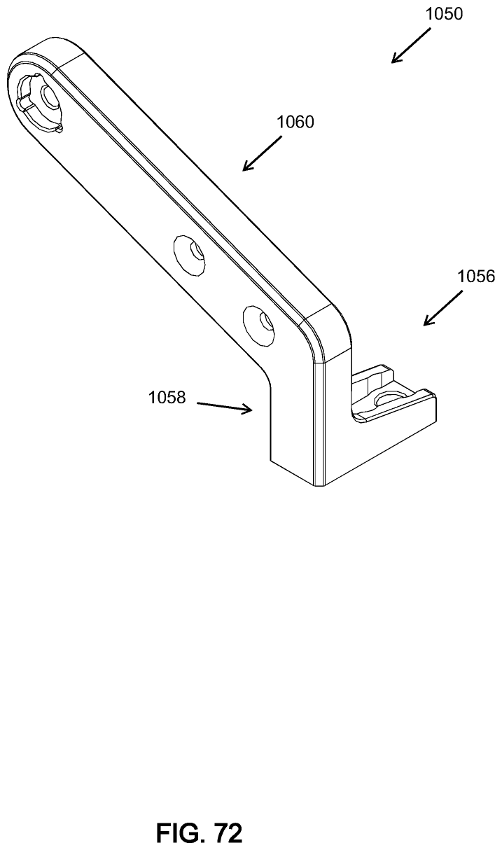

FIG. 73 shows an upper rear right view of a right arm of a fulcrum assembly of a bracket assembly of a pocket hole drilling system, in accordance with one or more arrangements.

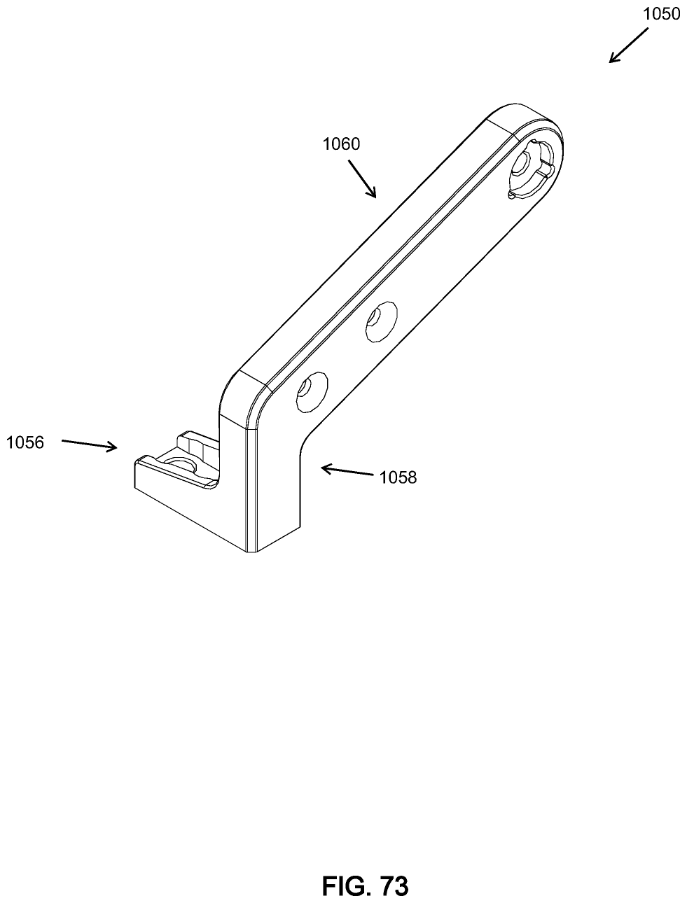

FIG. 74 shows an upper perspective view of a cross support of a fulcrum assembly of a bracket assembly of a pocket hole drilling system, in accordance with one or more arrangements.

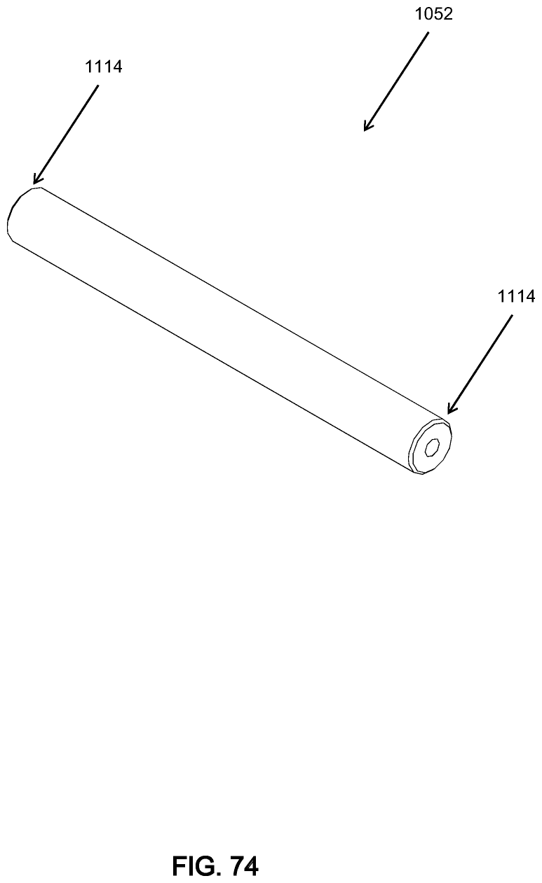

FIG. 75 shows an upper front left view of a lever of an actuating assembly of a pocket hole drilling system, in accordance with one or more arrangements.

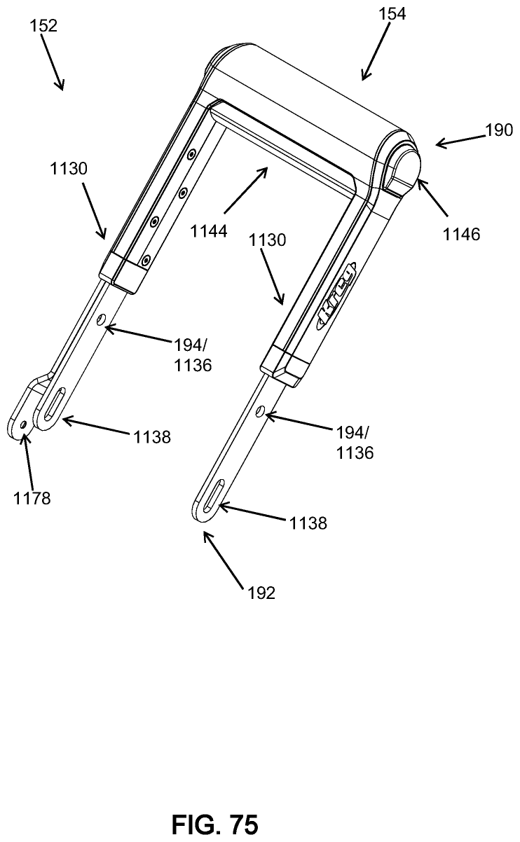

FIG. 76 shows a left view of a lever of an actuating assembly of a pocket hole drilling system, in accordance with one or more arrangements.

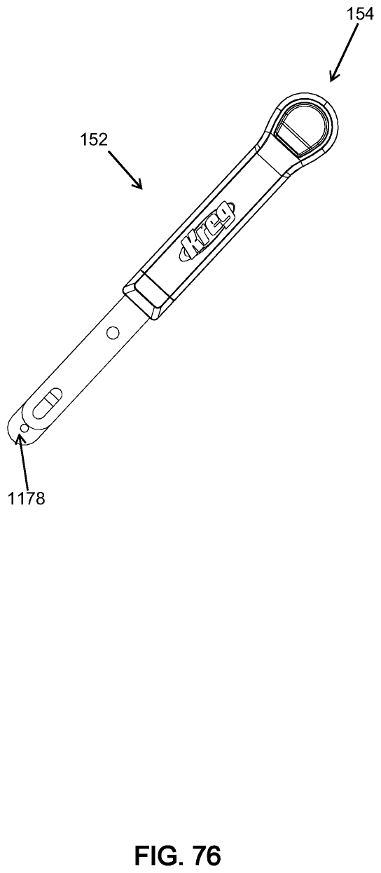

FIG. 77 shows a left view of a lever of an actuating assembly of a pocket hole drilling system, in accordance with one or more arrangements.

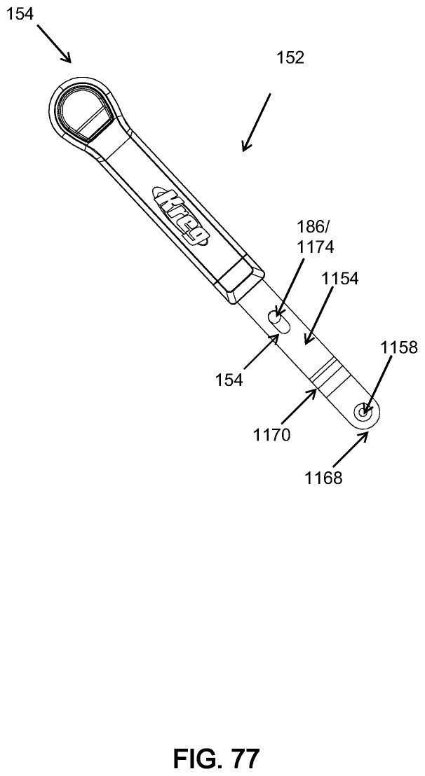

FIG. 78 shows a front view of a lever of an actuating assembly of a pocket hole drilling system, in accordance with one or more arrangements.

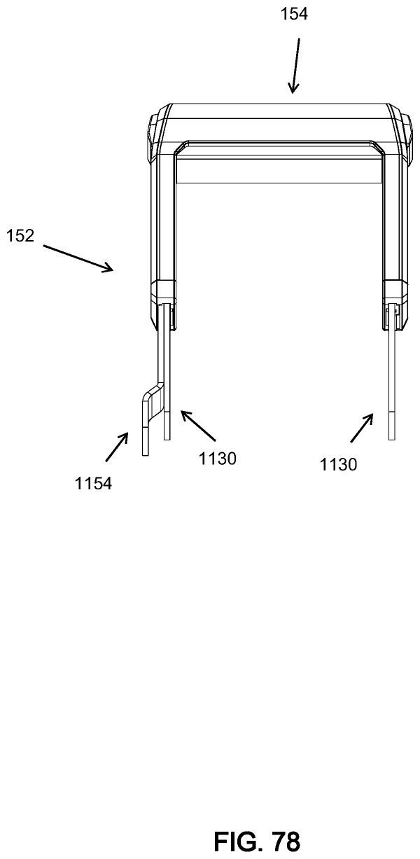

FIG. 79 shows a bottom view of a lever of an actuating assembly of a pocket hole drilling system, in accordance with one or more arrangements.

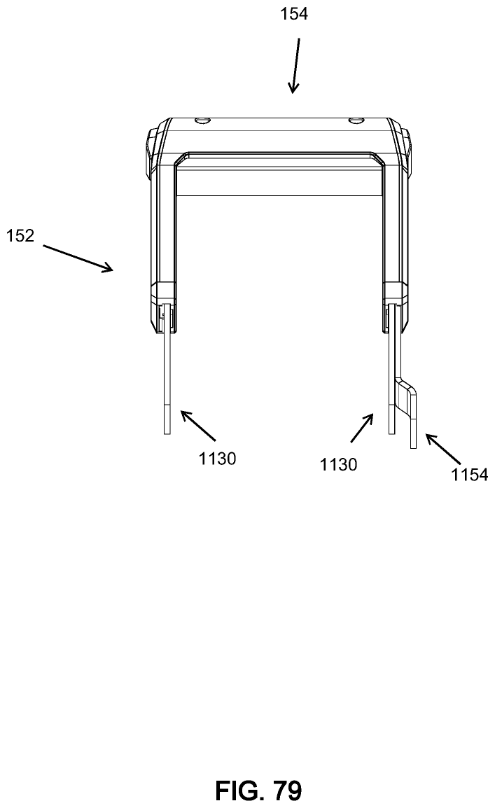

FIG. 80 shows a rear view of a lever of an actuating assembly of a pocket hole drilling system, in accordance with one or more arrangements.

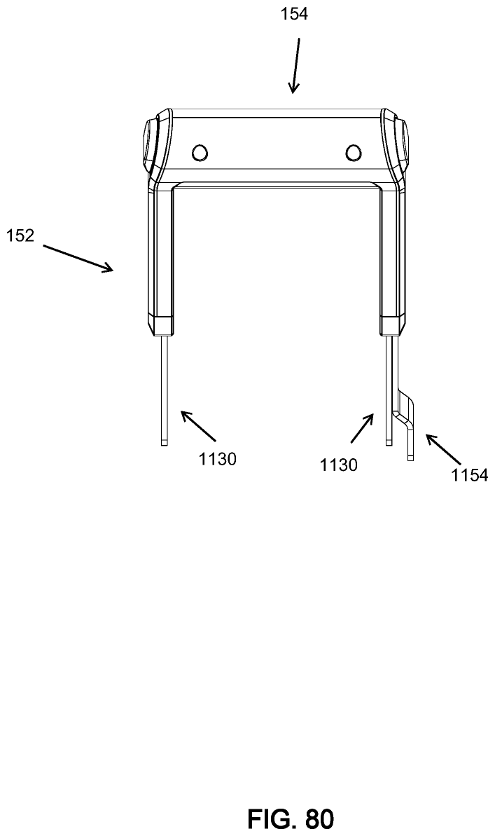

FIG. 81 shows a top view of a lever of an actuating assembly of a pocket hole drilling system, in accordance with one or more arrangements.

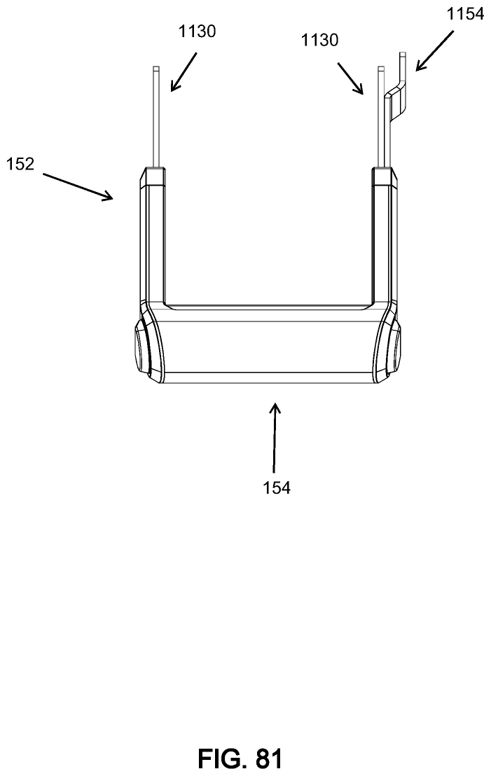

FIG. 82 shows an exploded view of a handle of a lever of an actuating assembly of a pocket hole drilling system, in accordance with one or more arrangements.

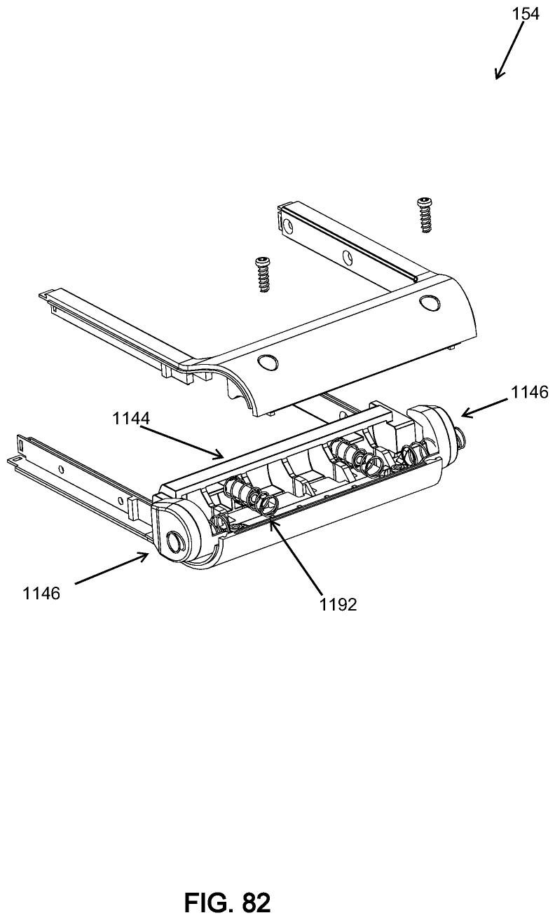

FIG. 83 shows an upper front right perspective view of a pocket hole drilling system, in accordance with one or more arrangements; the view showing the system with the drilling assembly omitted; the view showing an exploded view of support arms of the lever of the actuating assembly.

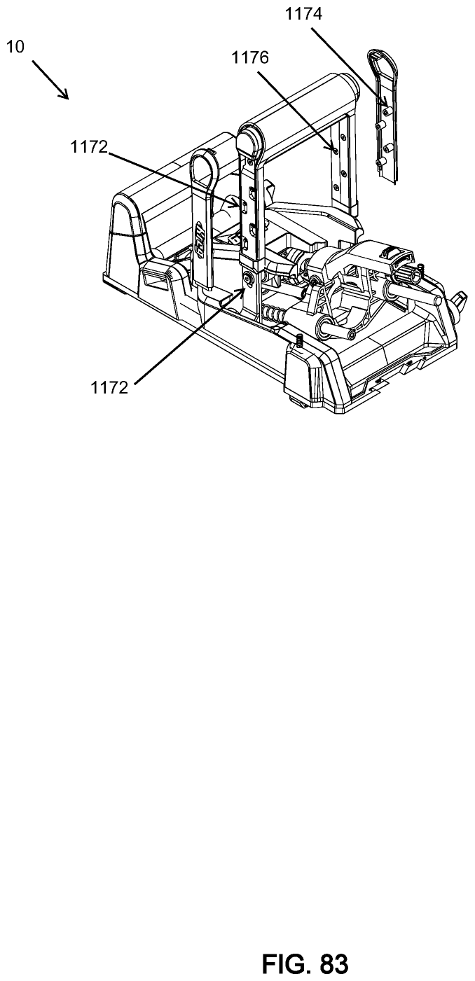

FIG. 84 shows a link of a lock assembly of a actuating assembly of a pocket hole drilling system, in accordance with one or more arrangements

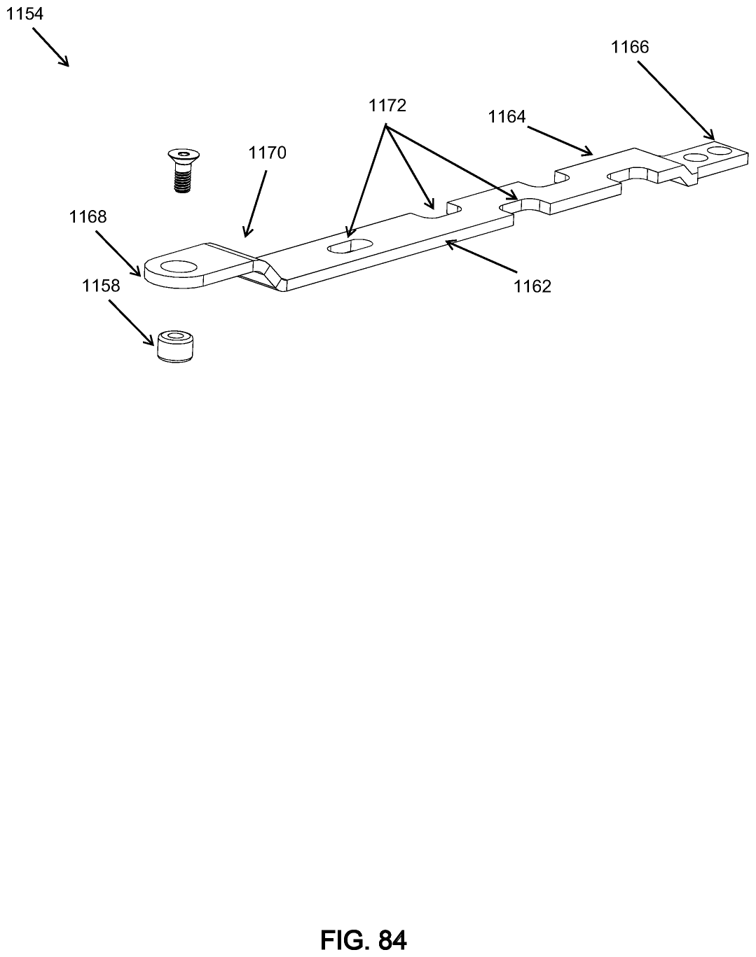

FIG. 85 shows an upper front left perspective view of a base of a pocket hole drilling system, in accordance with one or more arrangements; the view showing a track of a locking mechanism of an actuating assembly.

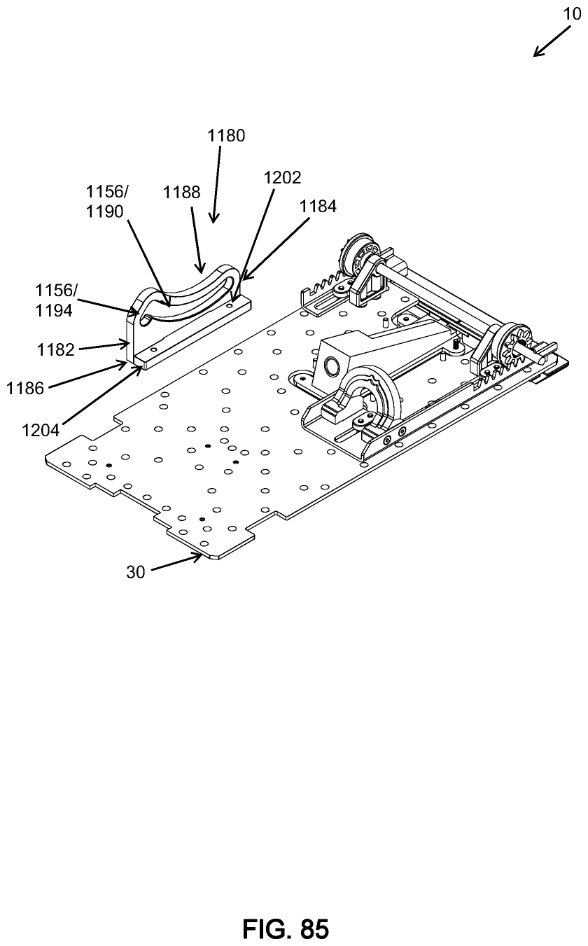

FIG. 86 shows a partial forward right perspective view of a pocket hole drilling system, in accordance with one or more arrangements; the view showing a close up view of a locking mechanism of an actuating assembly.

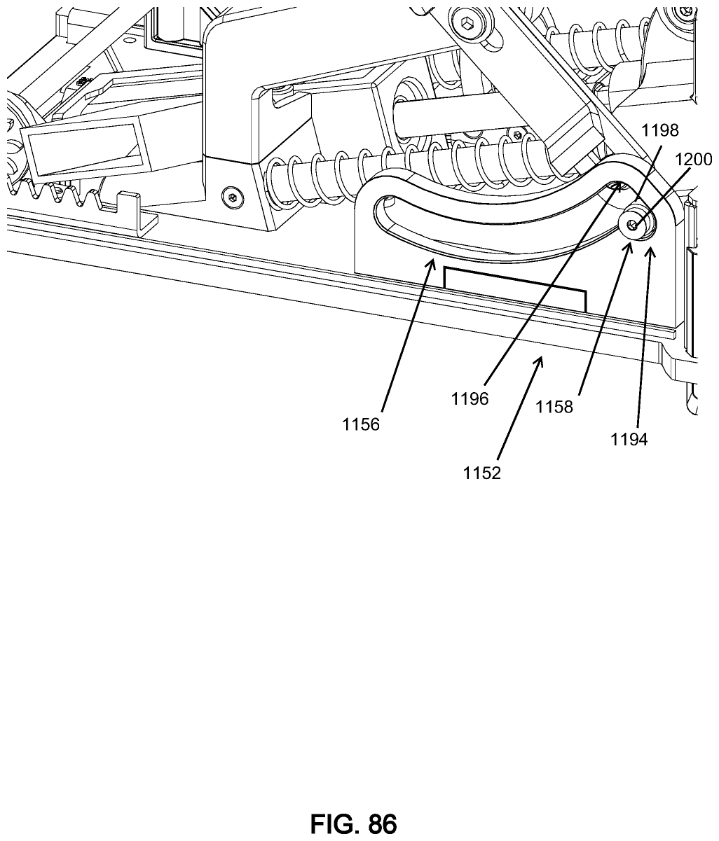

FIG. 87 shows an upper rear right perspective view of a base and lip assembly of a pocket hole drilling system, in accordance with one or more arrangements; the view showing the lip assembly detached from the base.

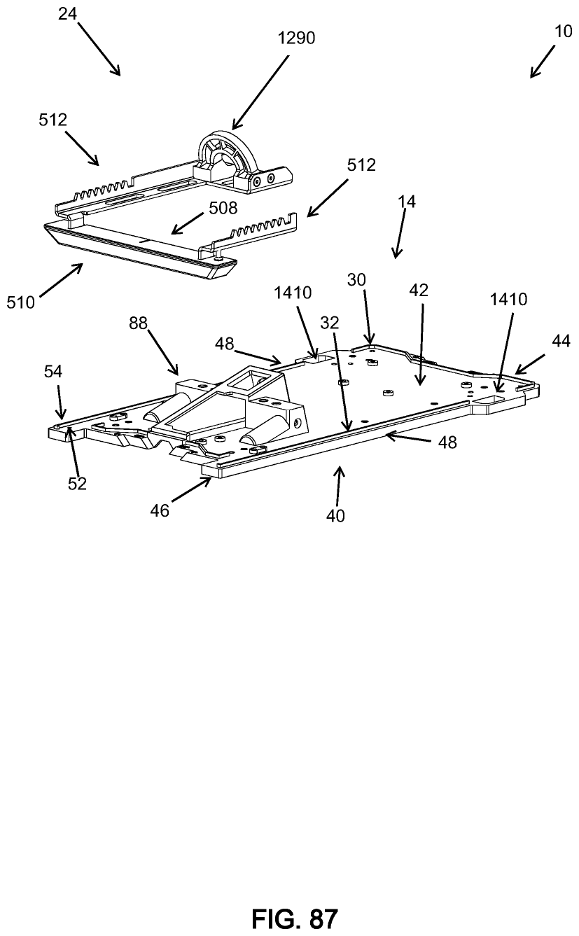

FIG. 88 shows an exploded upper rear left perspective view of a lip assembly of a pocket hole drilling system, in accordance with one or more arrangements.

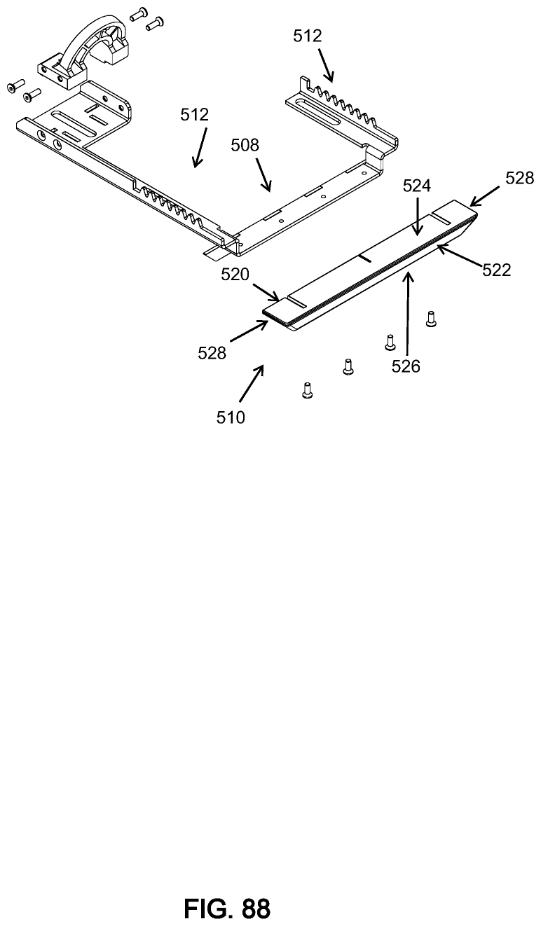

FIG. 89 shows an upper rear left perspective view of a lip support frame of a lip assembly of a pocket hole drilling system, in accordance with one or more arrangements.

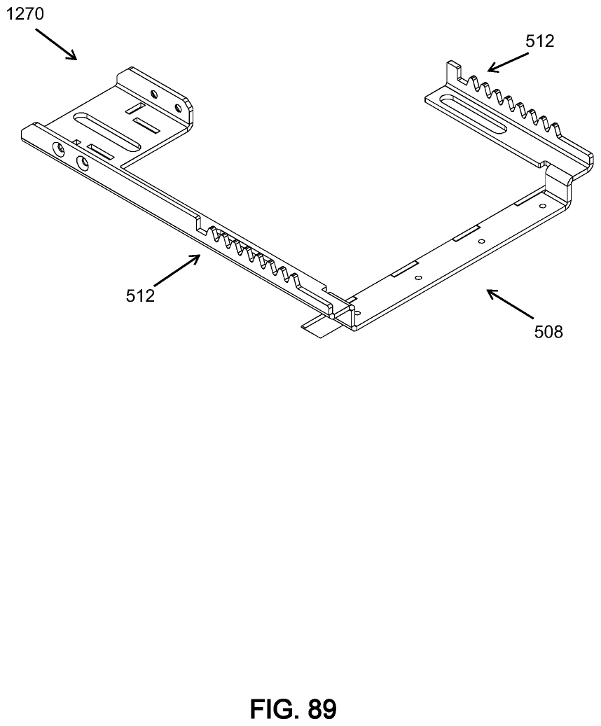

FIG. 90 shows an upper rear right perspective view of a lip support frame of a lip assembly of a pocket hole drilling system, in accordance with one or more arrangements.

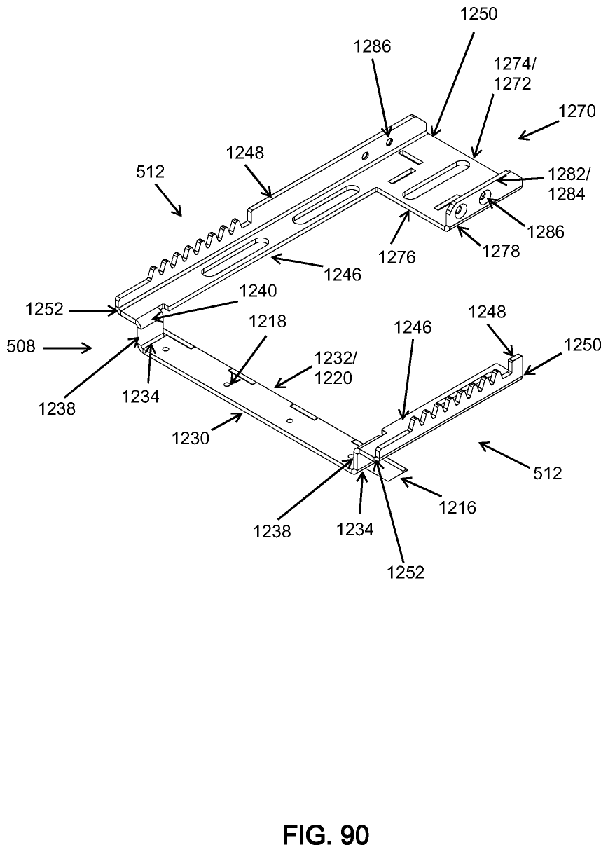

FIG. 91 shows an upper front right perspective view of a lip support frame of a lip assembly of a pocket hole drilling system, in accordance with one or more arrangements.

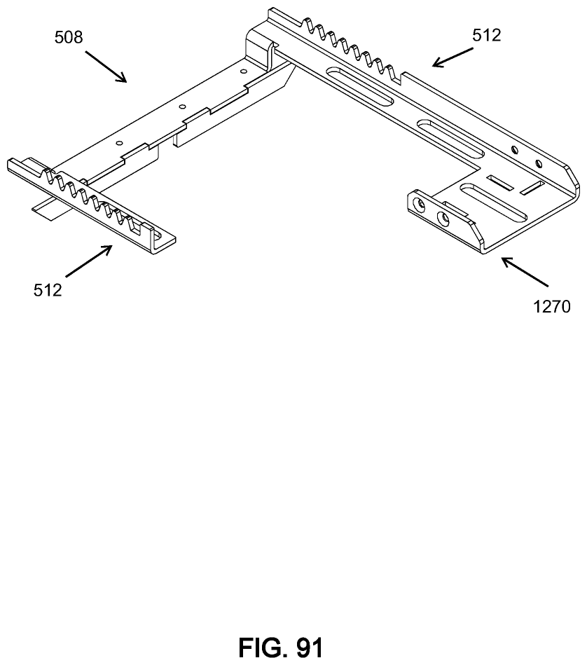

FIG. 92 shows an upper front left perspective view of a lip support frame of a lip assembly of a pocket hole drilling system, in accordance with one or more arrangements.

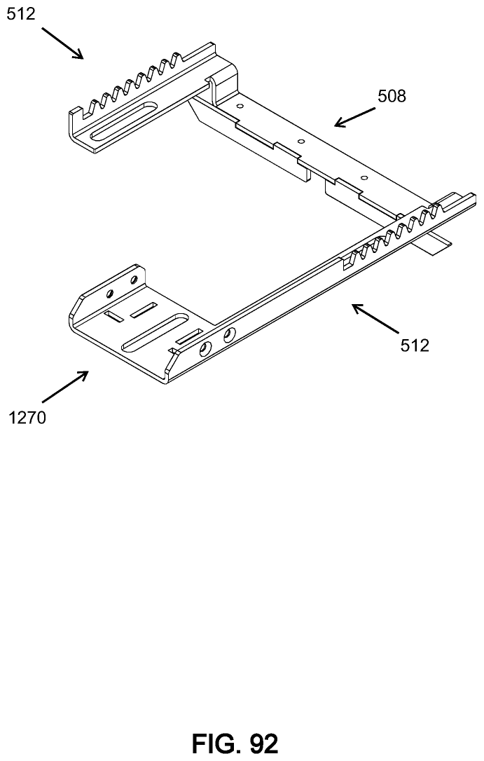

FIG. 93 shows a lower rear left perspective view of a lip support frame of a lip assembly of a pocket hole drilling system, in accordance with one or more arrangements.

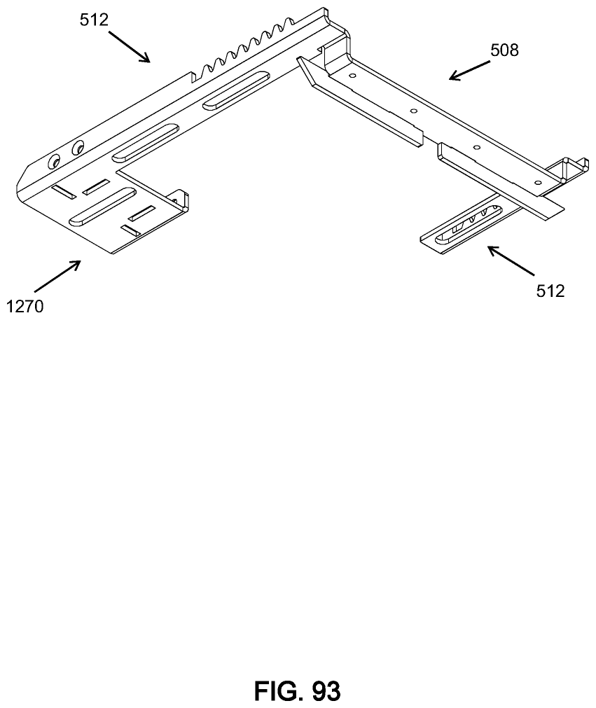

FIG. 94 shows a lower rear left perspective view of a lip support frame of a lip assembly of a pocket hole drilling system, in accordance with one or more arrangements.

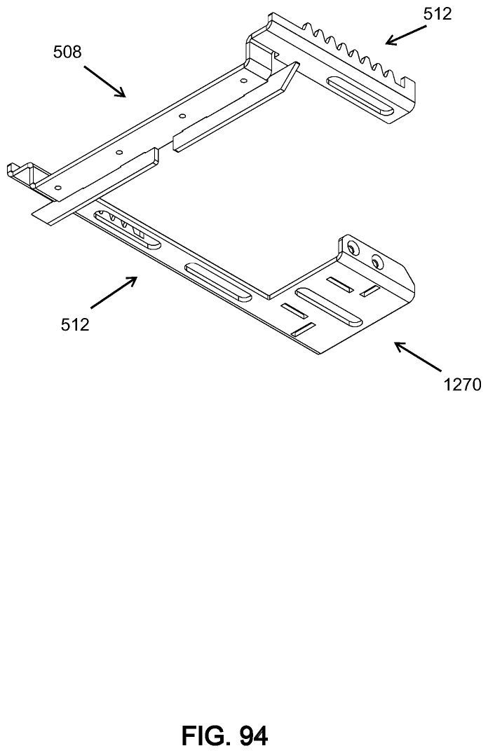

FIG. 95 shows a lower front right perspective view of a lip support frame of a lip assembly of a pocket hole drilling system, in accordance with one or more arrangements.

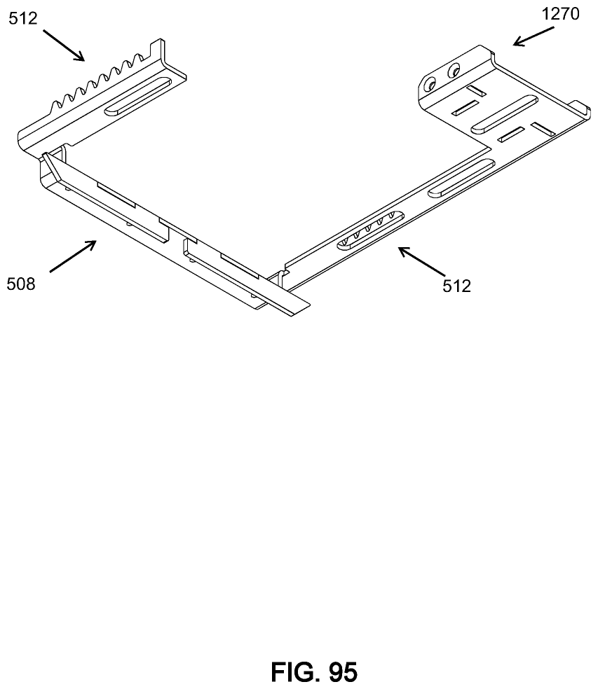

FIG. 96 shows a lower front left perspective view of a lip support frame of a lip assembly of a pocket hole drilling system, in accordance with one or more arrangements.

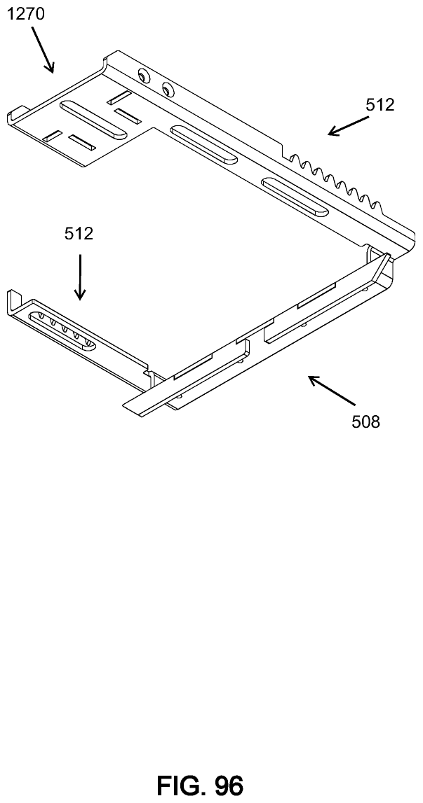

FIG. 97 shows a left view of a lip support frame of a lip assembly of a pocket hole drilling system, in accordance with one or more arrangements.

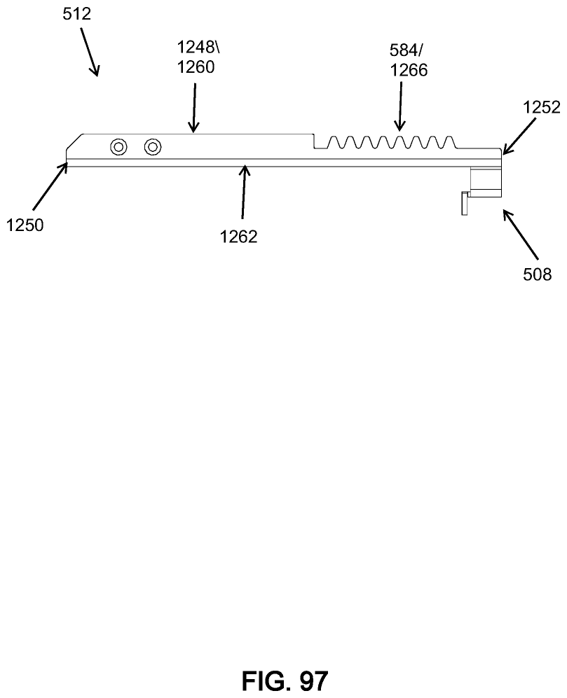

FIG. 98 shows a right view of a lip support frame of a lip assembly of a pocket hole drilling system, in accordance with one or more arrangements.

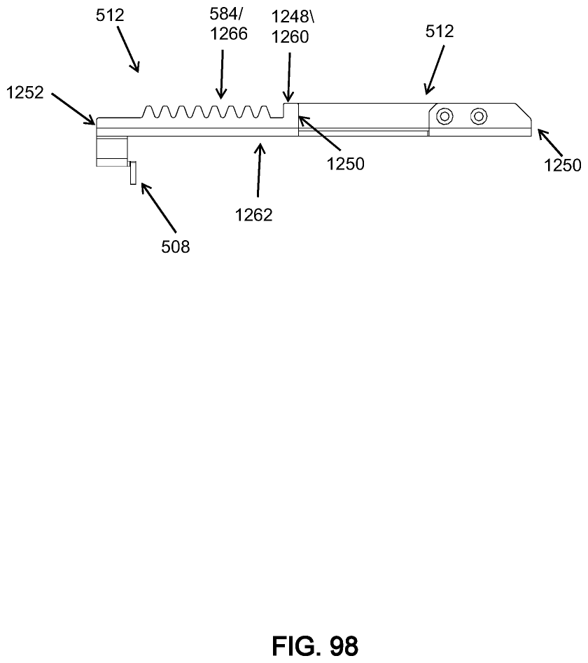

FIG. 99 shows a front view of a lip support frame of a lip assembly of a pocket hole drilling system, in accordance with one or more arrangements.

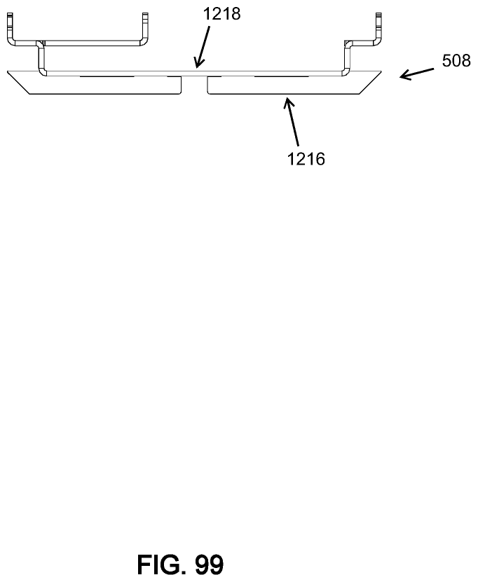

FIG. 100 shows a rear view of a lip support frame of a lip assembly of a pocket hole drilling system, in accordance with one or more arrangements.

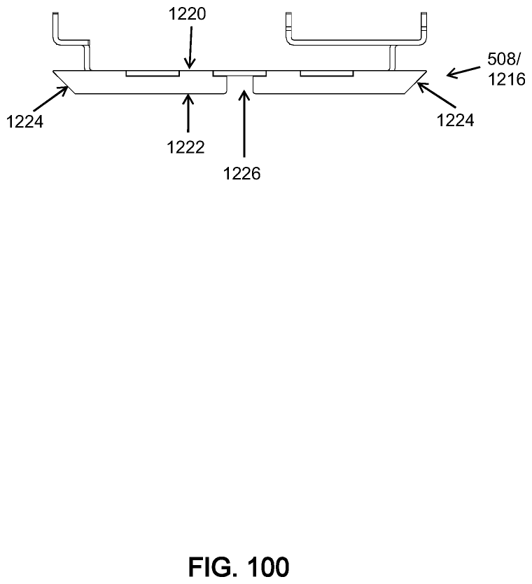

FIG. 101 shows a top view of a lip support frame of a lip assembly of a pocket hole drilling system, in accordance with one or more arrangements.

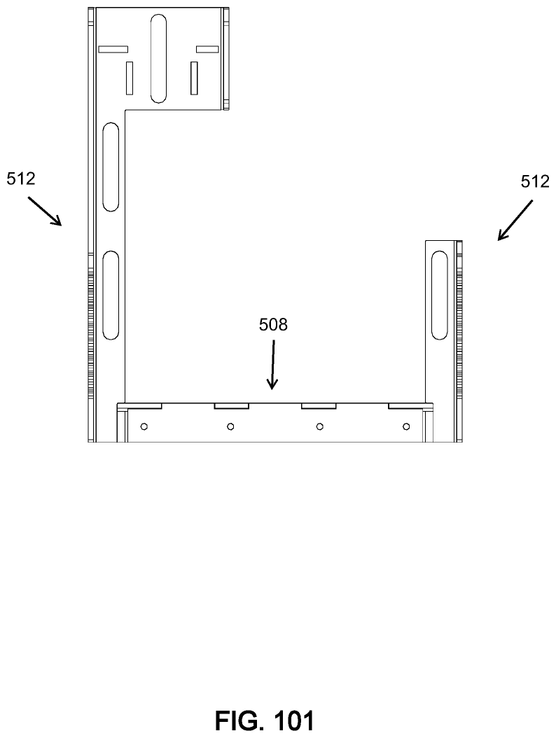

FIG. 102 shows a bottom view of a lip support frame of a lip assembly of a pocket hole drilling system, in accordance with one or more arrangements.

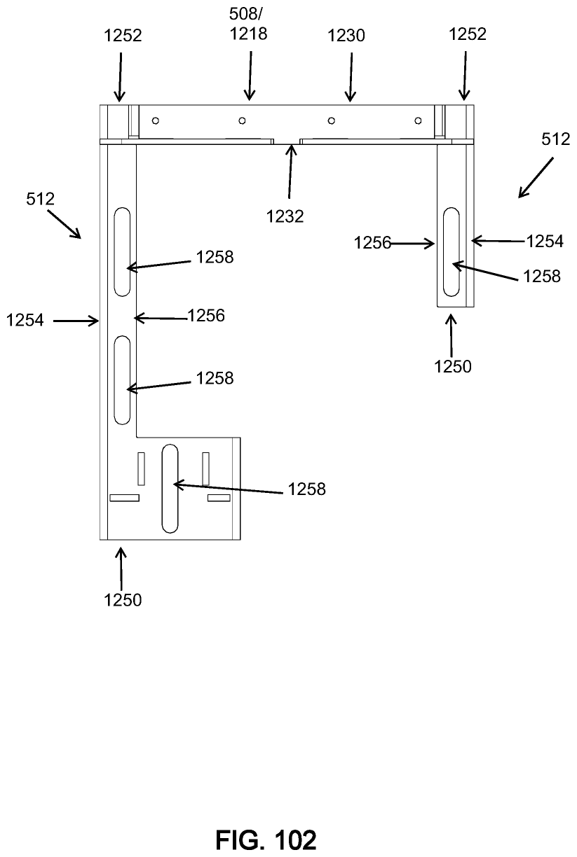

FIG. 103 shows a partially assembled upper front left perspective view of a pocket hole drilling system, in accordance with one or more arrangements; the view showing the system with the housing, drill motor, actuation assembly, and rear handle assembly omitted; the view showing a rear adjustment assembly for moving sliding lip member.

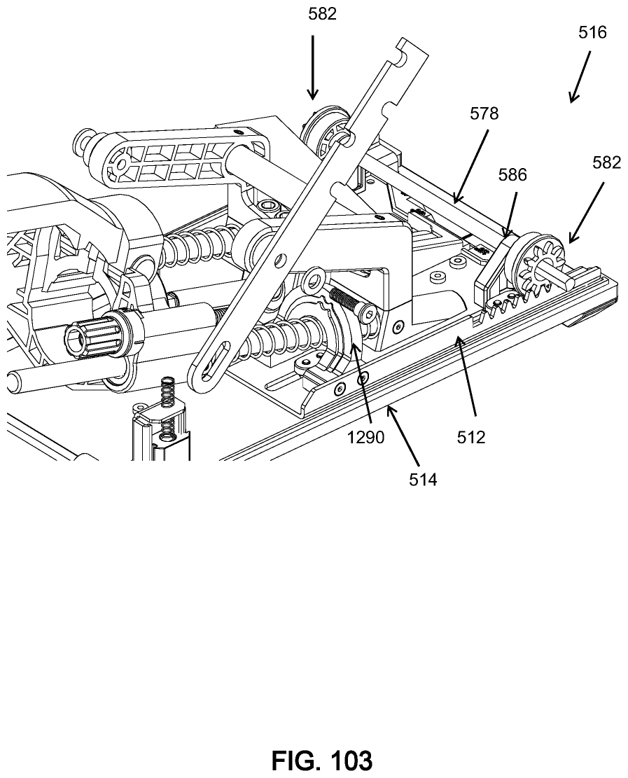

FIG. 104 shows an upper front right perspective view of a pocket hole drilling system, in accordance with one or more arrangements; the view showing the system with the housing, drilling assembly, actuation assembly, and rear handle assembly omitted; the view showing a rear adjustment assembly for moving sliding lip member.

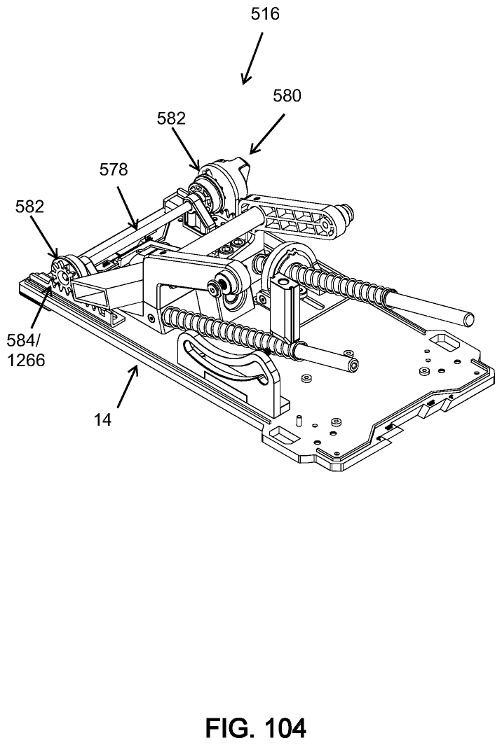

FIG. 105 shows an exploded perspective view of a rear adjustment assembly for moving sliding lip member of a pocket hole drilling system, in accordance with one or more arrangements.

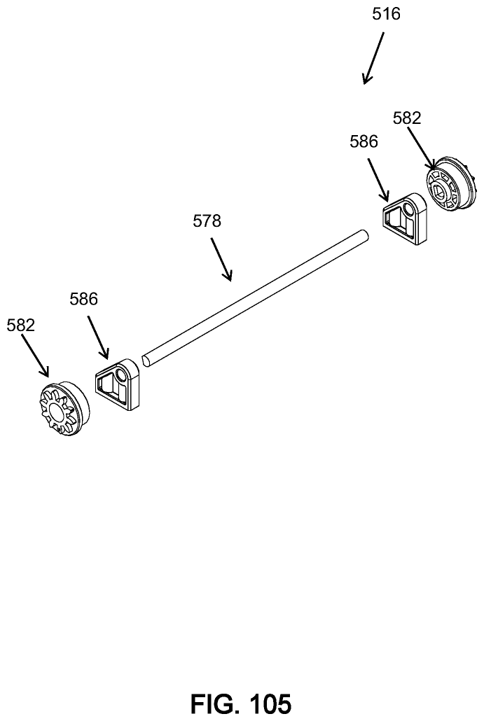

FIG. 106 shows a partial left view of a pocket hole drilling system, in accordance with one or more arrangements; the view showing the housing and rear handle assembly omitted; the view showing a close up of a rear adjustment assembly for moving sliding lip member.

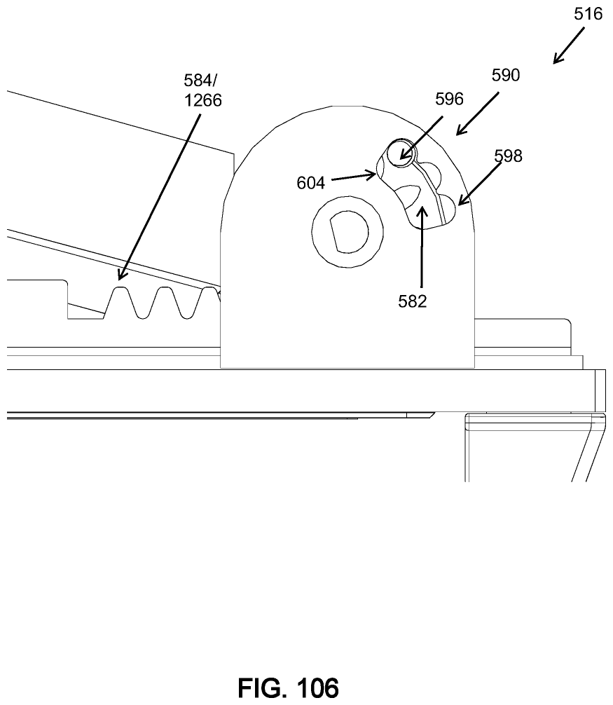

FIG. 107 shows a partial upper rear left perspective view of a pocket hole drilling system, in accordance with one or more arrangements; the view showing the housing and rear handle omitted; the view showing a close up of a rear adjustment assembly for moving sliding lip member.

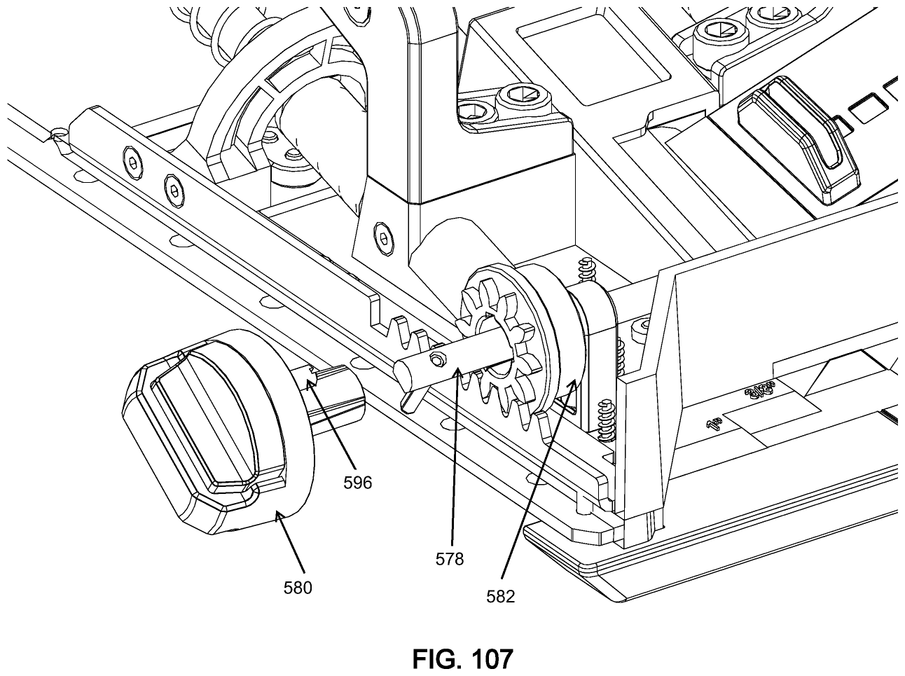

FIG. 108 shows an upper rear left perspective view of a housing and rear handle assembly of a pocket hole drilling system, in accordance with one or more arrangements.

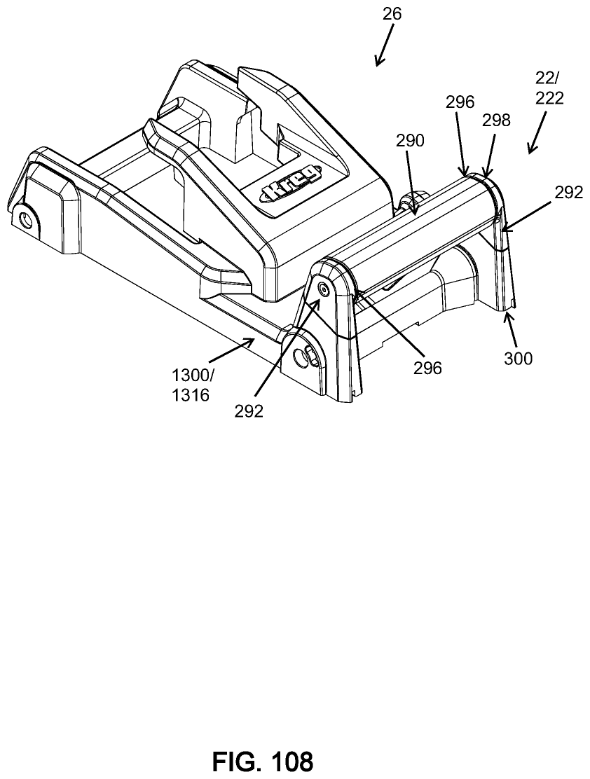

FIG. 109 shows an upper rear right perspective view of a housing and rear handle assembly of a pocket hole drilling system, in accordance with one or more arrangements.

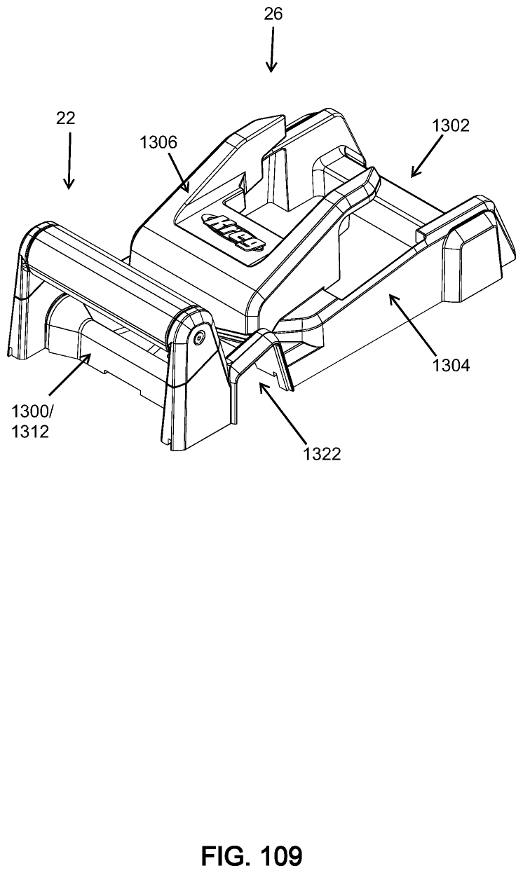

FIG. 110 shows an upper front right perspective view of a housing and rear handle assembly of a pocket hole drilling system, in accordance with one or more arrangements.

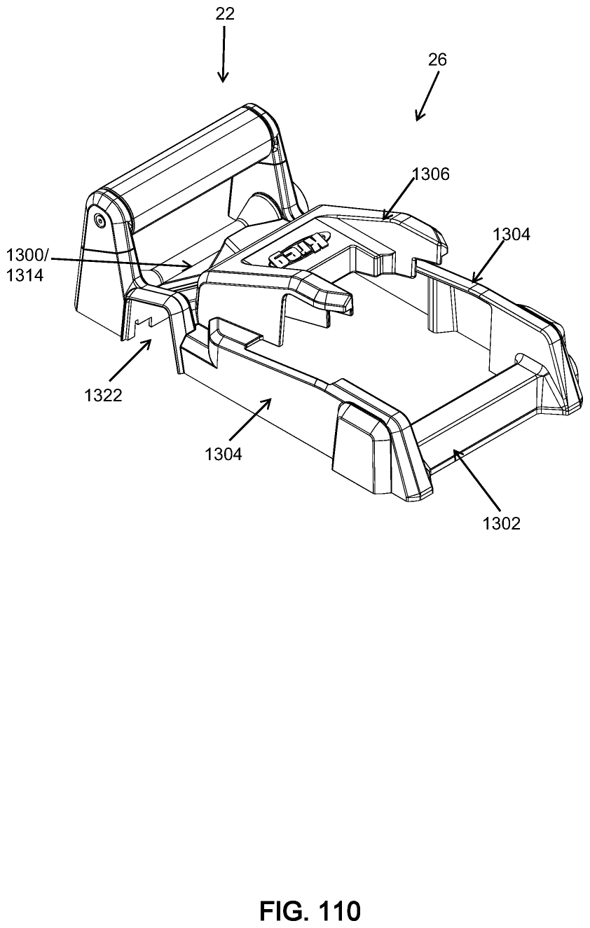

FIG. 111 shows an upper front left perspective view of a housing and rear handle assembly of a pocket hole drilling system, in accordance with one or more arrangements.

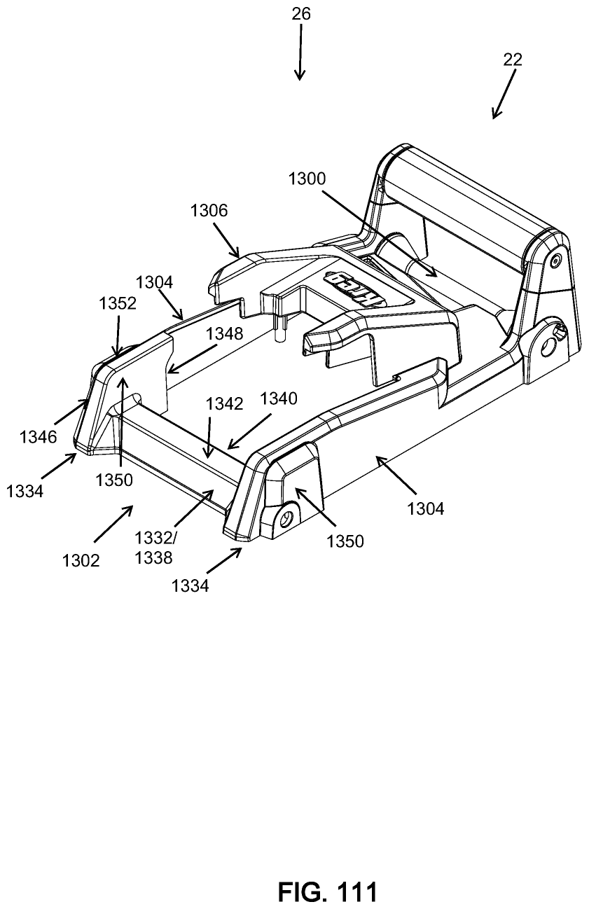

FIG. 112 shows a lower rear left perspective view of a housing and rear handle assembly of a pocket hole drilling system, in accordance with one or more arrangements.

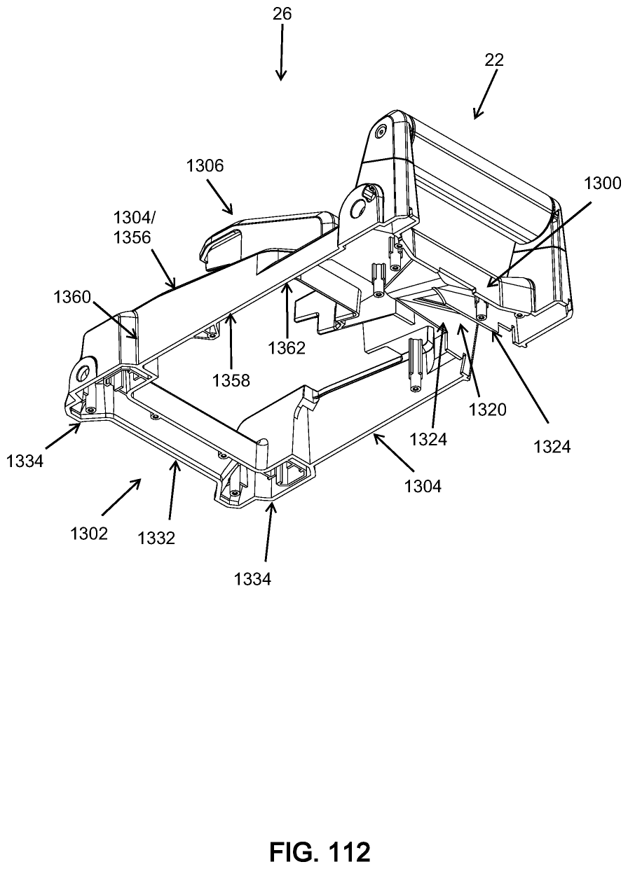

FIG. 113 shows a lower rear right perspective view of a housing and rear handle assembly of a pocket hole drilling system, in accordance with one or more arrangements.

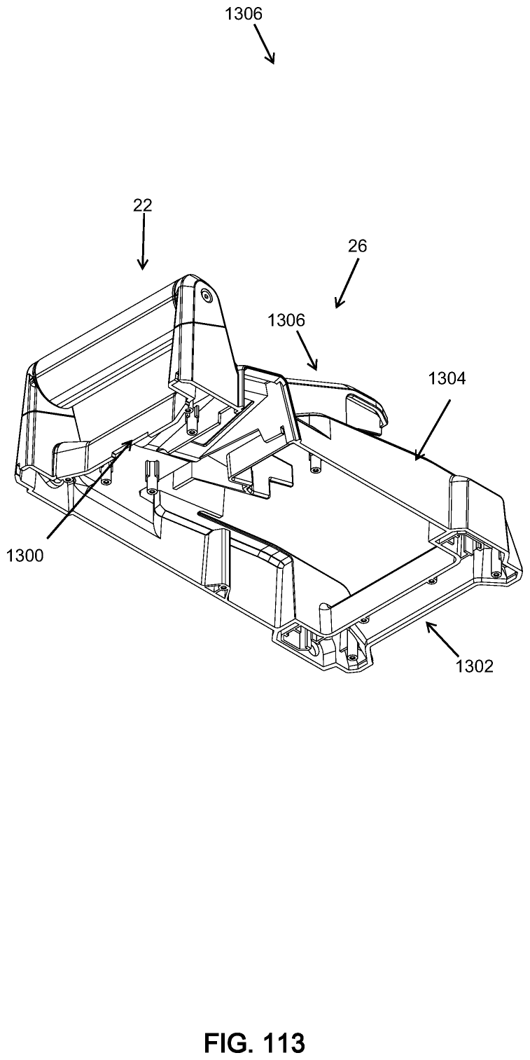

FIG. 114 shows a lower front right perspective view of a housing and rear handle assembly of a pocket hole drilling system, in accordance with one or more arrangements.

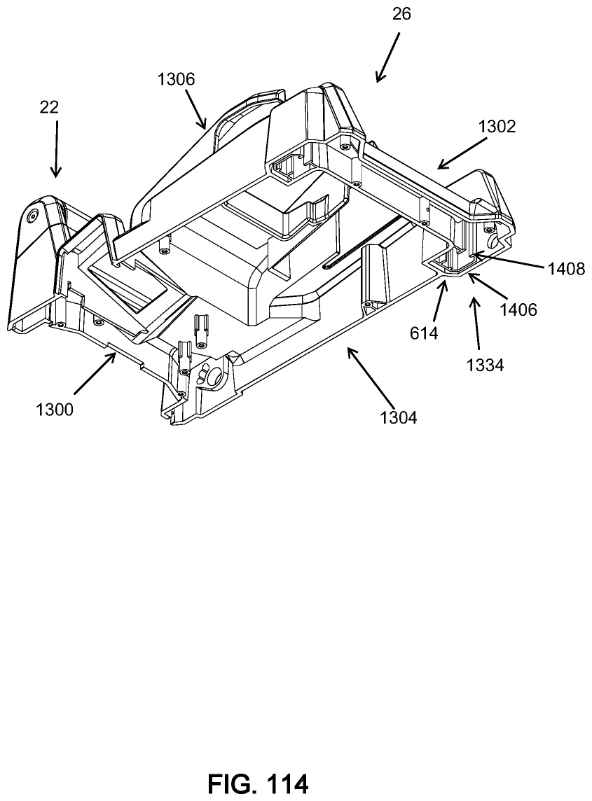

FIG. 115 shows a lower front left perspective view of a housing and rear handle assembly of a pocket hole drilling system, in accordance with one or more arrangements.

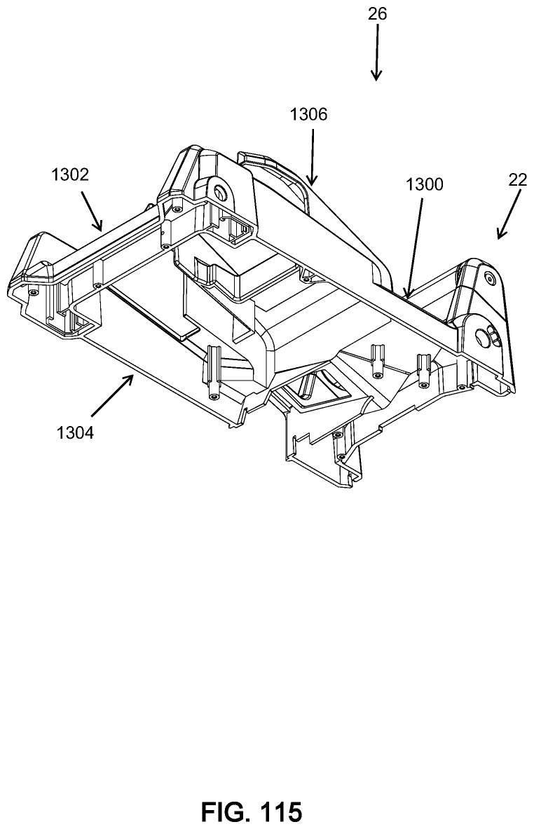

FIG. 116 shows a left view of a housing and rear handle assembly of a pocket hole drilling system, in accordance with one or more arrangements.

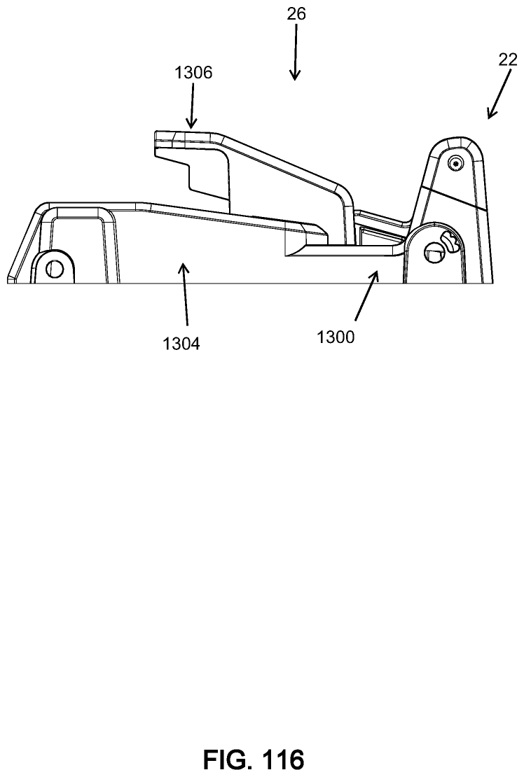

FIG. 117 shows a right view of a housing and rear handle assembly of a pocket hole drilling system, in accordance with one or more arrangements.

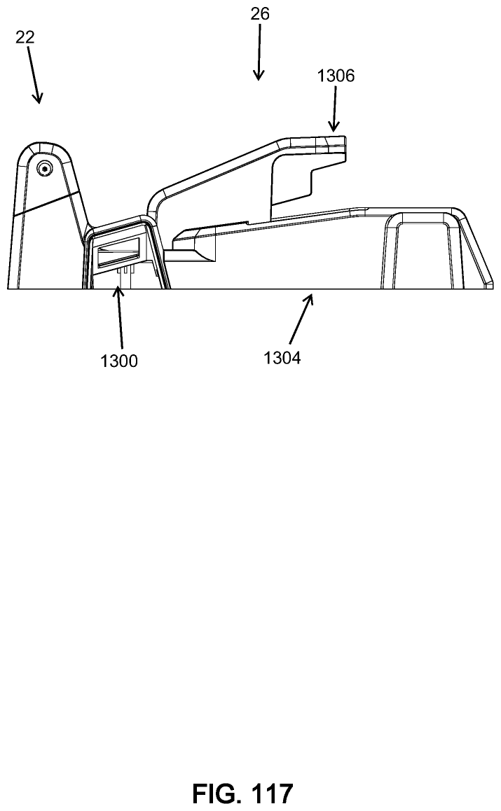

FIG. 118 shows a rear view of a housing and rear handle assembly of a pocket hole drilling system, in accordance with one or more arrangements.

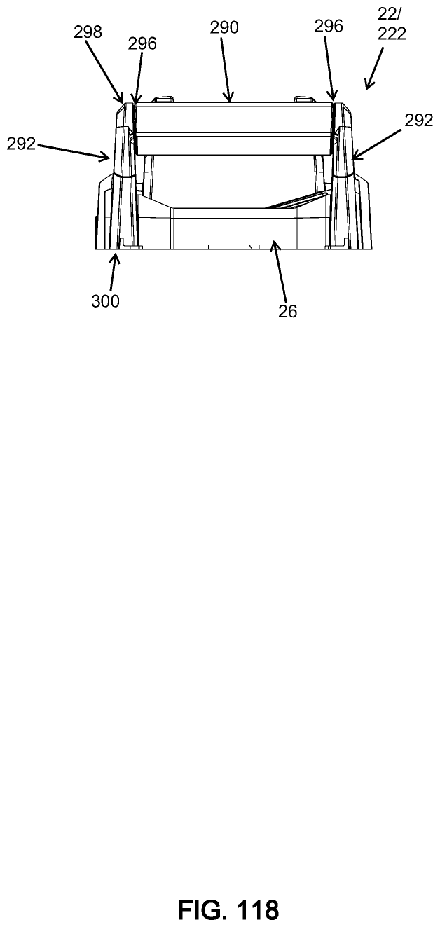

FIG. 119 shows a front view of a housing and rear handle assembly of a pocket hole drilling system, in accordance with one or more arrangements.

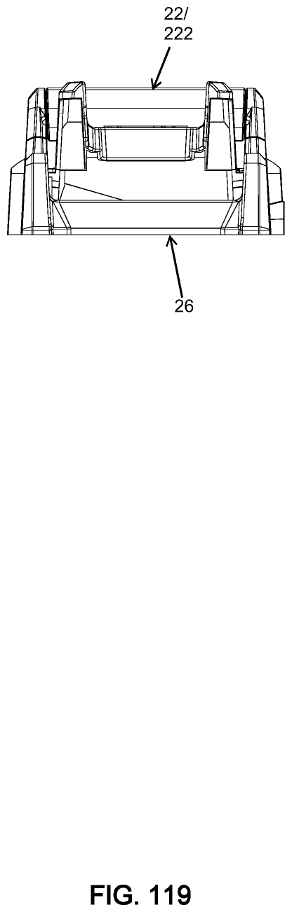

FIG. 120 shows a top view of a housing and rear handle assembly of a pocket hole drilling system, in accordance with one or more arrangements.

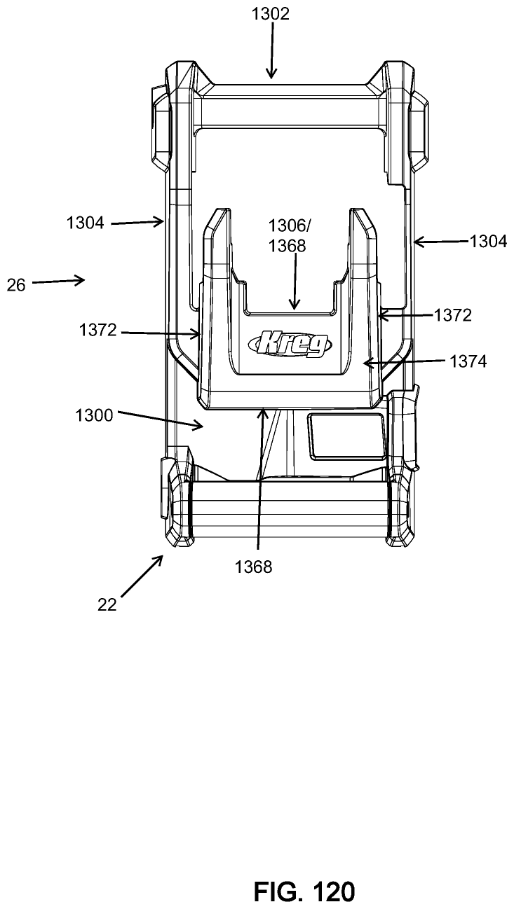

FIG. 121 shows a bottom view of a housing and rear handle assembly of a pocket hole drilling system, in accordance with one or more arrangements.

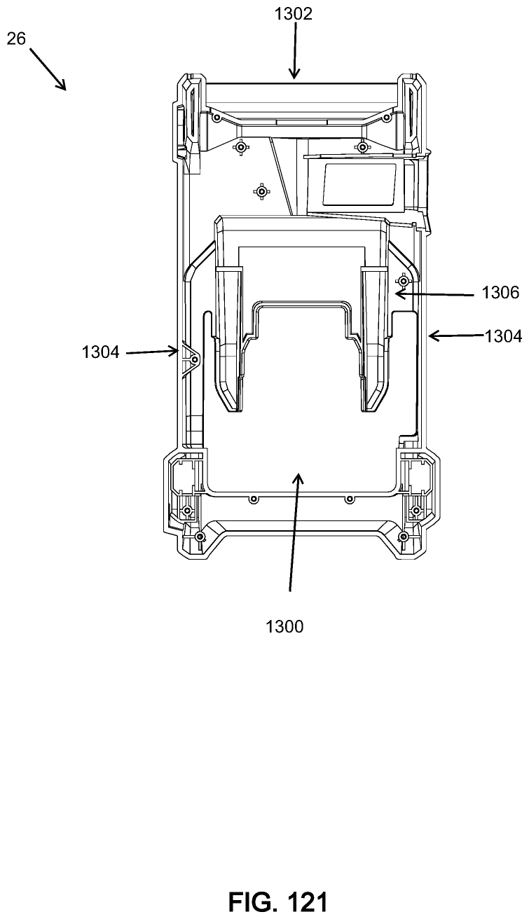

FIG. 122 shows an upper rear right perspective view of a right support leg of a front support assembly of a pocket hole drilling system, in accordance with one or more arrangements.

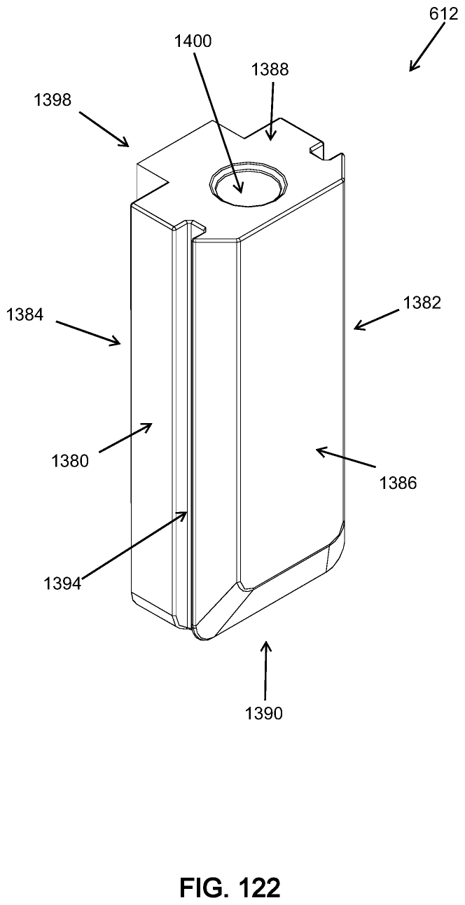

FIG. 123 shows an upper front right perspective view of a right support leg of a front support assembly of a pocket hole drilling system, in accordance with one or more arrangements.

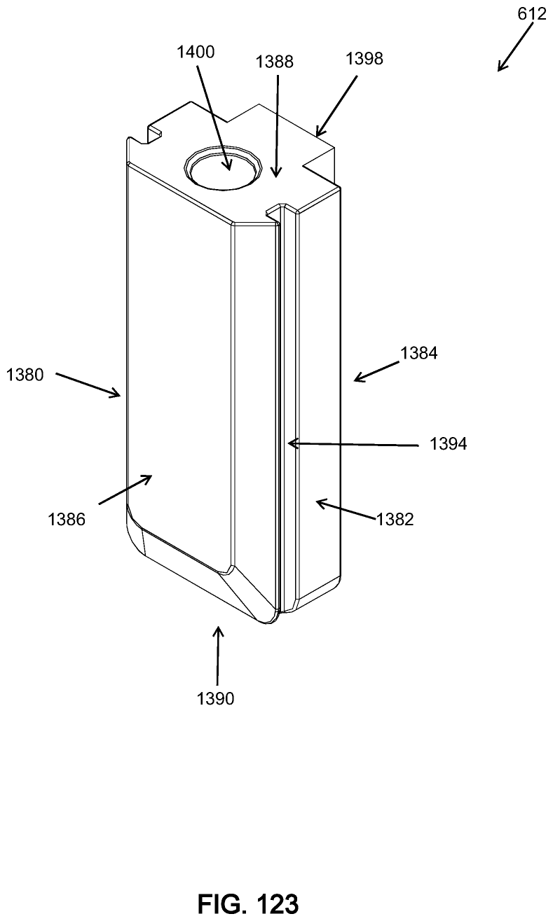

FIG. 124 shows an upper front left perspective view of a right support leg of a front support assembly of a pocket hole drilling system, in accordance with one or more arrangements.

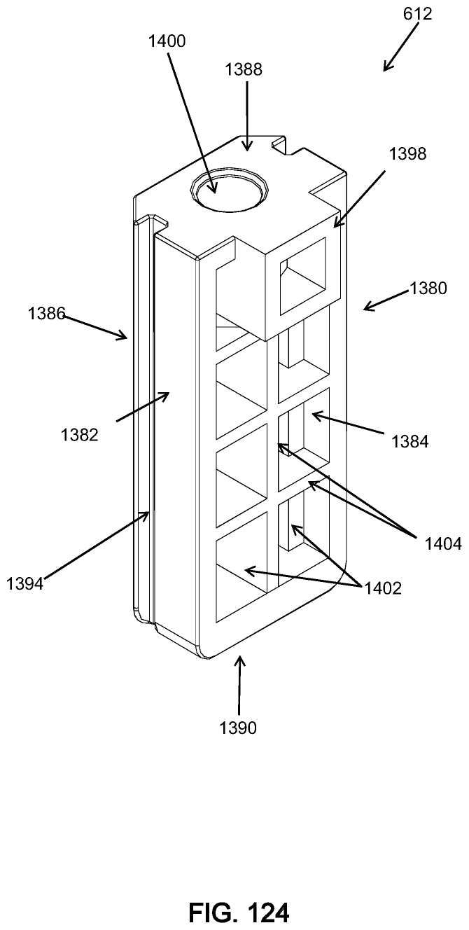

FIG. 125 shows an upper rear left perspective view of a right support leg of a front support assembly of a pocket hole drilling system, in accordance with one or more arrangements.

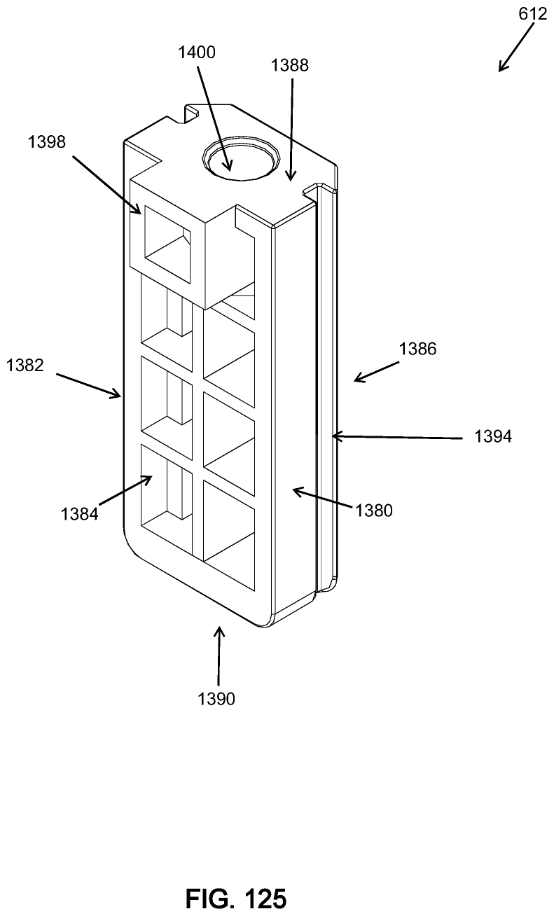

FIG. 126 shows a lower front left perspective view of a right support leg of a front support assembly of a pocket hole drilling system, in accordance with one or more arrangements.

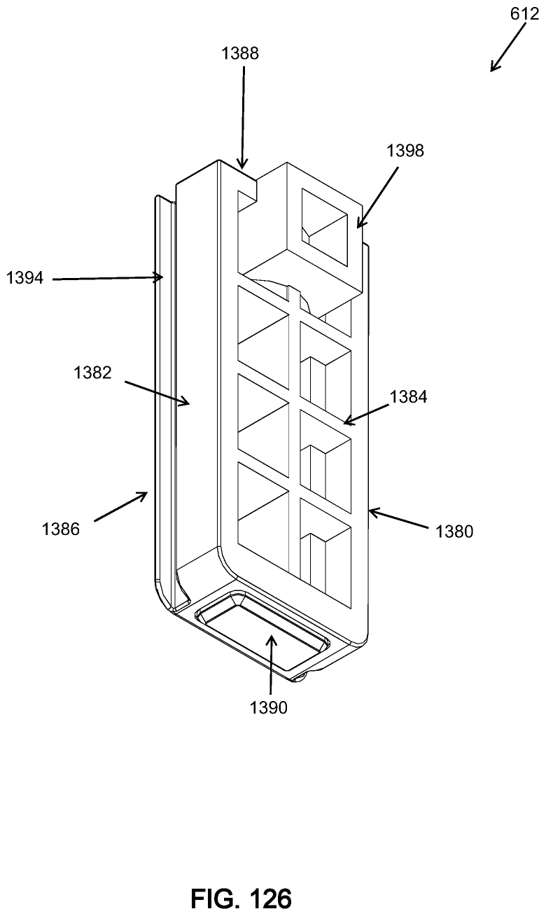

FIG. 127 shows a lower rear left perspective view of a right support leg of a front support assembly of a pocket hole drilling system, in accordance with one or more arrangements.

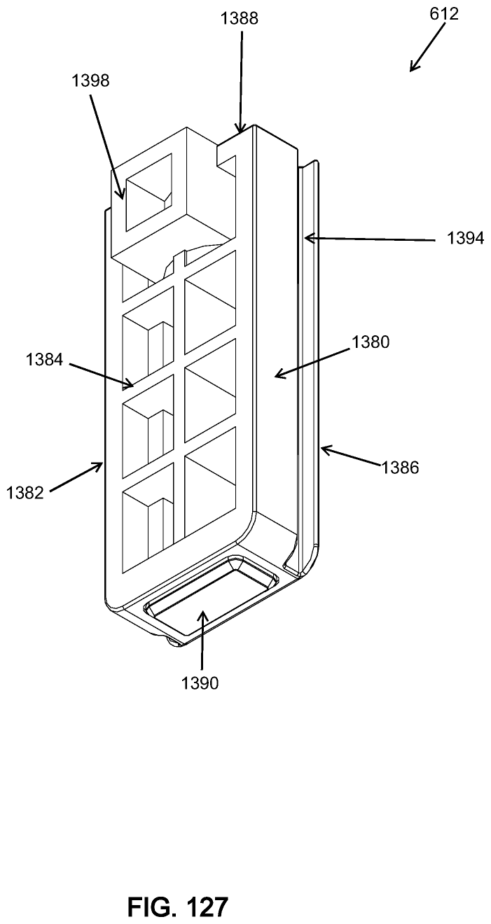

FIG. 128 shows a lower front right perspective view of a right support leg of a front support assembly of a pocket hole drilling system, in accordance with one or more arrangements.

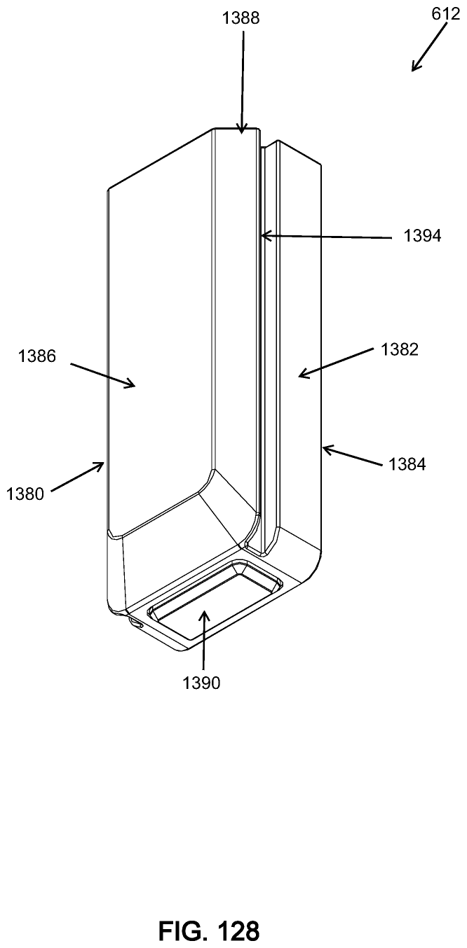

FIG. 129 shows a lower rear right perspective view of a right support leg of a front support assembly of a pocket hole drilling system, in accordance with one or more arrangements.

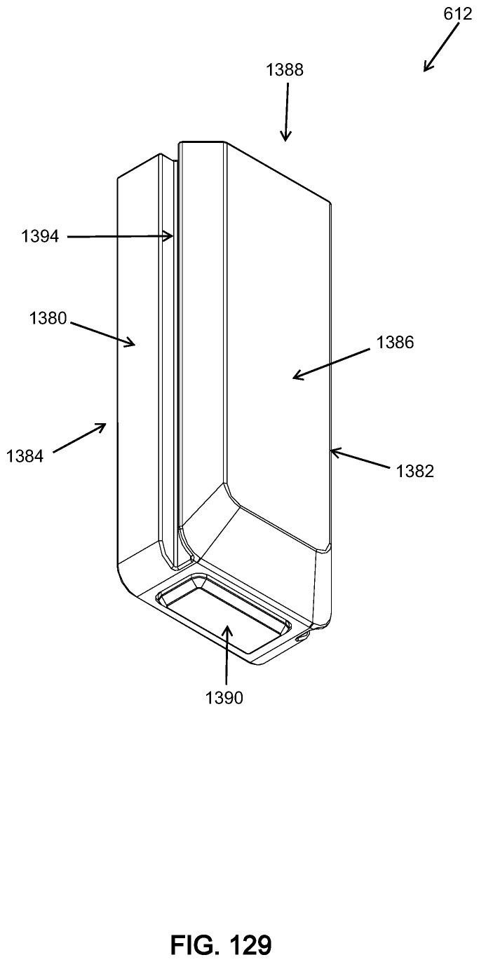

FIG. 130 shows a left view of a right support leg of a front support assembly of a pocket hole drilling system, in accordance with one or more arrangements.

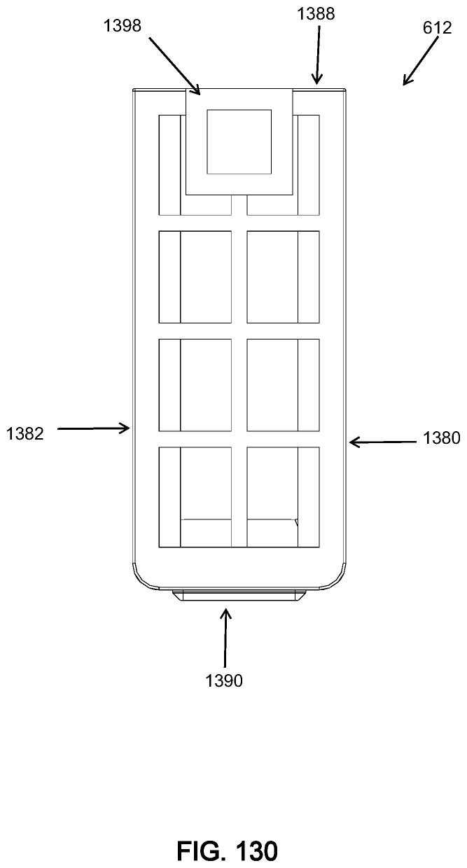

FIG. 131 shows a bottom view of a right support leg of a front support assembly of a pocket hole drilling system, in accordance with one or more arrangements.

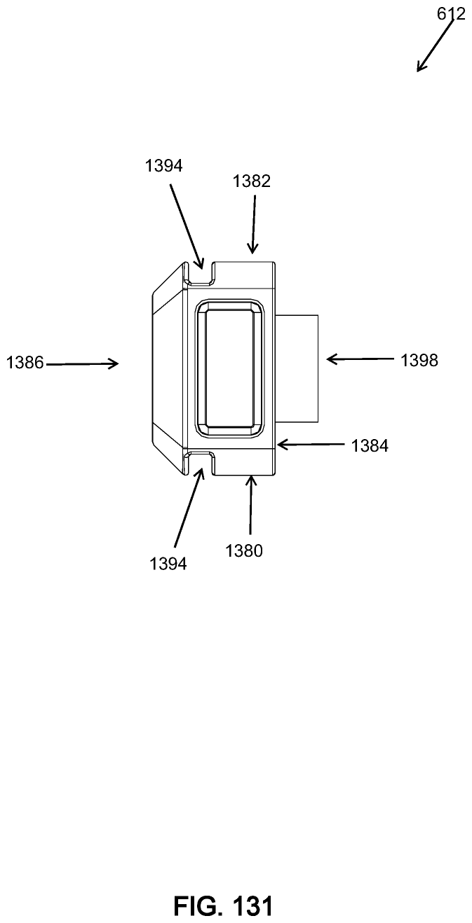

FIG. 132 shows a front view of a right support leg of a front support assembly of a front support assembly of a pocket hole drilling system, in accordance with one or more arrangements.

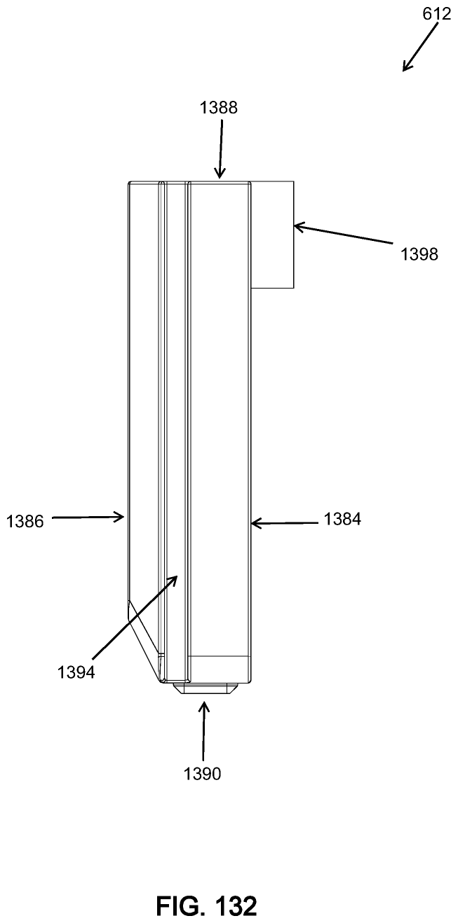

FIG. 133 shows a rear view of a right support leg of a front support assembly of a pocket hole drilling system, in accordance with one or more arrangements.

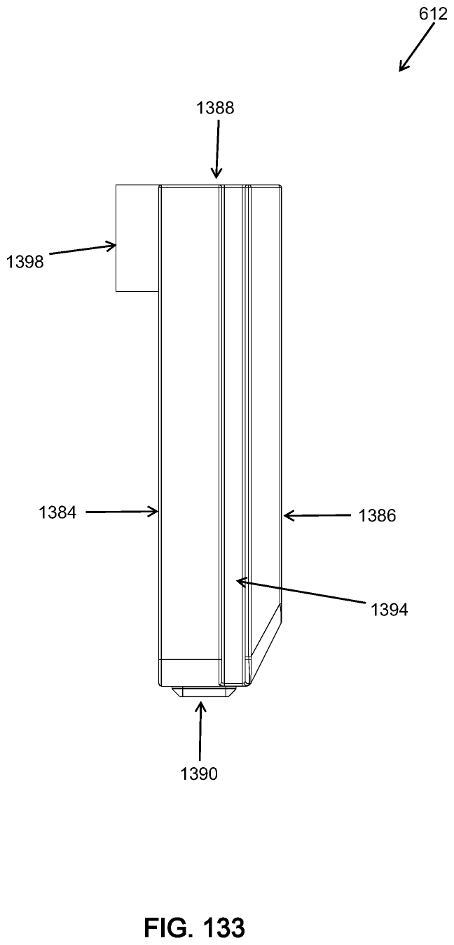

FIG. 134 shows a right view of a right support leg of a front support assembly of a pocket hole drilling system, in accordance with one or more arrangements.

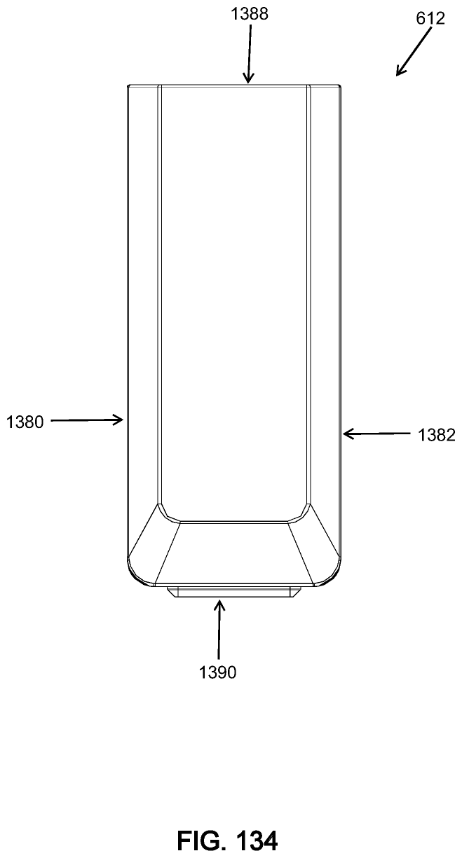

FIG. 135 shows a top view of a right support leg of a front support assembly of a pocket hole drilling system, in accordance with one or more arrangements.

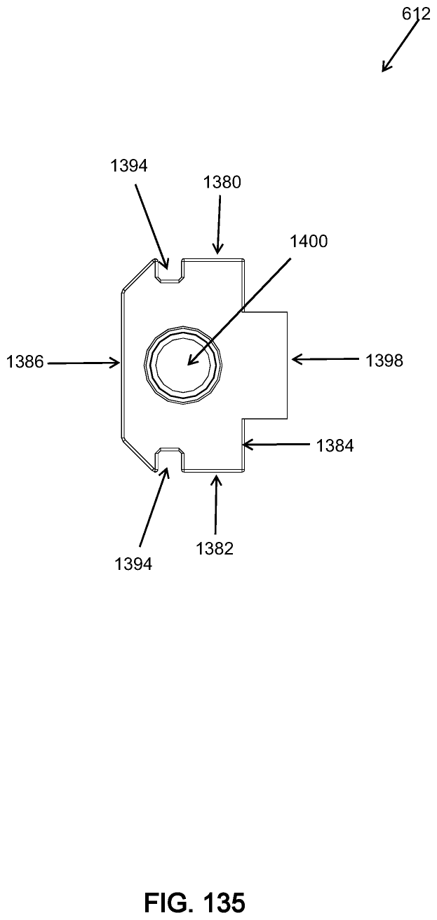

FIG. 136 shows a lower front left perspective view of a pocket hole drilling system, in accordance with one or more arrangements; the view showing support legs of a front support assembly disconnected from leg guides in the base.

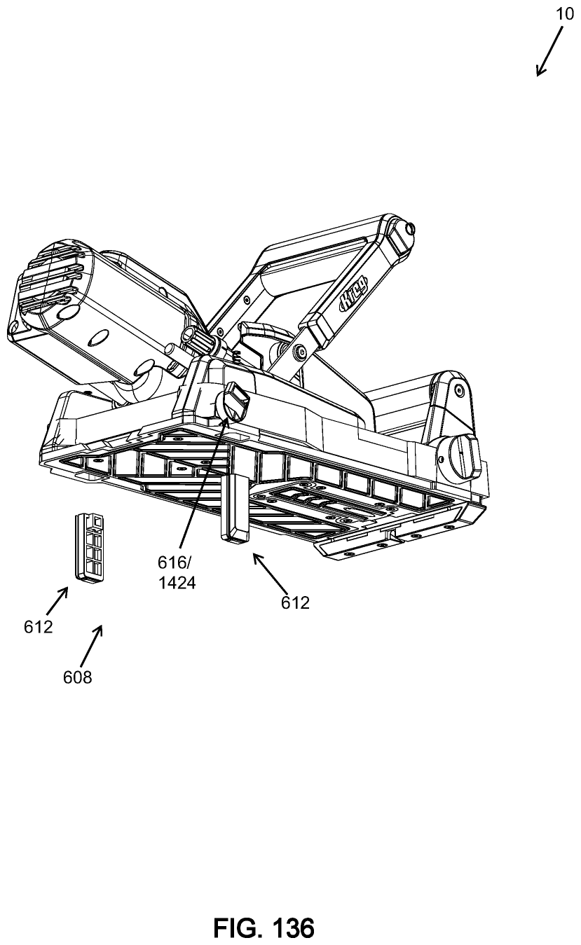

FIG. 137 shows a lower front left perspective view of a pocket hole drilling system, in accordance with one or more arrangements; the view showing support legs of a front support assembly in a partially extended position.

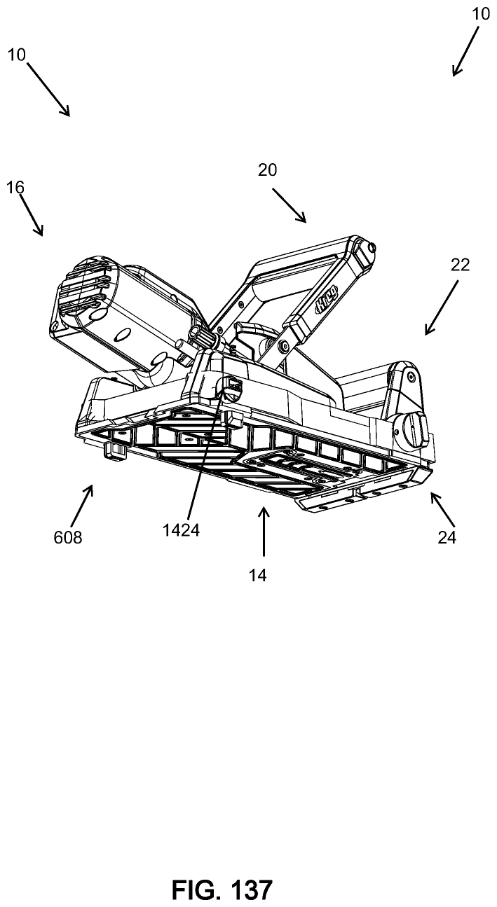

FIG. 138 shows a left view of a pocket hole drilling system, in accordance with one or more arrangements; the view showing support legs of a front support assembly in a partially extended position; the view showing housing omitted.

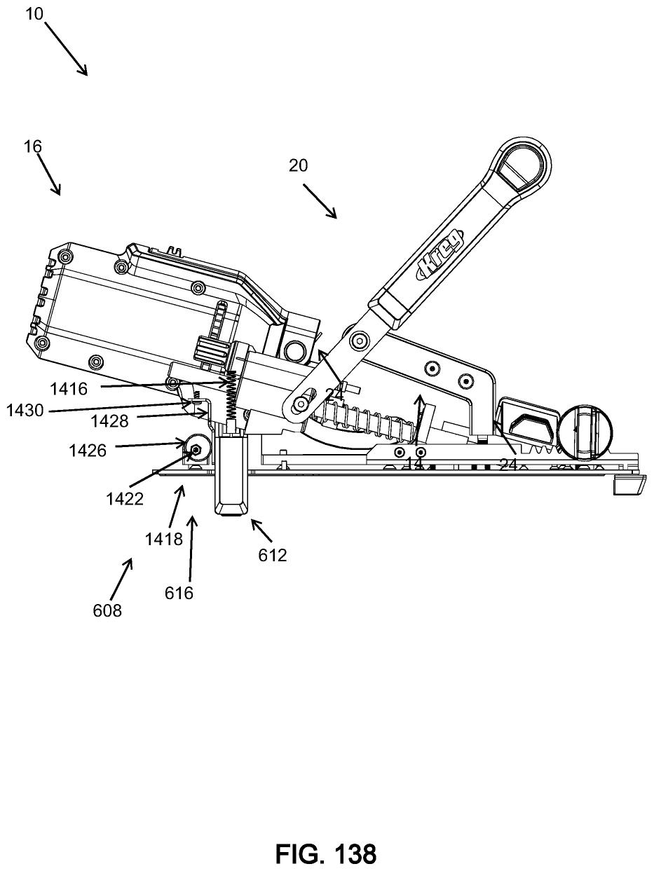

FIG. 139 shows a left view of a pocket hole drilling system, in accordance with one or more arrangements; the view showing support legs of a front support assembly in a retracted position; the view showing housing omitted.

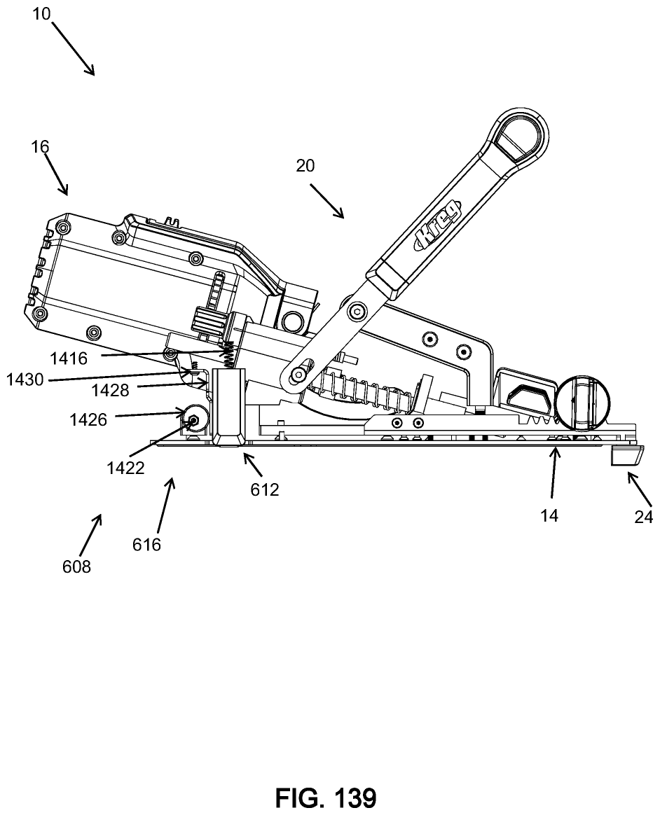

FIG. 140 shows an upper front left perspective view of a pocket hole drilling system, in accordance with one or more arrangements; the view showing support legs of a front support assembly in a partially extended position; the view showing housing omitted.

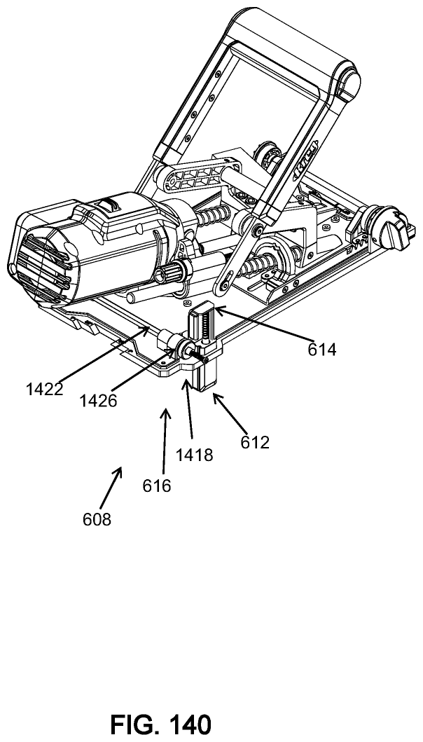

FIG. 141 shows an upper front left perspective view of a base, drill guide assembly, and front support assembly of a pocket hole drilling system, in accordance with one or more arrangements; the view showing support legs of the front support assembly in a partially extended position; the view showing housing omitted.

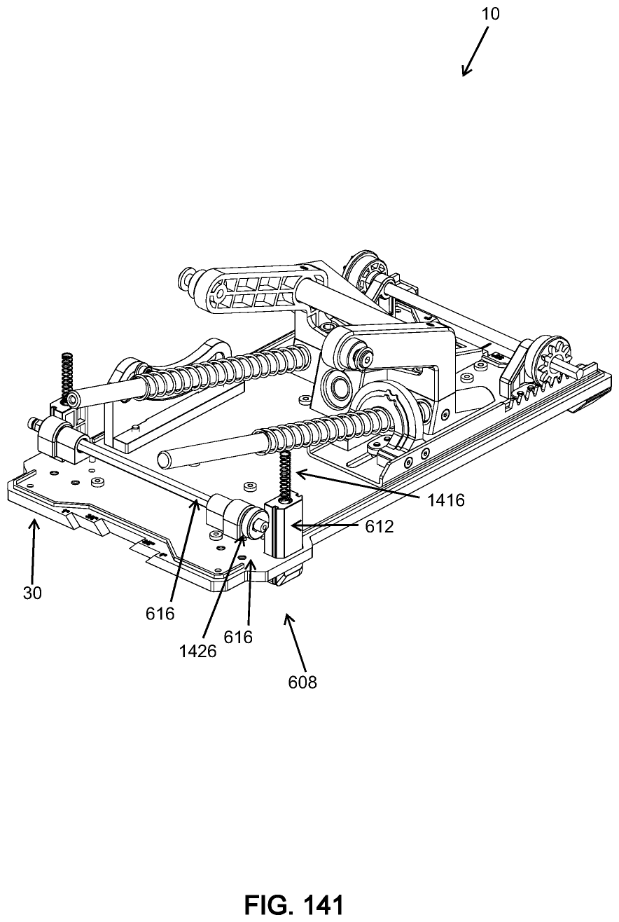

FIG. 142 shows a left view of a pocket hole drilling system, in accordance with one or more arrangements; the view showing housing omitted; the view showing a rear end of the system placed on a workpiece and support legs of a front support assembly in a retracted position.

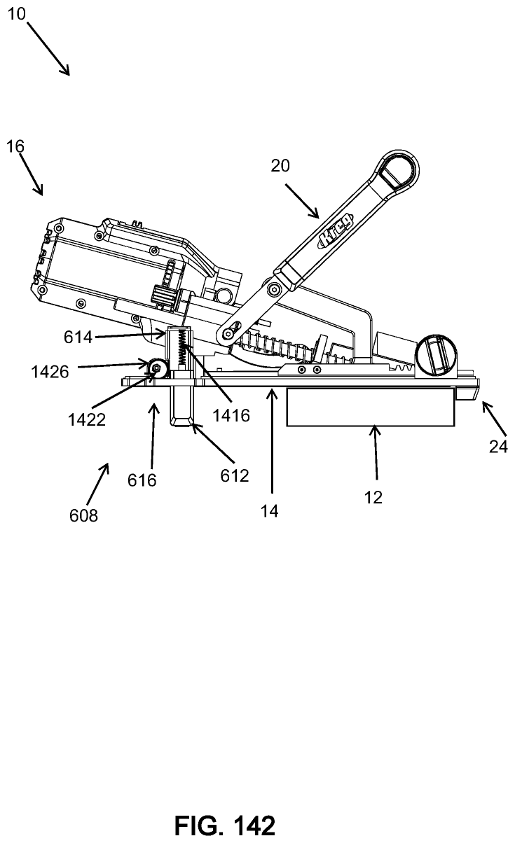

FIG. 143 shows a partial upper front left perspective view of a pocket hole drilling system, in accordance with one or more arrangements; the view showing housing omitted; the view showing close up of a front support assembly with support legs in a retracted position.

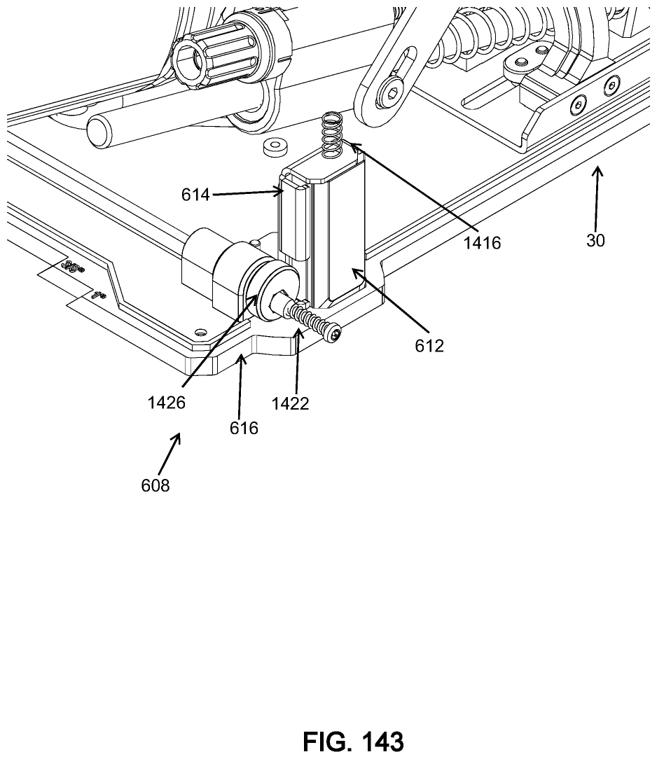

FIG. 144 shows a partial left view of a pocket hole drilling system, in accordance with one or more arrangements; the view showing housing omitted; the view showing close up of a front support assembly with support legs in a retracted position.

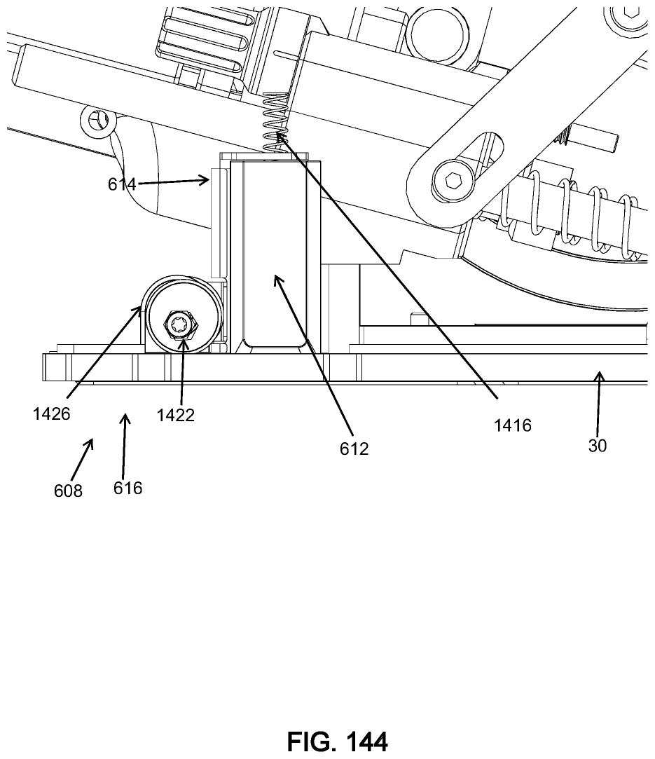

FIG. 145 shows a front view of a pocket hole drilling system, in accordance with one or more arrangements; the view showing support legs of front support assembly in an extended position.

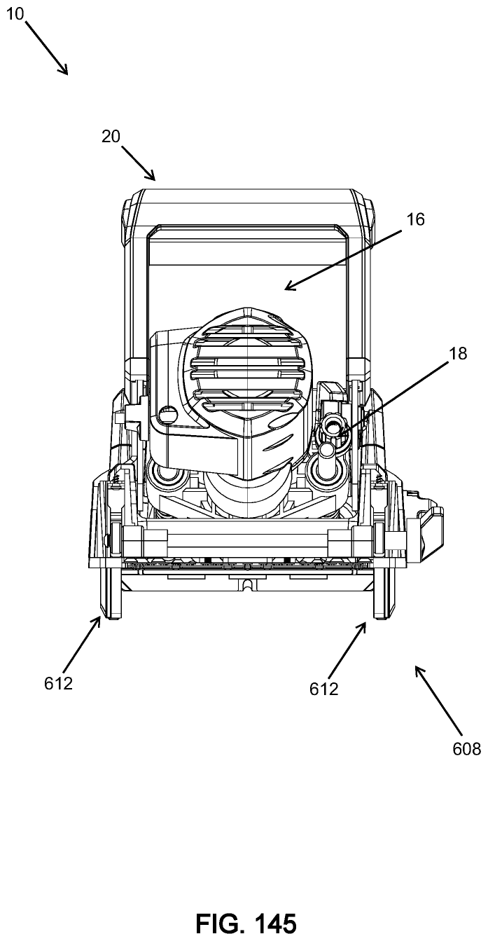

FIG. 146 shows a partial upper rear right perspective view of a cross section of a rear end of a pocket hole drilling system, in accordance with one or more arrangements; the view showing a dust and debris removal system; the view showing rear handle assembly and housing omitted.

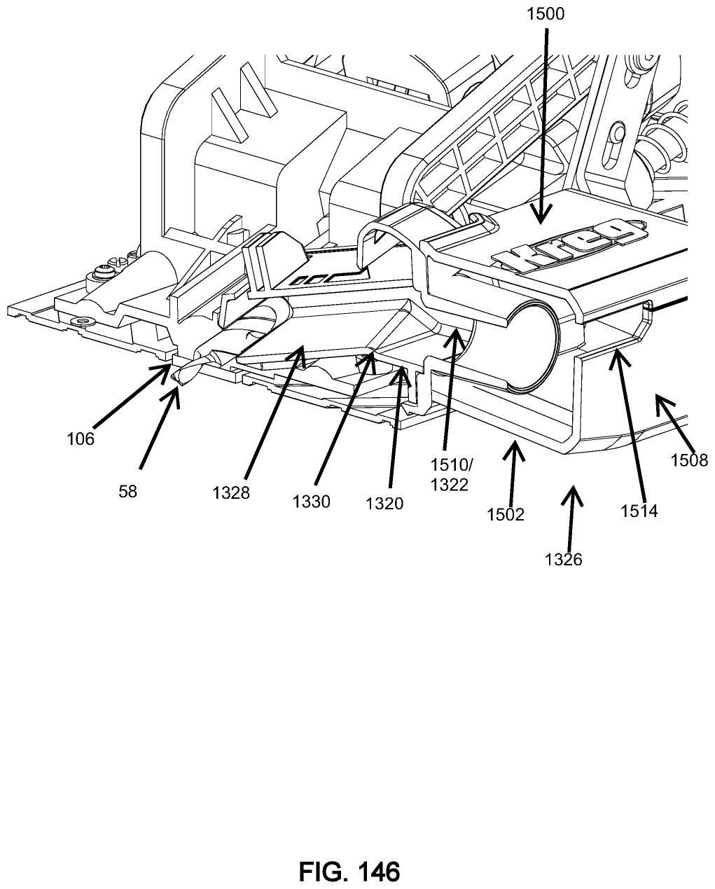

FIG. 147 shows a partial upper rear right perspective view of a rear end of a pocket hole drilling system, in accordance with one or more arrangements; the view showing a dust and debris removal system; the view showing rear handle assembly and housing omitted.

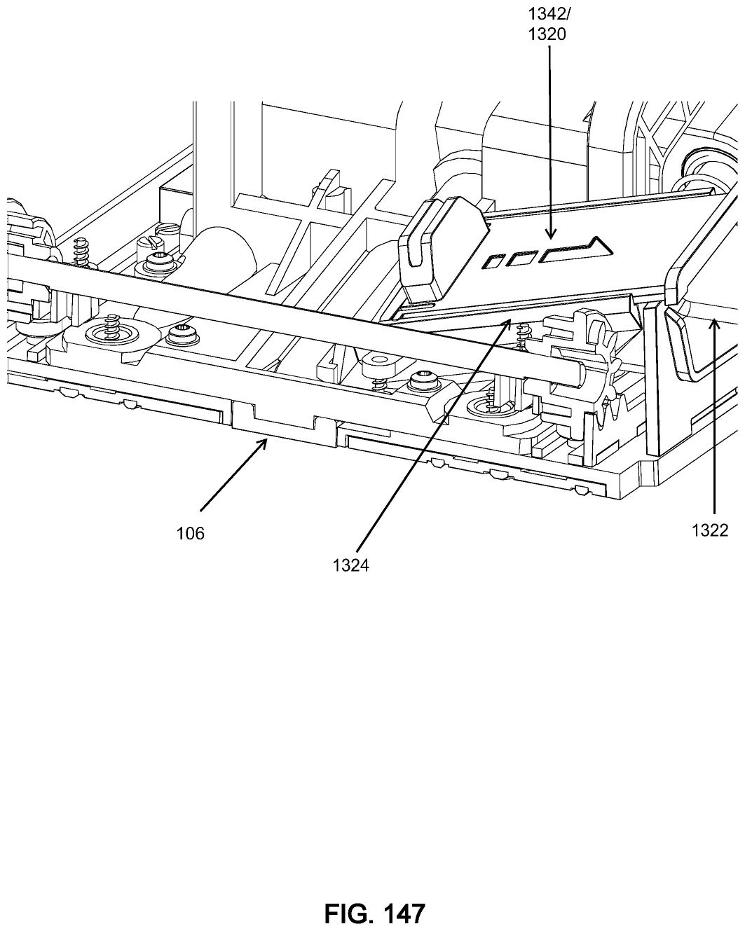

FIG. 148 shows an upper rear left perspective view of a lower portion of a passageway for dust and debris removal in a pocket hole drilling system, in accordance with one or more arrangements.

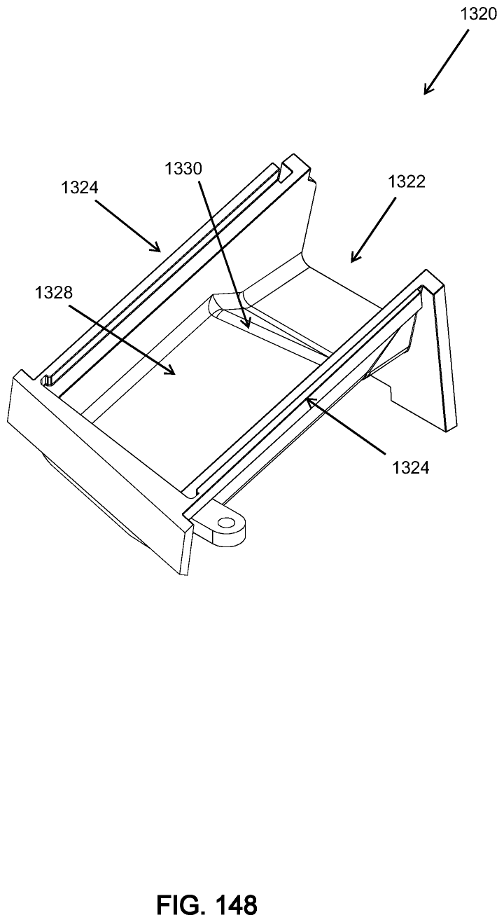

FIG. 149 shows a lower rear left perspective view of a lower portion of a passageway for dust and debris removal in a pocket hole drilling system, in accordance with one or more arrangements.

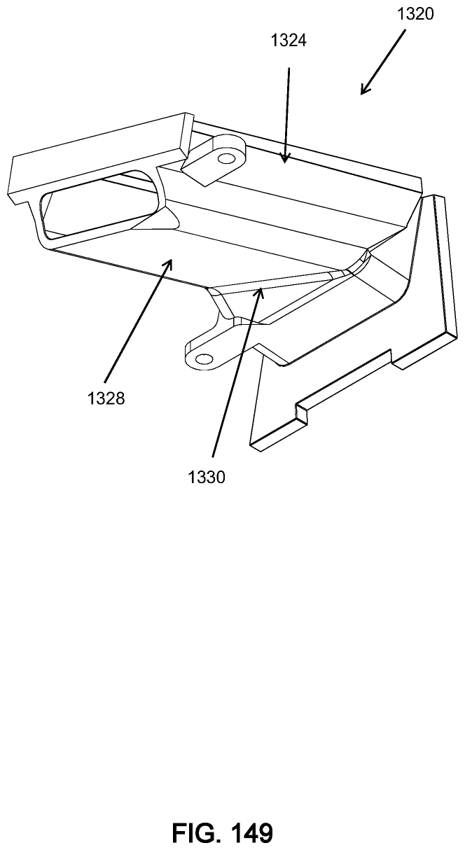

FIG. 150 shows an upper front right perspective view of a pocket hole drilling system, in accordance with one or more arrangements; the view showing a dust collector positioned for attachment to the pocket hole drilling system.

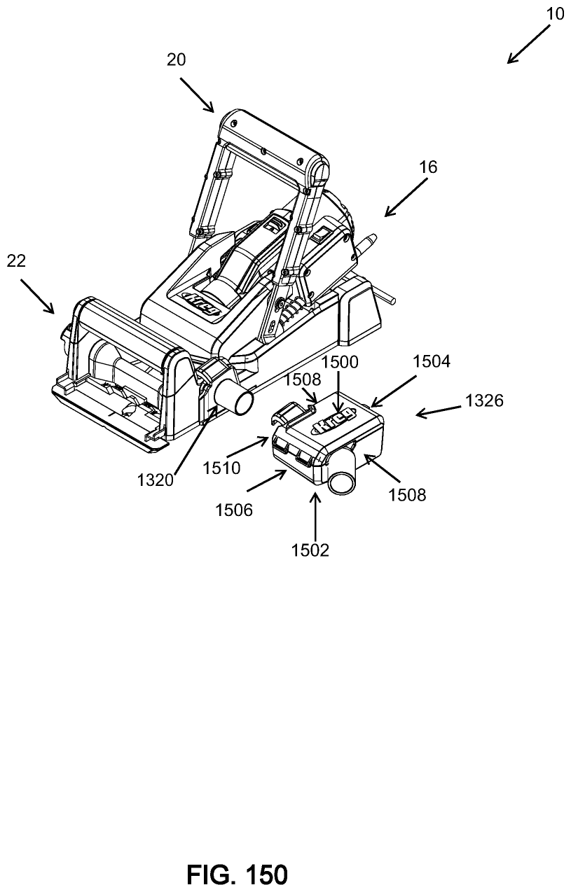

FIG. 151 shows an upper front right perspective view of a pocket hole drilling system, in accordance with one or more arrangements; the view showing a dust collector positioned for attachment to the pocket hole drilling system.

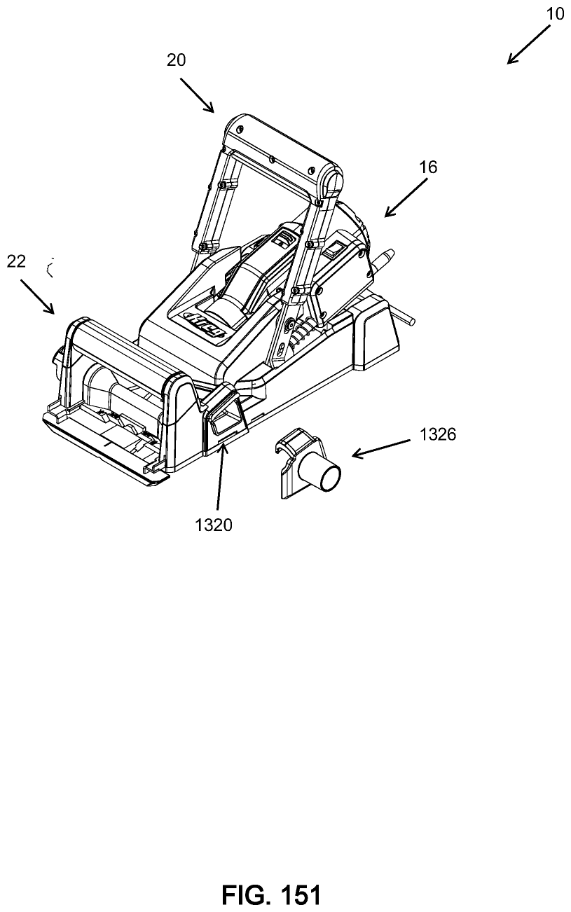

FIG. 152 shows a lower rear left perspective view of a pocket hole drilling system, in accordance with one or more arrangements; the view showing a drill bit guide disconnected from a plate of a base of system.

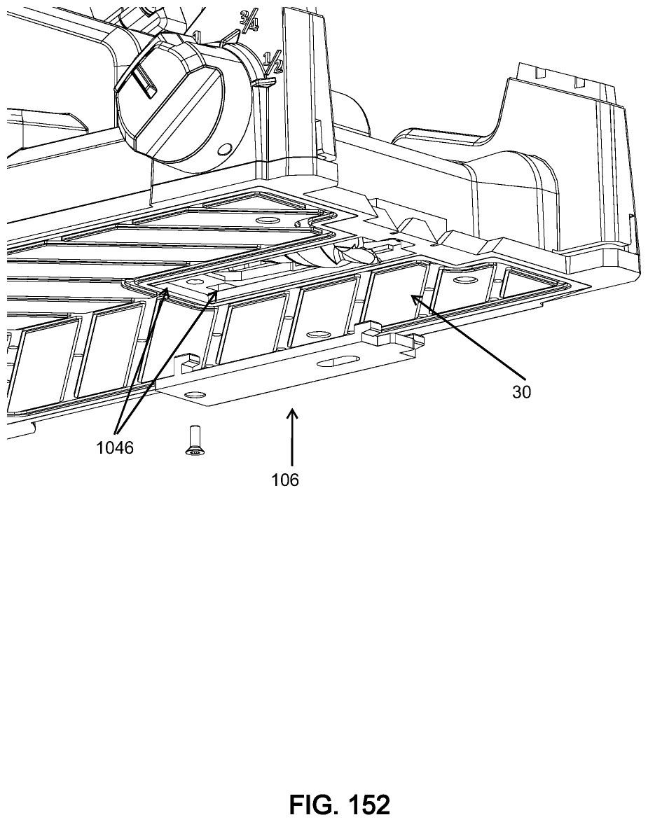

FIG. 153 shows an upper front left perspective view of a drill bit guide for a pocket hole drilling system, in accordance with one or more arrangements.

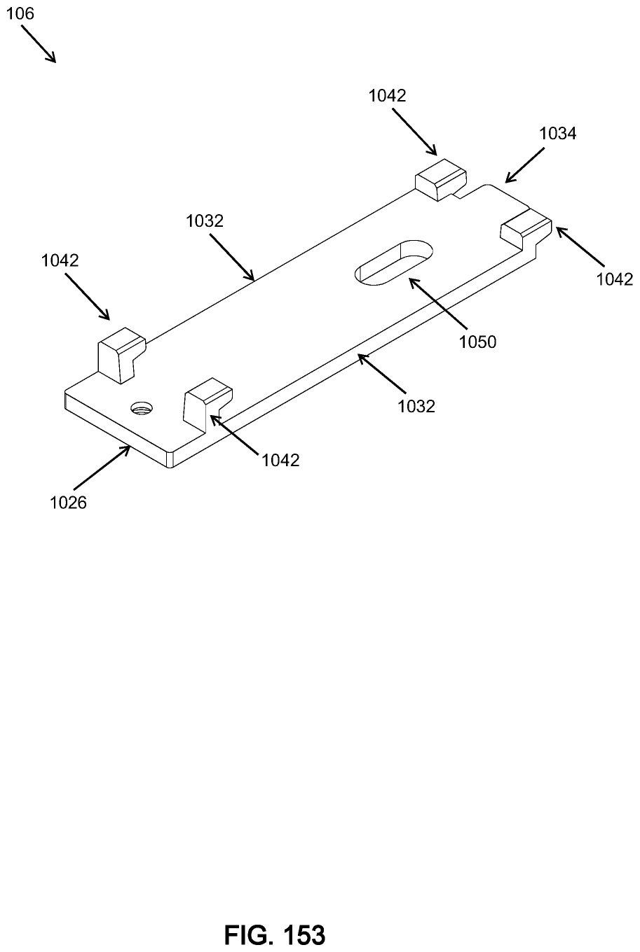

FIG. 154 shows a bottom view of a drill bit guide for a pocket hole drilling system, in accordance with one or more arrangements.

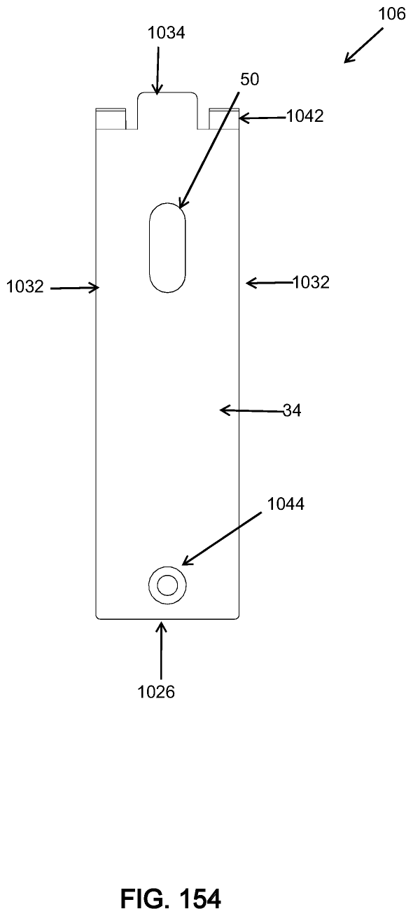

FIG. 155 shows an upper rear right perspective view of a cross section of a pocket hole drilling system, in accordance with one or more arrangements; the view showing a close up view of a drill bit guide connected with a plate of a base of system; the view showing the drill bit guide flush with the plate.

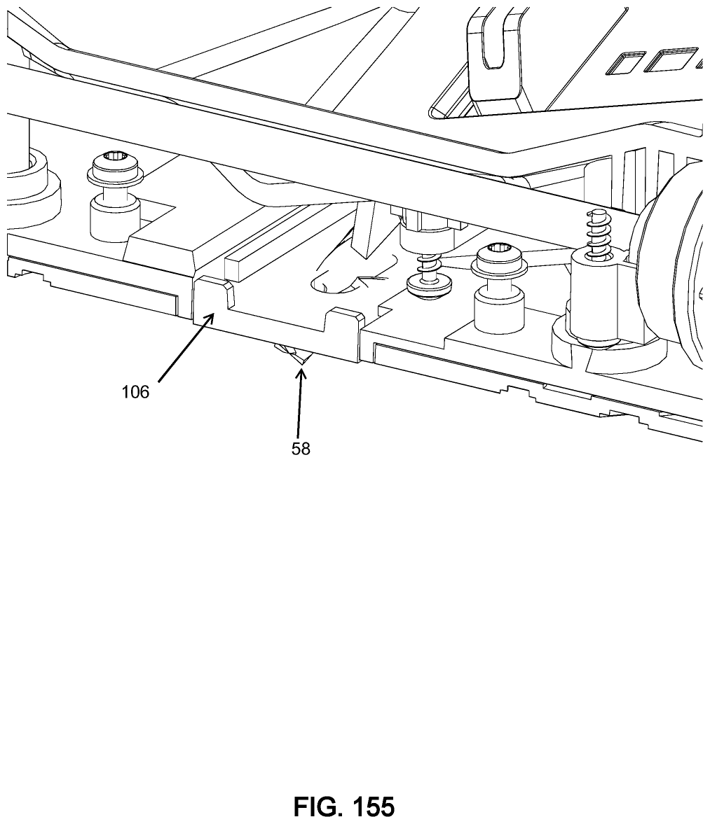

FIG. 156 shows a top view of a cross section of a pocket hole drilling system, in accordance with one or more arrangements; the view showing airflow through a cooling system of a drilling assembly.

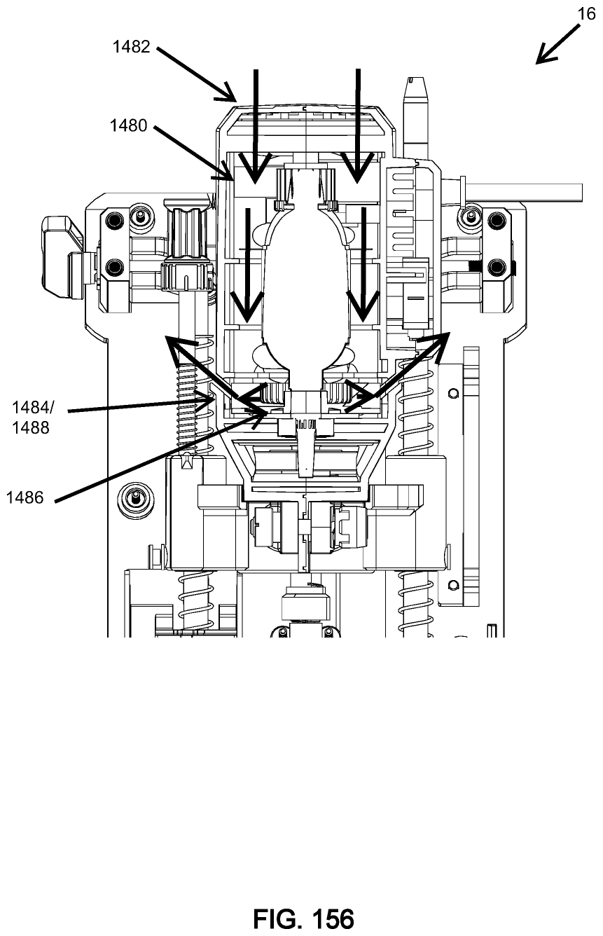

FIG. 157 shows an upper front right view of a cross section of a pocket hole drilling system, in accordance with one or more arrangements; the view showing a cooling system of a drilling assembly.

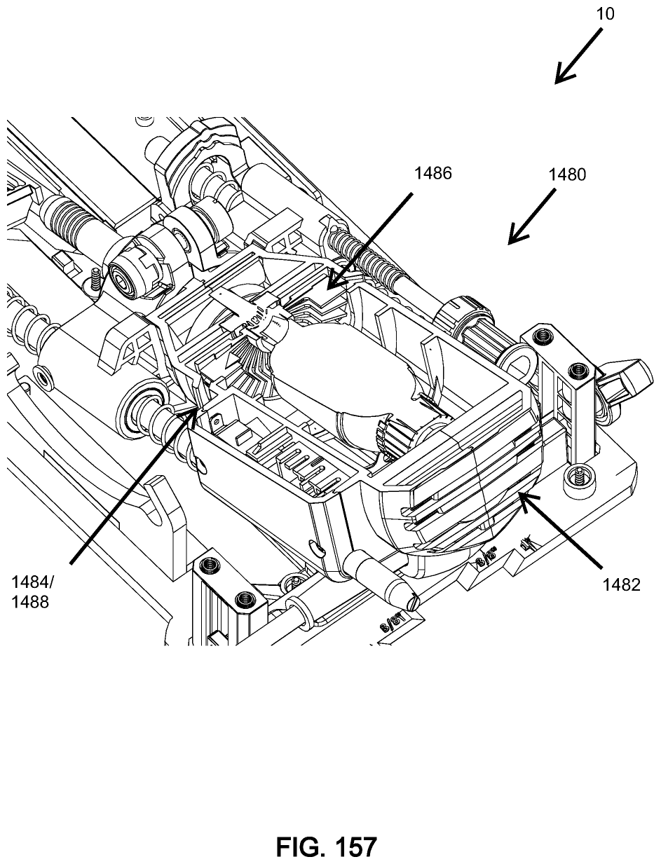

FIG. 158 shows a partial view of the pocket hole drilling system shown in FIG. 157, in accordance with one or more arrangements; the view showing baffles of a cooling system.

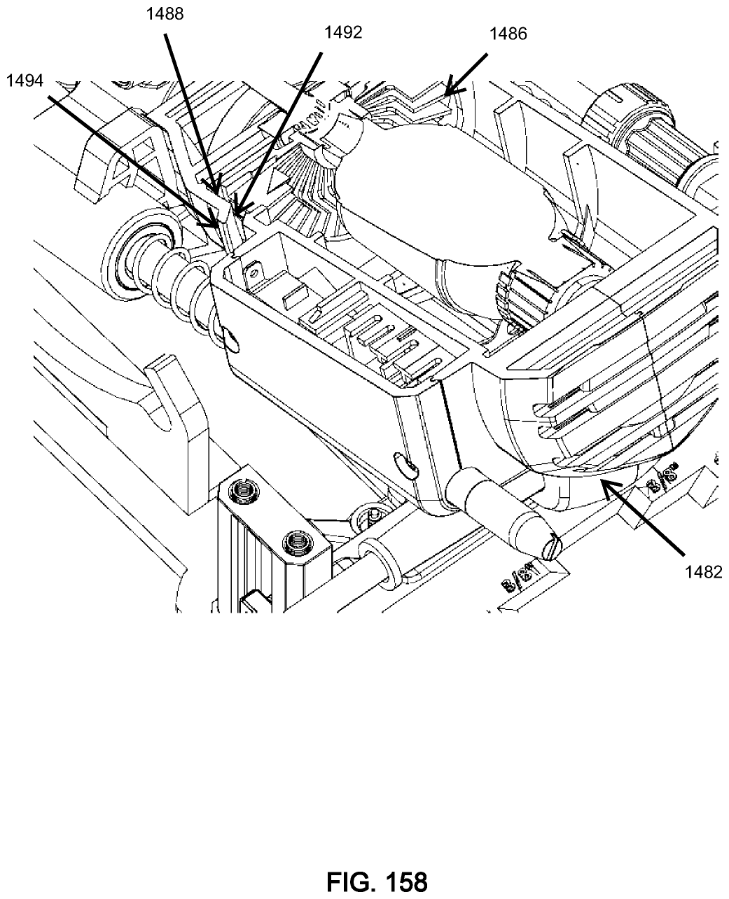

FIG. 159 shows an upper front right perspective view of drilling assembly of a pocket hole drilling system, in accordance with one or more arrangements.

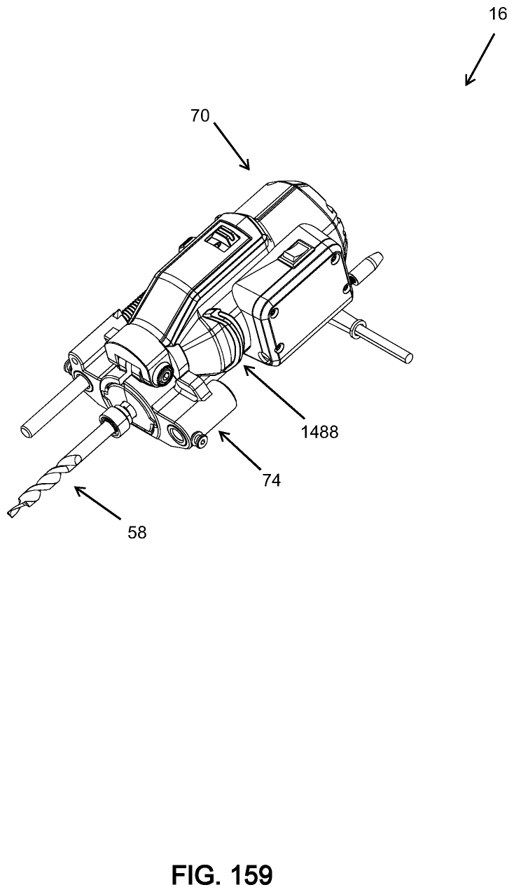

FIG. 160 shows an upper front right perspective view of drilling assembly of a pocket hole drilling system, in accordance with one or more arrangements.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

Any advantages and/or improvements discussed herein may not be provided by various disclosed embodiments, and/or implementations thereof. The contemplated embodiments are not so limited and should not be interpreted as being restricted to embodiments which provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments which address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer,” and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously introduced and not, while definite articles like “the” refer to a same previously introduced term; as such, it is understood that “a” or “an” modify items that are permitted to be previously introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of such articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected and/or engaged, respectively, in any manner that facilitates operation, which may include being directly connected, indirectly connected, electronically connected, wirelessly connected and/or connected by any other manner, method and/or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments and/or methods.

Similarly, the structures and operations discussed herein may occur out of the order described and/or noted in the figures. For example, two operations and/or figures shown in succession may in fact be executed concurrently and/or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of drilling pocket holes. However, the embodiments are not so limited. It is appreciated that the embodiments may be adapted for use in various other applications, which may be improved by the disclosed structures, arrangements and/or methods. The system is merely shown and described as being used in the context of drilling pocket holes for ease of description and as one of countless examples.

### System 10:

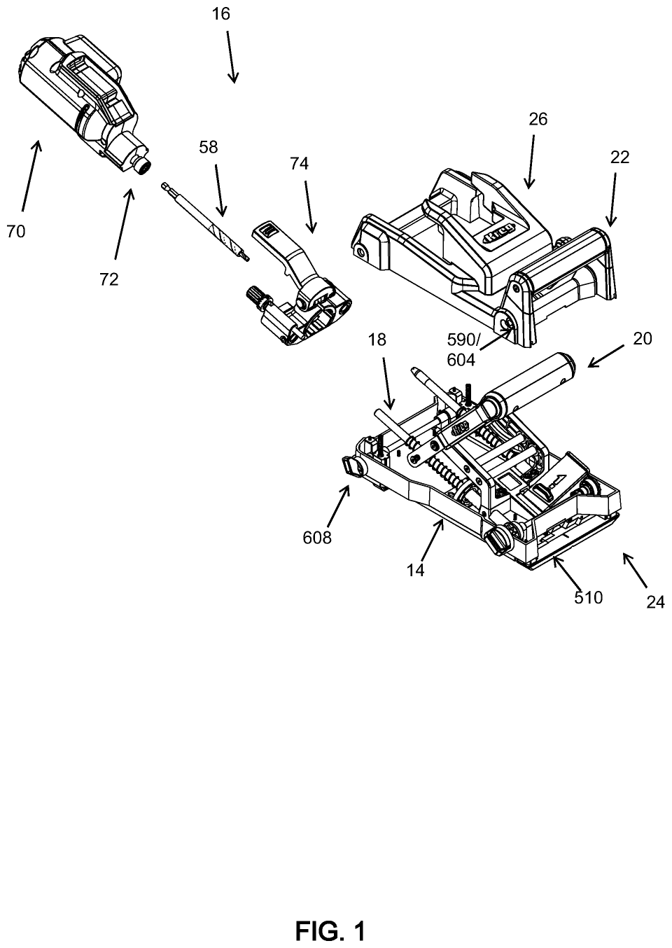

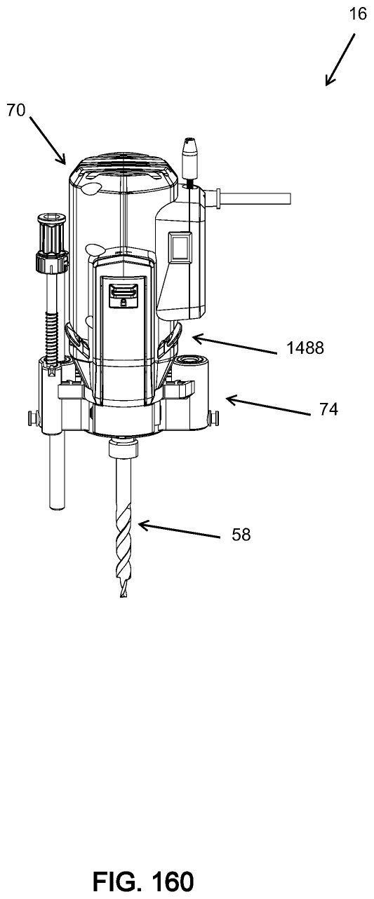

With reference to the figures, a handheld powered pocket hole drilling system 10 (or “pocket hole drilling system” 10 or simply “system” 10) is presented. In the arrangements of system 10 discussed with reference to FIGS. 1-160 of the present application are similar to, some example arrangements of systems 10 that are presented in the patent applications to which priority is claimed (the Priority Patent Applications). As such the disclosure related to the arrangements disclosed in the Priority Patent Applications apply to the arrangements shown in FIGS. 1-160 of the present application unless stated specifically herein.

In one or more arrangements, the pocket hole drilling system 10 includes a base assembly 14, a drilling assembly 16, a drill guide assembly 18, an actuating assembly 20, housing 26, a rear handle assembly 22, and a lip assembly 24, among other components.

### Base Assembly 14:

Base assembly 14 is formed of any suitable size, shape, and design and is configured to engage a surface of a workpiece 12 in a secure manner to facilitate drilling of a pocket hole therein. In the arrangement shown, as one example, base assembly 14 includes a plate 30, support members 32, and one or more grip pads 34, among other components.

### Plate 30:

Plate 30 is formed of any suitable size, shape, and design and comprises a lower surface that is arranged to engage a surface of a workpiece 12 and an upper surface 42 that facilitates operable connection with drilling assembly 16, drill guide assembly 18, actuating assembly 20, rear handle assembly 22, adjustable lip assembly 24, and/or other components of system 10. In the arrangement shown, as one example, plate 30 has a generally rectangular planar shape extending in a generally planar lower surface 40 and a generally planar upper surface 42 between a forward edge 44, a rearward edge 46, and generally straight opposing side edges 48.

### Opening 56:

In the arrangement shown, as one example, plate 30 includes an opening 56 configured to receive a drill bit guide 106. Opening 56 is formed of any suitable size, shape, and design and is configured to facilitate installation and removal of drill bit guide 106. In the arrangement shown, as one example, opening 56 has a shape similar to that of drill bit guide 106. That is opening has a generally rectangular shape extending between a front edge 60, a rear edge 62, and opposing side edges 64. In the arrangement shown, as one example, opening 56 extends through plate 30 from upper surface 42 to lower surface 40 in a generally centrally located position between opposing side edges 48. In the arrangement shown, as one example, drill bit opening 50 extends through plate 30 from upper surface 42 to lower surface 40 in a position located toward rearward edge 46.

In the arrangement shown, as one example, upper surface 42 and lower surface 40 extend in approximate parallel spaced relation to one another. In the arrangement shown, as one example, forward edge 44 and rearward edge 46 extend in approximate parallel spaced relation to one another. In the arrangement shown, as one example, upper surface 42 and lower surface extend in approximate perpendicular alignment to forward edge 44 and rearward edge 46. In the arrangement shown, as one example, opposing side edges 48 extend in approximate parallel spaced relation to one another; and in the arrangement shown, as one example, opposing side edges 48 extend in approximate perpendicular alignment to upper surface 42 and lower surface 40; and in the arrangement shown, as one example, opposing side edges 48 extend in approximate perpendicular alignment to forward edge 44 and rearward edge 46. In this way, upper surface 42 and lower surface 40, forward edge 44 and rearward edge 46, and opposing side edges 48 form a generally square or rectangular cubic shaped member that forms plate 30.

However, any other shape is hereby contemplated for use.

In one or more arrangements, plate 30 is formed of a metallic material, such as aluminum, steel, or an alloy or any other metallic material to provide extreme ruggedness and durability as well as a durable flat surface. Additionally or alternatively, in one or more arrangements, plate 30 may be formed of a plastic material, a nylon material, a fiberglass material, an Ultra High Molecular Weight (“UHMW”) material, or any other composite and/or non-metallic material. Additionally, or alternatively, in one or more arrangements, plate 30 may be formed of a combination of metallic materials or components and non-metallic materials or components.

In the arrangement shown, as one example, upper surface 42 and lower surface 40 of plate 30 are generally flat planar surfaces that extend in approximate parallel spaced relation to one another. However, embodiments are not so limited. Rather, it is contemplated that plate 30 may be implemented to have various shapes or textures formed into upper surface 42 and/or lower surface 40. For example, in one or more arrangements, upper surface 42 and/or lower surface 40 of plate 30 may have a pattern of planes and grooves which provide a flat and flush planar work surface. This pattern of planes and grooves may also provide limited relief for particles, such as wood chips, to fall or fit within the grooves to prevent the particles from interfering with the planar work surface and the engagement between the planar work surface of lower surface 40 of plate 30 and the upper surface of workpiece 12. In one arrangement, plate 30 is formed, and then upper surface 42 and/or lower surface 40 are machined flat to take up any dimensional variance imparted through the manufacturing process. In this manner, an extremely flat surface may be formed.

### Support Members 32:

In some arrangement base assembly 14 includes support members 32 attached to plate 30. Support members 32 are formed of any suitable size, shape, and design and are configured to provide structural support and/or rigidity to plate 30 and/or facilitate rigid connection with housing 26 and/or rear handle assembly 22. In the arrangement shown, as one example, support members 32 are flanges that extend along portions of edges 44, 46, and/or 48 of plate 30. In this example arrangement, support members 32 extend upward from lower ends 52 that are connected to upper surface 42 of plate 30, to upper ends 54. In the arrangement shown, as one example, two support members 32 are positioned alongside side edges 48. In the arrangement shown, as one example, two support members 32 are also positioned along rearward edge 46 and another support member 32 is positioned along forward edge 44. However, embodiments are not so limited. Rather, it is contemplated that base assembly 14 may include any number of support members 32, which may be positioned and/or interconnected in any arrangement to provide structural reinforcement and/or rigidity to plate 30.

### Grip Pad(s) 34:

In one or more arrangements, plate 30 of base assembly 14 of system 10 is formed of a hard or rigid material (e.g., plastic, metal, and/or composite). Using a hard or rigid plastic, metal, or composite material provides a strong, durable, and long-lasting tool that can handle daily use and abuse without significant wear or damage. One drawback, however, of using a hard or rigid plastic, metal, or composite material for plate 30 or other components of system 10 is that these materials tend to have a low coefficient of friction. Or, said another way, when plate 30 of base assembly 14 of system 10 is placed on workpiece 12 to drill a pocket hole, there is a low amount of friction or grip between plate 30 and workpiece 12. This means that plate 30 may easily slide on workpiece 12. Or, said another way, this means that an increased amount of down-pressure is required to hold workpiece 12 in place relative to plate 30 of base assembly 14 of system 10. It is undesirable to have plate 30 easily move on workpiece 12 during use. Such movement can cause an inaccurate pocket hole placement, damage to workpiece 12, rough pocket holes, and/or injury to a user.

In one or more arrangements, system 10 includes one or more grip pads 34 positioned on lower surface 40 of plate 30. Grip pad(s) 34 are formed of a material that is more flexible and/or more compressible than the plastic, metal, or composite material that forms plate 30 and/or other components of system 10 on which grip pad(s) 34 are positioned. Grip pad(s) 34 are formed of any suitable size shape or design and of any material that has a higher coefficient of friction than the material of the surface upon which grip pad(s) 34 are positioned. This facilitates improved grip of system 10 with surfaces of other objects during use. In various arrangements, grip pad(s) 34 may be formed of various materials including but not limited to, for example, a rubber material, a natural rubber material, a synthetic rubber material, a silicone material, an isoprene rubber material, ethylene propylene diene (“EPDM”) material, a nitrile rubber (“NBR”) material, a styrene butadiene rubber (“SBR”) material, a silicone rubber material, a butyl rubber material, a isobutylene isoprene rubber material, a polybutadiene rubber material, a foam rubber material, any compressible or high coefficient of friction plastic material, or any other material that is more-compressible than and/or has a higher coefficient of friction than the rigid materials used to form other components of system 10 that grip pad(s) 34 are attached to.

The enhanced grip of grip pad(s) 34 help system 10 to better stay in place during use. The enhanced grip of grip pad(s) 34 help to reduce the downward pressure a user must apply to system 10 to hold system 10 in place on workpiece 12. The enhanced grip of grip pad(s) 34 helps to prevent marking (e.g., scrapes or scratches) of workpiece 12 when in use. It is hereby contemplated that system 10 may include grip pad(s) 34 on any place or portion of system 10 that come into contact with or could come into contact with workpiece 12 during use as is further described herein.

In the arrangement shown, as one example, grip pad 34 is positioned in a contact area that extends in a diagonal pattern across the entire bottom surface of plate 30. The diagonal pattern may help to ensure that at least some portions of grip pad 34 extend across the workpiece 12 and thereby helps to reduce wobble. However, the embodiments are not so limited. Rather, it is contemplated that in one or more arrangements, grip pad may extend in various other patterns or arrangements, or alternatively extends across the entire bottom surface of plate 30. In this arrangement, the surface area of grip pad 34 is maximized on plate 30.

In one or more arrangements, grip pad(s) 34 may additionally or alternatively have a wavy or ridged lower surface, formed by recesses positioned between raised portions or flat contact portions, to improve contact with workpiece 12. Similarly, in some arrangements, grip pads 34 may be raised relative to portions of the bottom surface of plate that are not covered by grip pad.

This configuration of raised contact portions of grip pad(s) 34 cause an increased amount of force to be applied to the contact portions of the grip pad(s) 34 that make contact with workpiece 12. This has the effect of spreading out the down-pressure force over less surface area of contact between the upper surface of workpiece 12 and the ridges or raised portions of grip pad(s) 34, thereby increasing the amount of friction or grip between workpiece 12 and the ridges or raised portions of grip pad(s) 34. This holds workpiece 12 in place better with the same down-pressure (as compared to having a flat bottom surface of grip pad(s) 34). Or, said another way, if the bottom surface of grip pad(s) 34 was flat and placed on the flat upper surface of workpiece 12, the down-pressure applied by the user during use would be spread out over a greater surface area which would generate less overall grip and friction. As such, by having raised portions of grip pad(s) 34 and reducing the surface area of contact between grip pad(s) 34 and workpiece 12, somewhat counterintuitively, the effective friction or grip is increased thereby holding workpiece 12 in place better.

### Drilling Assembly 16:

Drilling assembly 16 is formed of any suitable size, shape, and design and is configured to facilitate the drilling of pocket holes in workpiece 12. In the arrangement shown, as one example, drilling assembly 16 includes a drill motor 70, a chuck 72, and a collar assembly 74, among other components.

### Drill Motor 70:

Drill motor 70 is formed of any suitable size, shape, and design and is configured to operably connect with and rotate chuck 72 and drill bit 58 when operated. In the arrangement shown, as one example, drill motor 70 is an electrically powered Alternating Current (“AC”) motor. However, embodiments are not so limited. Rather, it is contemplated that drill motor 70 may be implemented using any type of motor including but not limited to, for example, an AC electric motor, a Direct Current (“DC”) electric motor, a pneumatic motor, a hydraulic motor, a combustion motor, and/or any other form of a motor.

### Chuck 72:

Chuck 72 is formed of any suitable size, shape, and design and is configured to receive and hold drill bit 58 to facilitate the drilling of pocket holes. In the arrangement shown, as one example, chuck 72 is a heavy-duty square or hex-drive quick release drill chuck with a spring-loaded locking sleeve positioned over a square or hexagonal bore which quickly and easily receives and locks drill bit 58 therein. Quick release chucks of this and other various designs are well known in the industry and are made by various manufacturers. However, embodiments are not so limited. Rather, it is contemplated that chuck 72 may be implemented using any type of chuck including but not limited to, for example, a keyed chuck, a double sleeve chuck, a single sleeve keyless chuck, a Slotted Drive Shaft/System (“SDS”) chuck, a hex connection chuck, and/or any other type of chuck.

### Collar Assembly 74:

Collar assembly 74 is formed of any suitable size, shape, and design and is configured to facilitate an operable connection between drill assembly 16, drill guide assembly 18, and actuating assembly 20. In the arrangement shown, as one example, collar assembly 74 has a main body 848 extending between and connecting a collar 850, alignment guides 852, clamp assembly 854, and stop adjustment assembly 856.

### Main Body 848:

Main body 848 is formed of any suitable size, shape, and design and is configured to operably interconnect a collar 850, alignment guides 852, clamp assembly 854, and stop adjustment assembly 856. In the arrangement shown, as one example, main body 848 extends outward from a centrally positioned collar 850 to alignment guides 852 positioned on each side of collar 850. In the arrangement shown, as one example, main body 848 is formed of a hollow core construction having hollow cells 860 formed by interconnecting support structures 862 that extend rearward from a front 864 and extend between collar 850, alignment guides 852, clamp assembly 854, and stop adjustment assembly 856. Such construction helps to reduce weight and material cost while retaining relatively high compression and sheer properties. However, the arrangements are not so limited. Rather, it is contemplated that in some various arrangements, main body 848 may be formed of solid core construction without any cells 860. It is understood that in some various arrangements, various other components of system 10 may similarly be formed with either hollow core construction or solid core construction

### Alignment Guides 852:

Alignment guides 852 are formed of any suitable size, shape, and design and are configured to engage and guide drill assembly 16 along guide rods 90 of drill guide assembly 18. In the arrangement shown, as one example, alignment guides 852 are generally cylindrical shaped tubes extending through main body 848. In this example arrangement, alignment guides 852 are positioned to the sides of collar 850 and are spaced to facilitate insertion of guide rods 90 through alignment guides 852. In this example arrangement, alignment guides 852 are sized and shaped to allow guide rods 90 to pass there through with close sliding alignment. In this way, the front to back actuation of drill motor 70 is aligned with the axis of guide rods 90.

### Collar 850:

Collar 850 is formed of any suitable size, shape, and design and is configured to receive and hold a rearward end of drill motor 70 when clamped by clamp assembly 854 and permit the rotating shaft and/or chuck 72 of drilling assembly 16 to extend through collar 850. In the arrangement shown, as one example, collar 850 is a generally cylindrical shaped tube extending through main body 848. In this example arrangement, collar 850 is configured to fit over a generally cylindrical rearward end of drill motor 70. In this example arrangement, collar assembly 74 is configured to selectably clamp and unclamp the rearward end of drill motor 70 withing collar 850, thereby permitting drilling assembly 16 to be easily disconnected and reinstalled as needed (e.g., for servicing, maintenance, repair, replacement, and/or alternative use). However, the embodiments are not so limited. Rather, it is contemplated that drill motor 70 may be secured to collar assembly 74 using various means and methods known in the art including but not limited to, for example, mechanical attachment means such as clamps, screws, bolts, threading, interlocks, latches, clips, pins, or other coupling devices, adhesive bonding, chemical bonding, welding, and/or any other means and/or method for attachment.

In the arrangement shown, as one example, collar 850 includes an upper segment 868 cutout of its cylindrical shape to permit collar 850 to flex to facilitate clamping a rearward end of drill motor 70 therein. In this example arrangement, collar 850 has tabs 866 extending upward from collar 850 on each side of upper segment 868 to facilitate connection with and clamping of collar 850 by clamping assembly 854. In this example arrangement, clamping assembly 854 is configured to cause collar 850 to clamp onto a rearward end of drill motor 70 by moving tabs 866 toward one another, thereby reducing the interior diameter of collar 850. Conversely, clamping assembly 854 is configured to cause collar 850 to release the rearward end of drill motor 70 by permitting tabs 866 to move away from one another, thereby increasing the interior diameter of collar 850.

### Clamping Assembly 854:

Clamping assembly 854 is formed of any suitable size, shape, and design and is configured to facilitate clamping and/or connection of drill motor 70 with collar assembly 74. In the arrangement shown, as one example, clamping assembly 854, includes a clamp 872, a lever 874, a lock mechanism 876, and a latch 878, among other components.

### Clamp 872:

Clamp 872 is formed of any suitable size, shape, and design and is configured to facilitate clamping of tabs 866 of collar 850 to move tabs toward one another and thereby cause collar 850 to clamp onto the rearward end of drill motor 70. In the arrangement shown, as one example, clamp 872 includes an inverted U-shaped bracket having arms 886 extending downward from a central member 888 with tabs 866 of collar 850 positioned therebetween. In this example arrangement, clamp 872 also includes a bolt 890 that extends through holes 892 (not shown) in arms 886 and tabs 866 and operably connects with a nut 894 (or other threaded member).

In this example arrangement, central member 888 is connected to a rearward end 920 of lever 874, thereby pivotally connecting lever 874 to tabs 866 of collar 850 of collar assembly 74. In this example arrangement, clamping by clamp 872 is actuated by rotation of lever 874 about bolt 890. For example, in one or more arrangements, bolt 890 is operably connected to one of the arms 886 and nut 894 is operably connected with one of the tabs 866 (or vice-versa). That is, when a forward end 922 of lever 874 is lowered, arms 886 are rotated in a first direction to cause bolt 890 to rotate while nut 894 remains stationary (of vice versa) to cause bolt 890, nut 894 and/or arms 886 to tighten and clamp tabs 866 of collar 850 closer together. Conversely, when forward end 922 of lever 874 is raised, arms 886 are rotated in the opposite direction, which causes bolt 890, nut 894 or arms 886 to loosen and unclamp clamp tabs 866 of collar 850 closer together.

### Cam Shaped Arms:

Arms 886 are formed of any suitable size, shape, and design and are configured to facilitate pivoted connection with tabs 866. In the arrangement shown, as one example, arms 886 have a generally planar shape extending between a front edge 898 and a rear edge 900, from a generally rectangular upper end 902, where arms 886 connect with central member 888, to a curved lower end 904. In one or more arrangements, as is shown, lower end 904 has a cam feature 906 formed by a portion where the edge of lower end protrudes outward. The cam feature 906 is configured to engage and push against the drill motor 70 after lever 874 of color is moved upward to unclamp collar 850 and release the front end of drill motor 70. In this manner, cam feature 906 helps to unstick and/or remove front end of drill motor 70 from collar assembly 74 when unclamped.

### Lever 874:

Lever 874 is formed of any suitable size, shape, and design and is configured to move between a raised position and a lowered position to acuate clamp 872 and facilitate connection/disconnection of drill motor 70 with/from collar assembly 74. In the arrangement shown, as one example, lever 874 as an elongated generally rectangular bar shape having top 914, a bottom 916, and sides 918 extending from a rearward end 920, where lever 874 is connected to central member of 888 of clamp 872, to a forward end 922. In the arrangement shown, as one example, lever 874 has an angled or curved bend between rearward end 920 and forward end 922, which follows the upper surface of drill motor 70, so bottom 916 of lever 874 mates with drill motor 70 when drill motor 70 is installed and clamped in place by collar assembly 74.

### Latch 878:

In this example arrangement, clamping assembly 854 includes a latch 878. Latch 878 is formed of any suitable size, shape, and design and is configured to engage drill motor 70 to latch and secure drill motor 70 in place when clamped in place. Latch 878 helps to ensure that rearward end of drill motor 70 does not slip free from collar 850 during operation. However, the embodiments are not so limited. Rather, it is contemplated that some arrangements may utilize various different means and/or methods to provide secure connection between drill motor 70 and collar assembly 74 including but not limited to, for example, screws, bolts, threading, interlocks, latches, clips, pins, and/or any other method or means for connecting components.

In the arrangement shown, as one example, latch 878 has a generally rectangular shape having a front 930, a back 932, and opposing sides 934 extending downward from an upper end 936, connected to bottom 916 of lever 874, to a lower end 938. In this example arrangement, latch 878 has a tapered shape, when viewed from the side, that narrows from a wider upper end 936 to a narrower lower end 938.

In this example arrangement, drill motor 70 has a complementary shaped recess 928 configured to receive latch 878 when rearward end of drill motor 70 is inserted in collar 850 and forward end 922 of lever 874 is moved to the lowered position to cause clamping assembly 854 to clamp drill motor 70 in place. When latch 878 is inserted into recess 928, latch 878 prevents rearward end of drill motor 70 from being removed from collar 850.

### Lock Mechanism 876:

Lock mechanism 876 is formed of any suitable size, shape, and design and is configured to lock lever 874 in place in the lowered position against drill motor 70 to prevent lever 874 from being unintentionally moved to the raised position that would permit drill motor 70 to be removed. In the arrangement shown, as one example, lock mechanism 876 is positioned in forward end 922 of lever 874 and includes a spring-loaded latch 942 that extends outward from the forward end 922. In this example arrangement, lock mechanism 876 latches against a recess or strike plate of drill motor when lever is moved to the lowered position. In this example arrangement, lock mechanism 876 has a slider button 944 positioned on top 914 of lever 874 and is operably connected to spring-loaded latch 942. In this example arrangement, when user moves slider button 944 rearward, spring-loaded latch 942 is retracted and lever 874 is released, thereby permitting lever 874 to be moved to the raised position.

### Stop Adjustment Assembly 856:

Stop adjustment assembly 856 is formed of any suitable size, shape, and design and is configured to set a lowest position that drilling assembly 16 may be moved along drill guide assembly 18 relative to drill stop assembly 514. In the arrangement shown, as one example, stop adjustment assembly 856 includes an extendable brace 950 and a knob 952 operably connected to collar 850, among other components.

Extendable brace 950 is formed of any suitable size, shape, and design and is configured to extend rearward an adjustable distance from collar assembly 74 and engage drill stop assembly 514 operably connected to adjustable lip assembly 24 when drilling assembly 16 is moved rearward and downward along drill guide assembly 18, and thereby prevent drilling assembly 16 from being moved further rearward and downward. In one or more arrangements, extendable brace 950 is an elongated cylindrical shape having a threaded exterior extending from a forward end 958, though a threaded hole in main body 848 of collar assembly 74, to a rearward end 960. In this example arrangement, knob 952 is connected to forward end 958 of extendable brace 950 to facilitate find tune adjustment of drilling depth by rotating knob 952. In this example arrangement, rotation of knob 952 causes extendable brace 950 to rotate. As extendable brace 950 is rotated, treading on extendable brace 950 causes forward end 958 of extendable brace 950, which contacts drill stop assembly 514 and limits movement of drilling assembly 16, to move rearward or forward relative to collar assembly 74 and drilling assembly 16. In this manner, the lowest position that drilling assembly 16 is permitted to move along drill guide assembly 18 relative to drill stop assembly 514 can be adjusted.

### Movement Actuated Switch Assembly 1450:

In one or more arrangements, drilling assembly 16 includes a switch assembly 1450 configured to turn on drill motor 70 when drilling assembly 16 begins to be moved downward along guide rods 90 of drill guide assembly 18 from the fully retracted position. Switch assembly 1450 is formed of any suitable size, shape, and design and is configured to turn on drill motor 70 when drilling assembly 16 is moved from the fully retracted position and turn off motor when drilling assembly 16 is returned to the fully retracted position. In the arrangement shown, as one example, switch assembly 1450 includes a switch 1452 and an actuator 1454, among other components.

### Switch 1452:

Switch 1452 is formed of any suitable size, shape, and design and is configured to selectably connect and disconnect an electric pathway to turn on and off drill motor 70. In the arrangement shown, as one example, switch 1452 is a momentary microswitch configured to turn on drill motor 70 when a button 1456 of switch 1452 is depressed and turn off drill motor 70 when button 1456 of switch 1452 is released. However, the embodiments are not so limited. Rather, it is contemplated that in various arrangements, switch 1452 may be implemented using various different types of switches including but not limited to mechanical switches, pressure switches, proximity switches, electronic switches, and/or any other type of switch.

### Actuator 1454:

Actuator 1454 is formed of any suitable size, shape, and design and is configured to cause switch 1452 to turn on drill motor 70 when drilling assembly 16 is moved from the fully retracted position and turn off motor when drilling assembly 16 is returned to the fully retracted position. In the arrangement shown, as one example, actuator 1454 includes a roller 1460 positioned on an axle 1462 between switch 1452 and a guide rod 90 of drill guide assembly 18. In this example arrangement, actuator 1454 is biased by bias member 1464 (not shown) configured to move axle 1462 and roller 1460 away from switch 1452 in absence of an opposing force. In this example arrangement, actuator 1454 is positioned to engage a sloped end 1468 of guide rod 90 when drilling assembly 16 is moved to the fully retracted position. The sloped end 1468 of guide rod 90 allows when roller 1460 of actuator 1454 to be move far enough away from switch 1452 to release button 1456 and cause switch to turn off drill motor 70. Actuating assembly 20 causes drilling assembly 16 to be moved downward along guide rod 90 for drilling operation, roller 1460 of actuator 1454 is moved off the sloped end 1468 of guide rod, which moves, roller 1460 close enough to switch 1452 to depress button 1456 and cause switch to turn on drill motor 70.

In the example arrangement shown, switch assembly 1450 is positioned within drilling assembly 16 and is configured to switch drill motor 70 on or off based on position of drilling assembly 16 relative to guide rods 90. This arrangement is beneficial in that no wiring harness is required to connect with a button located elsewhere on system (e.g., on handle 154 of actuating assembly 20). The elimination of such wiring harness may make it simpler to remove drilling assembly 16 from system 10, for example for maintenance, repair and/or replacement. However, the embodiments are not so limited. Rather, it is contemplated that switch assembly 1450 may be located as various other locations on system 10 switch drill motor 70 on or off based on position of drilling assembly 16 relative to guide rods 90 or any other component of system.

### Power Switch 1474:

In one or more arrangements, system 10 may additionally or alternatively include a power switch 1474. Power switch 1474 is formed of any suitable, size, shape, and design, and is configured to prevent operation of drill motor 70 when power switch 1474 is switched off and permit drill motor 70 to be switched on, as described herein, when power switch 1474 is switched on. In the arrangement shown, as one example, power switch 1474 is positioned on drilling assembly 16 proximate to switch assembly 1450. In one or more arrangements, power switch 1474 is configured to mechanically prevent button 1456 of switch 1452 from being depressed when power switch 1474 is switched off. Additionally or alternatively, in one or more arrangements, power switch 1474 is configured to selectably connect and disconnect an electric pathway to prevent or permit operation of drill motor 70. However, the embodiments are not so limited. Rather, it is contemplated that in some arrangements power switch 1474 may be located as various other locations on system 10 and/or use any other means of method to prevent operation of drill motor 70 when switched off and permit operation of drill motor 70 when switched on.

### Cooling System 1480

In one or more arrangements, drilling assembly 16 includes a cooling system 1480. Cooling system 1488 is formed of any suitable size, shape, and design and is configured to cool drill motor 70 and/or other components of drilling assembly during operation. In one or more arrangements shown, for example, cooling system 1480 includes front vents 1482 positioned at a front end of drill motor 70, rear vents 1484 positioned at a front end of drill motor 70, and a cooling fan 1486 operably connected to an output shaft of drill motor 70 and configured to induce airflow into front vents 1482, through drill motor 70, and out from rear vents 1484, thereby cooling drilling assembly 16.

### Baffles 1488:

Through careful observation, it has been observed that in some arrangements wood chips and other debris created during drilling may be pulled forward through opening 1016 of drill bit guide housing 972 and/or drill bit guide 106 by fluting of drill bit 58 are drilling assembly is moved forward to the retracted position. It has been observed that such wood chips and other debris may be blown airborne by airflow of cooling system 1480 in an undesirable manner (e.g., into the face of a user). In one or more arrangements, cooling system 1480 includes baffles 1488 to mitigate such undesirable blowing of such wood chips and other debris.

Baffles 1488 are formed of any suitable size, shape, and design and are configured to direct airflow output through rear vents 1484 of cooling system 1480, for example, to prevent undesirable blowing of wood chips and other debris. In one or more arrangements shown, for example, baffles 1488 are positioned proximate to rear vents 1484 and have a flange shape extending outward and forward at an angle from an inner edge 1492 where baffles 1488 connect with drilling assembly 16 to an outward free edge 1494. In this example, baffle cause airflow output through rear vents 1484 to be directed out to the side and forward, thereby preventing cooling fan 1486 from blowing wood chips and other debris that may be pulled forward by drill bit 58 airborne.

### Drill Guide Assembly 18:

Drill guide assembly is formed of any suitable size, shape, and design and is configured to operably connect with drilling assembly 16 and facilitate movement of drilling assembly 16 between the extended and retracted positions. In the arrangement shown, as one example, drill guide assembly 18 includes a guide block 88 and a set of guide rods 90, among other components.

### Guide Block 88:

Guide block 88 is formed of any suitable size, shape, and design and is configured to operably connect guide rods 90 with plate 30 of base assembly 14 and guide drill bit 58 during operation. In the arrangement shown, as one example, guide block 88 includes a removable drill bit guide 106, a drill bit guide housing 972, and a pair of guide block segments 974 positioned opposing sides of the drill bit guide housing 972, among other components.

### Guide Block Segments 974

Guide block segments 974 are formed of any suitable size, shape, and design and are configured to operably connect respective guide rods 90 with plate 30 of base assembly 14. In the arrangement shown, as one example, guide block segments 974 each have a main body 980, a guide rod support 982, and a guide rod connection member 984, among other components.

In this example arrangement, main body 980 of each guide block segment 974 has a generally rectangular block shape having a front 988, a back 990, and opposing sides 992, extending from a top 994, to lower edges 996, where main body 980 is connected to upper surface 42 of plate 30.

In the example arrangement shown, main body 980 of guide block segments 974 have openings 1000 configured to receive the guide rods 90. In this example arrangement, openings 1000 extend from front 988 main body 980 to back 990 of main body 980 and into guide rod supports 982.

### Guide Rod Supports 982:

In this example arrangement, guide block 88 includes guide rod supports 982 positioned proximate to openings 1000 at back 990 of main body 980. Guide rod supports 982 are formed of any suitable size, shape, and design and are configured to receive and hold ends 146 of guide rods 90. In the arrangement shown, as one example, guide rod supports 982 each have a semi-cylindrical body 1004 connected to upper surface 42 of plate 30 and have a cylindrical recess 1006 (not shown) extending rearward from opening 1000 of main body 980 into body 1004 of guide rod support 982.

When system 10 is fully assembled, the ends 146 of guide rods 90 are positioned in cylindrical recess 1006 of guide rod supports 982 with guide rods 90 extending forward from guide rod supports 982 through openings 1000 in main body 980 of guide block segments 974. The guide rod supports 982 and openings 1000 hold the guide rods 90 at an angle at which holes are to be drilled into workpiece 12 for formation of pocket holes. Although the precise angle can vary, a drilling angle of about 15 degrees is commonly used to form pocket joints in wooden or composite (i.e., material dense fiberboard (MDF), particle board, etc.) workpieces 12. However, embodiments are not so limited. Rather, it is contemplated that guide rods 90 can be positioned at other angles to facilitate drilling of pocket holes at angles greater or less than 15 degrees.

In various different arrangements, guide rods 90 may be secured within guide rod supports 982 using various means and methods known in the art including but not limited to, for example, adhesive bonding, chemical bonding, welding, and/or mechanical attachment means such as screws, bolts, threading, interlocks, latches, clips, pins, or other coupling devices. In the arrangement shown, as one example, guide rods 90 are secured in place by guide rod connection members 984 positioned in sides 992 of main body 980.

### Guide Rod Connection Members 984:

Guide rod connection members 984 are formed of any suitable size, shape, and design and are configured to engage and hold guide rods 90 secure within guide rod supports 982. In the arrangement shown, as one example, guide rod connection members 984 are threaded holes extending inward from outer sides 992 of main body. When system 10 is fully assembled, guide rods 90 extend through opening 1000 of main body 980 and a fastener (e.g., a screw or bolt) is threaded into threaded hole of guide rod connection members 984 and tightened to clamp guide rods 90 into position.

### Drill Bit Guide Housing 972

Drill bit guide housing 972 is formed of any suitable size, shape, and design, and is configured to receive and hold drill bit guide 106. In the arrangement shown, as one example, drill bit guide housing 972 has a wedge-shaped housing having a front wall 1010, side walls 1012, and a top 1014. In this example arrangement, drill bit guide housing 972 opening 1016 in front wall 1010 to permit drill bit 58 to enter housing 972 and extend into drill bit guide 106.

In this example arrangement, drill bit guide housing 972 includes an opening 1018 in top 1014 and the rightward side wall 1012 to facilitate removal of wood shavings generated during drilling. In this example arrangement, drill bit guide housing 972 also includes an opening 1020 in a front end of top 1014. In this example arrangement, drill bit guide housing 972 is configured to receive drill bit guide 106 through opening 56 in plate 30, thereby permitting drill bit guide 106 to be easily cleaned, serviced, and/or replaced.

### Drill Bit Guide 106:

Drill bit guide 106 is formed of any suitable size, shape, and design, and is configured to guide and support drill bit 58 in proper alignment for drilling of pocket holes in workpiece 12. In one or more arrangements shown, for example, drill bit guide 106 has a wedge shape having a front 1026, a top 1028, a bottom 1030, sides 1032, and a rear end 1034. In this example arrangement, drill bit guide 106 has a flange 1040 extending around an outer edge of bottom 1030. In this example arrangement, drill bit guide 106 has a set of tabs 1042 extending around from flange 1040 to facilitate connection of drill be guide to plate 30 and thereby hold drill bit guide 106 within drill bit guide housing 972. In one or more arrangements, drill bit guide 106 is connected to plate by fasteners (e.g., screws or bolts) that extend through holes 1044 in tabs 1042 and into corresponding holes in plate 30. However, embodiments are not so limited. Rather, it is contemplated that drill bit guide 106 may be connected to plate 30 and/or other component of system 10 using various means, methods, and techniques known in the art including but not limited to, for example, adhesive bonding, chemical bonding, welding, and/or mechanical attachments means such as screws, bolts, threading, interlocks, latches, clips, pins, or other coupling devices. For example, in one or more arrangements, tabs 1042 may be configured to interconnect with complementary recesses 1046 in plate 30 and/or fasteners in various other locations.

When system 10 is fully assembled, with drill bit guide 106 positioned within drill bit guide housing 972, front 1026 is positioned proximate to opening 1020. In this example arrangement, drill bit guide 106 provides a drill bit opening 50 extending from opening 1020 in front wall 1010 of drill bit guide housing 972 to a lower surface of drill bit guide 106 to permit drill bit 58 to extend below plate 30 and facilitate drilling of pocket holes. Drill bit opening 50 may be formed of any suitable size, shape, and design and is configured to facilitate the passage of a drill bit 58 through drill bit guide 106 and plate 30. In this example arrangement, drill bit guide 106 includes chip openings 1038 to allow dust, particles, and shavings generated by drilling to exit drill bit guide 106.

In one or more arrangements, drill bit guide 106 has a lower surface configure to fit approximately flush with a workpiece in close proximity drill bit 58 to prevent chipping during use. In one or more arrangements, drill bit guide 106 is formed of a consumable material (e.g., plastic material, a nylon material, a fiberglass material, an Ultra High Molecular Weight (“UHMW”) material, or any other suitable composite and/or non-metallic material) with an undersized drill bit opening 50. In this example arrangement, when used for the first time, drill bit 58 drills through and expands drill bit opening 50 to produce an opening that is fitted to the drill bit 58. As a result, the lower surface of the drill bit guide 106 extend all the way to drill bit 58, thereby reducing the chance chipping the workpiece when forming a pocket hole.

### Guide Rods 90:

Guide rods 90 are formed of any suitable size, shape, and design and are configured to guide drilling assembly 16 along an angled path to facilitate drilling angled pocket holes in workpiece 12. In the arrangement shown, as one example, guide rods 90 have a generally cylindrical shaped exterior surface extending between opposing ends 146. However, embodiments are not so limited. Rather, it is contemplated that guide rods 90 may have a cross section with any other shape (e.g. circular, triangular, square, rectangular, pentagonal, hexagonal, or any other shape). Additionally or alternatively, guide rods may provide a track within which drilling assembly 16 is guided along the angled path.

### Actuating Assembly 20:

Actuating assembly 20 is formed of any suitable size, shape, and design and is configured to actuate movement of drilling assembly 16 along guide rods 90 of drill guide assembly 18 between an extended position and a retracted position. As used herein, extended position refers to a position of drilling assembly 16 at which drill bit 58 in chuck 72 extends through drill bit opening 50 of plate 30 and beyond lower surface 40 of plate 30. As used herein, retracted position refers to a position of drilling assembly 16 at which drill bit 58 in chuck 72 does not extend through drill bit opening 50 of plate 30 and beyond lower surface 40 of plate 30. In the arrangement shown, as one example, actuating assembly 20 is formed of a fulcrum assembly 150, a lever 152, a handle 154, and a switch 1144, among other components.

### Fulcrum Assembly 150:

Fulcrum assembly 150 is formed of any suitable size, shape, and design and is configured to operably connect with base assembly 14 and operate as a fulcrum for lever 152. In the arrangement shown, as one example, fulcrum assembly 150 includes a pair of arms connected by a set of cross supports, among other components.

Arms 1050 are formed of any suitable size, shape, and design and are configured to operably connect with base assembly 14 and facilitate a pivoted connection with lever 152 at a fulcrum point. In this example arrangement, arms 1050 have a base 1056, a lower section 1058 extending upward from the base, and a cantilever section 1060, extending forward and upward from an upper end of lower section 1058. In this example arms 1050 are formed of a hollow core construction having cells 1064 formed by interconnecting support structures 1066. Such construction helps to reduce weight and material cost while retaining relatively high compression and sheer properties. However, the arrangements are not so limited. Rather, it is contemplated that in some various arrangements, arms 1050 may be formed of solid core construction without any cells 1064.

Base 1056 is formed of any suitable size, shape, and design and is configured to facilitate operable connection with base 14. In this example arrangement, base 1056 of each arm 1050 is configured to connect with top 994 of main body 980 of guide block segments 974. In this example arrangement, base 1056 has an elongated generally U-shaped length formed by a generally rectangular shaped bottom 1070, a front flange 1072 and a rear flange 1074 extending from an inner end 1076 to an outer end 1078. In this example arrangement, base 1056 has holes 1080 in bottom 1070 to facilitate connection of arms 1050 with main body 980 of guide block segments 974 by fasteners (e.g., screws or bolts). However, embodiments are not so limited. Rather, it is contemplated that base 1056 may be connected to guide block segments 974 or other component of system 10 (e.g., plate 30) using various means, methods, and techniques known in the art including but not limited to, for example, adhesive bonding, chemical bonding, welding, and/or mechanical attachments means such as screws, bolts, threading, interlocks, latches, clips, pins, or other coupling devices.

Lower section 1058 is formed of any suitable size, shape, and design and is configured to operably connect cantilever section 1060 with base 1056. In this example arrangement, lower section 1058 has an elongated generally rectangular shape having a front 1084, a back 1086 and opposing sides 1088 extending upward from a lower end 1090, where lower section 1058 is connected to base, to an upper end 1092.

Cantilever section 1060 is formed of any suitable size, shape, and design and is configured to operably connect with lower section 1058 and facilitate pivoted connection with lever 152 at the fulcrum point. In this example arrangement, a cantilever section 1060 has an elongated generally rectangular shape having an upper surface 1096, a lower surface 1098, and opposing sides 1100 extending upward and forward form a rearward end 1102, where cantilever section 1060 is connected to upper end 1092 of lower section 1058, to a forward end 1104.

In this example arrangement, arms 1050 have a set of holes 1108 at forward ends 1104 to facilitate a hinged connection with lever 152 by fastener 186. Fastener 186 operates as a pivot point for lever 152. In this example arrangement, arms 1050 also have a set of holes 1110 to facilitate connection with cross supports 1052.

### Cross Supports 1052:

Cross supports 1052 are formed of any suitable size, shape, and design and are configured to connect with arms 1050 and provide structural rigidity to fulcrum assembly 150. In the arrangement shown, as one example, cross supports 1052 have an elongated cylindrical shape extending between opposing ends 1114, where cross supports 1052 connect with arms 1050. In this example arrangement, cross supports 1052 are connected to arms 1050 by fasteners (e.g., screws or bolts) that extend through holes 1108 and attach with ends 1114 of cross supports 1052. However, embodiments are not so limited. Rather, it is contemplated that cross supports 1052 may be connected to arms 1050 using various means, methods, and techniques known in the art including but not limited to, for example, adhesive bonding, chemical bonding, welding, and/or mechanical attachments means such as screws, bolts, threading, interlocks, latches, clips, pins, or other coupling devices.

### Lever 152:

Lever 152 is formed of any suitable size, shape, and design and is configured to operably connect with fulcrum assembly 150 and drilling assembly 16 and facilitate controlled movement of drilling assembly 16 along drilling guide assembly 18. In the arrangement shown, as one example, lever 152 has a pair of elongated generally planar shaped support arms 1130 positioned on opposing sides of lever 152 and extending from a first end 190 of lever 152, which is operably connected to a handle 154, and a second end 192 of lever 152, which operably connected to drilling assembly 16. In this example arrangement, lever has a pivot connection 194 located between first end 190 and second end 192. In this example arrangement, pivot connection 194 is provided by holes 1136 in support arms 1130 and holes 1108 of fulcrum assembly 150, through which fastener 186 is inserted to provide a hinged connection between lever 152 with fulcrum assembly 150. In this example arrangement, lever 152 is generally straight. However, embodiments are not so limited. Rather, it is contemplated that lever 152 may be straight, curved, angled, meandering, or be any other shape.

In various different arrangements, second end 192 of lever 152 may be operably connected to drilling assembly 16 using various different attachment means or methods. In the arrangement shown, as one example, lower ends of support arms 1130 at second end 192 of lever 152 are configured to connect to collar assembly 74 of drilling assembly 16. In this example arrangement, lever 152 includes slots 1138 positioned proximate to second end 192. In this example arrangement, a fastener 198 extends through slots 1138 of lever 152 and into collar assembly 74. When drilling assembly 16 is moved along guide rods 90 (e.g., between an extended position and a retracted position), fastener 198 is free to move within slots 1138 to permit drilling assembly 16 to move along the linear path of the guide rods 90 while remaining connected with second end 192 of lever 152, which moves in an arc. However, embodiments are not so limited. Rather, it is contemplated that second end 192 of lever 152 may be connected to collar assembly 74 and/or other component of drilling assembly 16 using various means, methods, and techniques known in the art including but not limited to, for example, adhesive bonding, chemical bonding, welding, and/or mechanical attachments means such as screws, bolts, threading, interlocks, latches, clips, pins, or other coupling devices.

### Handle 154:

Handle 154 is formed of any suitable size, shape, and design and is configured to facilitate hand-controlled movement of first end 190 of lever 152 by a user. In the arrangement shown, as one example, handle 154 is a horizontal hand grip extending between support arms 1130 at the first end 190 of lever 152. However, embodiments are not so limited. Rather, it is contemplated that handle 154 may be implemented using various different types of handgrips including but not limited to horizontal handgrips, vertical handgrips, knobs, wheels, loops, and/or any other type of handle or handgrip.

In the arrangement shown, as one example, handle 154 includes a switch 1144 to facilitate release a lock mechanism 1152 of actuating assembly 20. Switch 1144 is formed of any suitable size, shape, and design and is configured to disengage lock mechanism 1152. In the arrangement shown, as one example, switch 1144 is a handgrip actuated switch that is mechanically connected with lock mechanism 1152. In this arrangement, a user disengages lock mechanism 1152 by pressing switch 1144 upward into handle when gripping handle 154. This arrangement operates to prevent potentially unsafe operation of drilling assembly 16 when a user is not holding handle 154 (for example if user loses hold of handle 154 during drilling).

In one or more arrangements, system 10 may additionally or alternatively include one or more safety switches 1146 to prevent accidental disengagement of locking mechanism 1152 and/or operation of drill motor if switch 1144 is accidentally pressed or bumped, for example, if a user is using handle 154 to reposition or transport system 10. In the arrangement shown, as one example, handle 154 also includes thumb actuated safety switches 1146 that prevent a user from pressing switch 1144 unless the one of the safety switches 1146 is first pressed. This arrangement helps to prevent unintentional disengagement of lock mechanism 1152.

However, embodiments are not so limited to these switch arrangements. Rather, it is contemplated that in one or more arrangements lock mechanism 1152 may disengaged using any type or any number of mechanical and/or electrical switches, which may be located at any position on system 10.

### Lock Mechanism 1152

Lock Mechanism 1152 is formed of any suitable size, shape, and design, and is configured to lock lever 152 rearward and thereby lock drilling assembly 16 in the retracted position. In the arrangement shown, as one example, lock mechanism 1152 includes a link 1154 connected to lever 152, a track 1156, and a guide 1158 positioned withing track 1156 and connected to link 1154 among other components.

Link 1154 is formed is formed of any suitable size, shape, and design, and is configured to connect one of support arms 1130 of lever 152 with guide 1158 so movement of lever 152 is restricted by movement of guide 1158 within track 1156. In this example arrangement, link 1154 is also configured to provide a mechanical connection between switch 1144 with guide 1158 so as to permit switch to extend and retract guide 1158 to move guide into and out from a lock recess 1194 within in track 1156.

In this example, link 1154 has an elongated generally planar shape extending between a forward edge 1162 and rearward edge 1164 from an upper end 1166, where link 1154 is operably connected to switch 1144 to a lower end 1168, where link 1154 is operably connected to guide 1158. In this example arrangement, link 1154 has an outward bend 1170 at lower end 1168 to facilitate connection with guide 1158 in track 1156 without interfering with connection of support arms 1130 of lever with collar assembly 74. In this example arrangement, link 1154 is connected to the right support arm 1130 of lever 152 by fasteners 186/1174 that extend through a set of slots 1172 in link 1154 and holes 1176 in support arm 1130. In this example arrangement, slots 1172 permit link 1154 to slide upward and downward relative to right support arm 1130 to facilitate movement of guide 1158 by switch 1144.

### Track 1156 and Guide 1158

Track 1156 is formed of any suitable size, shape, and design, and is configured to facilitate movement of guide 1158 along a curve path corresponding to movement of second end 192 of lever 152 and provide a lock recess 1194 along the path configured to receive and hold guide in place, thereby preventing movement of lever 152. In the arrangement shown, as one example, track 1156 is a curved slot formed in a bracket 1180 having a generally planar shape extending between a front edge 1182, a rear edge 1184, a bottom edge 1186, and a curved upper edge 1188. In the arrangement shown, as an example, bracket 1180 includes a flange 1204 extending out to the side from bottom edge 1186 of bracket 1180. In this example arrangement, flange 1204 includes holes 1202 to facilitate connection with plate 30 of base assembly 14 or other component of system 10 (e.g., by screws, bolts, or other fasteners). However, the embodiments are not so limited. Rather, it is contemplated that bracket 1180 may be connected plate 30 of other component using any means and methods known in the art including but not limited to, for example, adhesive bonding, chemical bonding, welding, and/or mechanical attachment means such as screws, bolts, threading, interlocks, latches, clips, pins, or other coupling devices.

In this example arrangement, the curved slot 1190 of track 1156 follows the path corresponding to movement of second end 192 of lever 152 as drilling assembly 16 is moved between the extended and retracted positions. In this example arrangement, track 1156 includes a lock recess 1194 at the position at which guide 1158 is located when drilling assembly 16 is in the retracted position. In this position, a bias member 1192 of switch 1144 in handle 154 (e.g., a spring or other bias mechanism) moves link 1154 downward, which move guide 1158 into lock recess 1194. While guide 1158 is in lock recess 1194, lever 152 of actuating assembly 20 is prevented from moving, thereby locking drilling assembly in the retracted position. Guide 1158 is held within lock recess 1194 until user engages switch 1144 to move guide out of lock recess 1194, thereby disengaging lock mechanism 1152.

Guide 1158 is formed of any suitable size, shape, and design, and is configured to connect with lower end 1168 of link 1154 and restrict movement of lower end 1168 of link 1154 to the path within track 1156. In the arrangement, guide includes a bearing 1198 positioned on a fastener 1200 (e.g., a screw or bolt) that extends through track 1156 and a hole 1178 positioned at lower end 1168 of link 1154.

In one or more arrangements, an upper corner 1196 of slot 1190 positioned above lock recess 1194 is configured to move guide 1158 slightly rearward as guide 1158 is moved out of lock recess when switch 1144 is pulled by a user. As described in more detail with reference to switch assembly 1450, such movement causes drilling assembly 16 to move slightly rearward along guide rods 90 of drill guide assembly 18 so to cause switch assembly 1450 to engage drill motor 70 and give the user the impression that the switch 1144 engages drill motor 70 directly.

### Bias Member 200:

In one or more arrangements, system 10 includes a bias member 200. Bias member 200 is formed of any suitable size, shape, and design and is configured to attach to and between components of drill guide assembly 18 and drilling assembly 16 and provide a bias force between drill guide assembly 18 and drilling assembly 16 sufficient to move drilling assembly 16 to a retracted position in the absence of an opposing rearward/downward force (e.g., placed on drilling assembly 16 by actuating assembly 20). In the arrangement shown, as one example, bias member 200 is a spring positioned on one of guide rods 90. In this example arrangement, the bias member 200 is configured to engage a forward surface of guide block 88 (e.g., front 988 of main body 980 of guide block segments 974) or drill guide assembly 18 and engage a rearward surface of collar assembly 74 and/or other component of system 10, to move drill guide assembly 18 and drilling assembly 16 away from each other. In various arrangements, bias member 200 may utilize various mechanisms to move drill guide assembly 18 and drilling assembly 16 away from each other including but not limited to, for example, one or more springs, one or more gas pistons, one or more gas springs, one or more hydraulic pistons, one or more actuators, one or more solenoids, one or more pneumatic members, and/or any other force generating means or combination thereof.

### Rear Handle Assembly 22:

Rear handle assembly 22 formed of any suitable size, shape, and design and is configured to facilitate secure holding and control of system 10 by a user during operation. In the arrangement shown, as one example, rear handle assembly 22 includes a handle 222 configured to operably connect with housing 26 and/or base assembly 14. In the arrangements shown, as one example, rear handle assembly 22 and housing 26 are formed as a unitary member. However, embodiments are not so limited. Rather, it is contemplated that in some arrangements housing 26 may be formed separate from rear handle assembly and/or may be omitted in part or entirely. When formed as separate components rear handle assembly 22 and housing 26 may be connected together using various means and methods known in the art including but not limited to, for example, adhesive bonding, chemical bonding, welding, and/or mechanical attachment means such as screws, bolts, threading, interlocks, latches, clips, pins, or other coupling devices.

### Handle 222:

Handle 222 is formed of any suitable size, shape, and design and is configured to provide a firm hand hold for a user to position and hold system 10 during operation for drilling pocket holes. In the arrangement shown, as one example, handle 222 is a generally loop shaped handle having a central section 290 extending between a pair of side sections 292. In this example arrangement, central section 290 has an elongated cylindrical shape extending horizontally between opposing ends 296, where central section 290 connects to side sections 292. In this example arrangement, each side section 292 has an elongated generally planar tapered shape extending downward from a narrow upper end 298, where side section 292 connects to central section 290, to a wider lower end 300, where side section 292 connects to base assembly 14 and/or housing 26.

In this example arrangement, lower ends 300 of side sections 292 of handle 222 connect to housing 26 at rearward side corners of housing 26. However, the embodiments are not so limited. Rather, it is contemplated that handle 222 may be located at any position on housing 26 or any other position of system 10. Furthermore, it is contemplated that handle 222 may be implemented using various different types of handgrips including but not limited to horizontal handgrips, vertical handgrips, knobs, wheels, loops, and/or any other type of handle or handgrip.

### Housing 26:

Housing 26 is formed of any suitable size, shape, and design and is configured to engage a base assembly 14 and cover and interconnect various components of system 10. In the arrangement shown housing 26 has a contoured shaped generally forming a rear enclosure 1300, front enclosure 1302, sidewalls 1304, and a bracket cover 1306. In various different arrangements, housing 26 may be connected to base assembly 14 in various means and/or methods including but not limited to adhesive bonding, chemical bonding, welding, and/or mechanical attachment means such as screws, bolts, threading, interlocks, latches, clips, pins, or other coupling devices.

Rear enclosure 1300:

Rear enclosure 1300 is formed of any suitable size, shape, and design and is configured to engage a rearward end of base assembly 14 end and cover guide block 88 and rear adjustment assembly 516 among other components positioned at a rearward end of base assembly 14. In the arrangement shown, as one example, rear enclosure 1300 has a contoured shape generally having a back 1312, a top 1314, and opposing sides 1316.

### Passageway 1320:

In this example arrangement, rear enclosure 1300 includes a passageway 1320 in rear enclosure 1300 extending from opening 1018 in drill bit guide housing 972 to an opening 1322 in a side 1316 of rear enclosure 1300. Passageway 1320 is formed of any suitable size, shape, and design and is configured to facilitate removal of drill shavings and chips created when drilling. In this example arrangement, passageway 1320 is a generally rectangular opening formed by a pair of walls 1324 extending downward from top 1314 along sides of opening 1322 to a bottom 1328. During operation, drill bit 58 moves wood chips and shavings with velocity sufficient to eject wood chips and shavings out through opening 1038 of drill bit guide 106, through opening 1018 in drill bit guide housing 972, through passageway 1320 and out through opening 1322. In one or more arrangements, bottom 1328 of passageway 1320 slopes upward as bottom 1328 extend outward from opening 1038 to a peak 1330 and slopes downward as bottom 1328 extends outward from peak 1330 to opening 1322. The peak 1330 is positioned so the velocity of wood chips and shavings through passageway 1320 beyond peak 1330. The downward slope of bottom 1328 outward of peak 1330 helps prevent wood chips and shavings from moving back inward toward opening 1038 of drill bit guide housing 972 and helps move wood chips and shavings outward and through opening 1322. While some arrangements, may be illustrated as having passageway 1320 positioned on the right side of system 10, the arrangements are not so limited. Rather it is contemplated that in some arrangements, passageway 1320 may be positioned and arranged to move wood chips and shavings out to an opening on the left side of system 10 or in any other location.

### Dust Collector 1326:

In one or more arrangements, system includes a dust collector 1326 for use with passageway 1320. Dust collector 1326 is formed of any suitable size, shape, and design and is configured to operably connect with system 10 proximate to opening 1322 and receive and hold dust and shavings transported through passageway 1320. In some various example arrangements, dust collector 1326 may be implemented using various means and methods for removing and/or collecting dust from an airflow but not limited to, for example, filters (e.g., a dust bag or vacuum bag), centrifugal separators, bins, baskets, and/or any other method of means for separating and/or collecting dust and debris.

As an illustrative example, in one or more arrangements shown, dust collector 1326 is a bin type dust collector configured to attached to system and collect dust and debris that is moved through opening. In this illustrative example, dust collector 1326 has a generally rectangular shape having a top 1500, bottom 1502, front 1504, back 1506, and opposing sides 1508. In this example, dust collector 1326 has an inlet opening 1510 in one side 1508 positioned in alignment with opening 1322 in side 1316 of rear enclosure 1300. In one or more arrangements, dust collector 1326 may also include an overflow opening 1514 in side 1316 to permit excess dust and debris to be expelled from dust collector 1326 when full and thereby help prevent dust and debris from backing up and clogging passageway 1320.

Additionally or alternatively, in some arrangements dust collector may include a connector configured to facilitate connection of a vacuum to system to provide a fluidic connection between passageway 1320 and a vacuum tube (not shown) to facilitate removal of wood chips and shavings generated during drilling.

### Front Enclosure 1302

Front enclosure 1302 is formed of any suitable size, shape, and design and is configured to engage a forward end of base assembly 14 end and house and interconnect components of front support assembly 608. In the arrangement shown, as one example, front enclosure 1302 has a center section 1332 extending between a pair of side sections 1334. In this example arrangement, center section 1332 has a generally rectangular block shape having a front 1338, a back 1340, and a top 1342 extending between the side sections 1334. In this example arrangement, side sections 1334 have a contoured semi-rectangular block shape having a front 1346, a back 1348, opposing sides 1350, and a top 1352.

### Sidewalls 1304:

Sidewalls 1304 are formed of any suitable size, shape, and design and are configured to connect front enclosure 1302 and rear enclosure 1300 of housing 26. In the arrangement, shown, sidewalls have a generally planar rectangular shape extending between an upper edge 1356 and a lower edge 1358 from a forward end 1360, where sidewalls 1304 connect with side sections 1334 of front enclosure 1302, to a rearward end 1362, where sidewalls 1304 connect with sides 1316 of rear enclosure 1300.

### Bracket Cover 1306:

Bracket cover 1306 formed of any suitable size, shape, and design and is configured to cover a fulcrum bracket 150 of actuating assembly 20 among other components positioned forward or rear enclosure 1300. In the arrangement shown, as one example, bracket cover 1306 has a contoured U-shape, when viewed from the top, generally having a front 1368, a back 1370, a top 1374 and opposing sides 1372. Bracket cover 1306 is configured to cover over fulcrum bracket 150 to give system an aesthetically pleasing appearance without interfering with operation of system 10. However, the embodiments are not so limited. Rather, it is contemplated that bracket cover 1306 may have any alternative shape that does not interfering with operation of system 10 and/or may be omitted in one or more arrangements.

### Adjustable Lip Assembly 24:

It should be understood that the proper distance from a rearward edge of workpiece 12 at which a pocket hole should be drilled depends on the thickness of the workpiece 12. Generally speaking, as thickness of a workpiece 12 increases, pocket holes should be drilled further away from the rearward edge of the workpiece 12. Conversely, as thickness of a workpiece 12 decreases, pocket holes should be drilled closer to the rearward edge of the workpiece 12. In the example arrangement shown, lip assembly 24 is adjustable (adjustable lip assembly 24) to position front 520 of sliding lip member 510 closer to or further away from drill bit opening 50, at which drilling assembly 16 is configured to drill pocket holes.

Adjustable lip assembly 24 is formed of any suitable size, shape, and design and is configured to facilitate proper positioning of system 10 on workpiece 12 for drilling of pocket holes for workpieces of different thicknesses. In one or more arrangements, adjustable lip assembly 24 has a sliding lip member 510 that is configured be slidable forward and backward to facilitate repositioning of sliding lip member 510. In an arrangement shown, as one example, adjustable lip assembly 24 includes a sliding lip member 510, a lip support frame 508, a set of guide members 512, a drill stop assembly 514, and a rear adjustment assembly 516, among other components.

### Sliding Lip Member 510:

Sliding lip member 510 is formed of any suitable size, shape, and design and is configured to provide a surface configured to engage a rearward edge for workpiece 12 to facilitate positioning system 10 to drill pocket holes at a proper distance from the rearward edge of workpiece 12. In the arrangement shown, as one example, sliding lip member 510 has an elongated shape having a front 520, a rear 522, a top 524, a bottom 526 extending between opposing ends 528. In this example arrangement, rear 522 of sliding lip member 510 is angled forward from top 524 to bottom 526. In the arrangement shown, as one example, sliding lip member 510 is operably connected to lip support frame 508

### Lip Support Frame 508:

Lip support frame 508 is formed of any suitable size, shape, and design and is configured to operably connect sliding lip member 510 with guide members 512. In the arrangement shown, as one example, lip support frame 508 has an elongated angled shape having front flange 1216 and a top flange 1218 connected at a 90-degree angle and extending between opposing ends.

In this example arrangement, front flange 1216 has a generally planar trapezoidal shape, when viewed from the front, having a wider upper edge 1220, a narrower lower edge 1222, and sloped side edges 1224. In this example arrangement, front flange 1216 include a cutaway portion 1226 extending upward from lower edge 1222 at approximately a center point between the side edges 1224. The cut away portion 1226 permits a drill bit 58 to extend outward from an end of workpiece 12, when drilling pocket holes, without the drill bit 58 engaging lip support frame 508.

In this example arrangement, top flange 1218 has a generally planar rectangular, when viewed from the top, extending between a rearward edge 1230 and a forward edge 1232, connected to upper edge 1220, between opposing side edges 1234. In this example arrangement, lip support frame 508 includes tabs 1238 extending upward from side edges 1234 of top flange 1218 to upper edges 1240, where lip support frame 508 connects with guide members 512.

### Guide Members 512:

Guide members 512 are formed of any suitable size, shape, and design and are configured to reposition lip support frame 508 and sliding lip member 510 to various positions to facilitate drilling of pocket holes for workpieces 12 of different thicknesses. In the arrangement shown, as one example, guide members 512 each have an elongated angle stock shape having a bottom flange 1246 and a side flange 1248 connected at a 90-degree angle and extending from a front end 1250 to a rear end 1252, where guide members 512 are connected to upper edges 1240 of tabs 1238.

In this example arrangement, side flange 1248 has an elongated generally planar shape extending between an upper edge 1260 and a lower edge 1262, where side flange 1248 is connected to outer side edge 1254 between the front end 1250 and rear end 1252 of the guide member 512. In this arrangement, a set of teeth 1266 are cut into upper edge 1260 proximate to front end 1250 of side flange 1248 of guide members 512 to facilitate adjustment of position of lip support frame 508 and sliding lip member 510.

In the arrangement shown, as one example, bottom flange 1246 has an elongated generally planar rectangular shape extending between an inner side edge 1256 and outer side edge 1254 between the front end 1250 and rear end 1252 of the guide member 512. In this example arrangement, bottom flange 1246 includes slots 1258 to facilitate operable connection of guide members 512 with base assembly 14 or other component (e.g., by fasteners extending through slots 1258) while permitting guide members 512 to move forward and rearward to facilitate adjustment of lip support frame 508 and sliding lip member 510.

In the arrangement shown, as one example, the guide member 512 on the left has a bracket 1270 positioned at the front end 1250 of the guide member 512 to facilitate connection of a drill stop assembly 514 to the guide member 512. In the arrangement shown, as one example, the bracket 1270 includes a generally planar tab 1272 that extends rightward between a forward edge 1274 and rearward edge 1276 from inner side edge 1256 of bottom flange 1246 to a rightward edge 1278. In this example arrangement, the bracket 1270 also includes a flange 1282 extending upward from rightward edge 1278 to an upper edge 1284. In this example arrangement, flange 1282 and side flange 1248 of the left one of the guide members 512 includes holes 1286 to facilitate connection with drill stop assembly 514.

### Drill Stop Assembly 514:

Drill stop assembly 514 is formed of any suitable size, shape, and design and is configured to set a lowest position that drilling assembly 16 can move along drill guide assembly 18 to set appropriate drilling depth for drilling pocket holes for different thicknesses of workpieces 12. In this example arrangement, drill stop assembly 514 includes an arch shaped brace 1290 attached to a rear end 1252 of the left one of the guide members 512 attached to lip support frame 508 and sliding lip member 510 and configured to extend over one of the guide rods 90 when installed. That is to say, a lower rearward end of the guide rod 90 extends under and through the arch and into guide rod support 982.

In this example arrangement, when actuating assembly 20 moves drilling assembly 16 downward and forward along drill guide assembly 18, a forward end of extendable brace 950 of stop adjustment assembly 856 of collar assembly 74 eventually contacts a forward surface of drill stop assembly 514, which prevents drilling assembly 16 from being moved further downward and forward along drill guide assembly 18. In this manner, drill stop assembly 514 and stop adjustment assembly 856 set the lowest position that drilling assembly 16 is permitted to move and thereby set drilling depth. However, the embodiments are not so limited. Rather, it is contemplated that in some various arrangements, drill stop assembly 514 may be configured to engage various other components of or be operably connected to drilling assembly 16 to set a drilling depth.

### Rear Adjustment Assembly 516:

In the example arrangement shown, as one example, adjustable lip assembly 24 includes a rear adjustment assembly 516. Rear adjustment assembly 516 is formed of any suitable size, shape, and design and is configured to facilitate simultaneous adjustment of a position of sliding lip member 510 and drill stop assembly 514 of adjustable lip assembly 24 to configure system 10 for drilling pocket holes in workpieces 12 of various thicknesses.

In the arrangement shown, as one example, rear adjustment assembly 516 includes a shaft 578 operably connected to base assembly 14 by brackets 586, a knob 580 connected on shaft 578, pinion gears 582 connected to shaft 578, and racks 584 operably connected to guide members 512 of adjustable lip assembly 24, among other components. In this example arrangement, racks 584 includes teeth 1266 formed on upper edge 1260 of guide members 512. In this example arrangement, pinion gear 582 has teeth positioned to engage teeth 1266 of rack 584. When knob 580 is rotated, shaft 578 and pinion gears 582 are rotated, which causes guide members 512 to move forward or rearward. Movement of guide members 512 forward or rearward causes lip support frame 508, sliding lip member 510, and drill stop assembly 514 to be moved forward or rearward to reposition lip support frame 508, sliding lip member 510, and drill stop assembly 514 for drilling pocket holes in workpieces 12 various thicknesses.

In one or more arrangements, knob 580 and housing 26 (or other components) include indica 588 (not shown) indicating positions at which knob 580 should be positioned for a plurality of different workpiece 12 thicknesses. In one example arrangement, indica 588 may indicate positions for 1 inch, ¾ inch, and ½ inch thicknesses, for example. However, the arrangements are not so limited. Rather, it is contemplated that in one or more arrangements, indica 588 may include marking for any number of different thicknesses.

In one or more arrangements, rear adjustment assembly 516 includes a lock assembly 590. Lock assembly 590 is formed of any suitable size, shape, and design and is configured to prevent unintended rotation of shaft 578. In this example arrangement, lock assembly 590 includes a feature 596 of knob 580 configured to engage one or more features 598 in a channel 604 formed in housing 26 or on another component. In this example arrangement, feature 596 is a protrusion extending inward to the side of knob 580 configured to be received in channel 604. In this example arrangement, features 598 in channel 604 are recess type features configured to receive and hold protraction feature 596 in place until sufficient rotational force is applied to knob 580 by a user.

In Operation:

System 10 is first adjusted based on thickness of the workpiece 12 for which pocket holes will be drilled. Sliding lip member 510 of adjustable lip assembly 24 is moved to a position forward and/or rearward on system 10 corresponding to the desired workpiece 12 thickness. In one or more arrangements, for example, the correct position for a desired workpiece 12 thickness may be set by moving knob 580 of rear adjustment member 516 to align with measuring indica 588 (not shown) on the base assembly 14, rear handle assembly 22, or other component of system 10 and simultaneously move sliding lip member 510 and drill stop assembly 514 into the correct positions for the workpiece thickness.

Once sliding lip member 510 and drill stop assembly 514 is in position, lower surface 40 of plate 30 and/or grip pad(s) 34 of system 10 are placed on workpiece 12 with a front 520 of sliding lip member 510 (or front 520 of sliding lip member 510) positioned flush against a rearward edge of workpiece 12. System 10 is then moved sideways as required to position drill bit opening 50 at the desired location for formation of a pocket hole.

Once system 10 is positioned on workpiece 12 to drill a pocket hole in the desired location, the user commences drilling. In this example arrangement, to commence drilling, the user holds handle 222 of rear handle assembly 22 in one hand and holds handle 154 of actuating assembly 20 with the user's other hand. At this time, handle 154 is in the most rearward most position and drilling assembly 16 is in a fully retracted position.

In this example arrangement, the user presses and holds safety switch 1146 to unlock switch 1144 and pulls switch 1144 to disengages lock mechanism 1152 of actuating assembly 22 to permit lever 152 to be moved forward. In one or more arrangements, lock mechanism 1152 is configured to cause drilling assembly to move slightly rearward along guide rods 90 when lock mechanism 1152 is disengaged. Such movement of drilling assembly 16 causes switch assembly 1450 to engage drill motor 70 and give the user the impression that the switch 1144 engages drill motor 70 directly.

With drill motor 70 running, the user moves handle 154 connected to first end 190 of lever 152 of actuating assembly 20 forward, away from the user. As handle 154 is moved forward, lever 152 pivots about pivot connection 194, where lever 152 is connected to fulcrum assembly 150. As lever 152 pivots, second end 192 of lever 152 is moved rearward toward the user. An operable connection between second end 192 of lever 152 and drilling assembly 16 applies force to the drilling assembly 16 to counter force applied by bias member 200 and move drilling assembly 16 rearward and downward along guide rods 90 of drilling guide assembly 18.

At the same time, movement of handle 154 forward causes a downward force to be transferred through the fulcrum assembly 150 to the plate 30 of base assembly 14 and/or grip pad(s) 34. This downward force helps to prevent system 10 from being unintentionally moved from the desired position during the drilling process. Additionally or alternatively, in one or more arrangements, movement of handle 154 forward causes a lateral force to be transferred through the fulcrum assembly 150 and other components of system 10 to sliding lip member 510. This forward force similarly helps to prevent system 10 from being unintentionally moved from the desired position during the drilling process.

As drilling assembly 16 is moved rearward toward the user, drill bit 58 that is connected in chuck 72 of drilling assembly 16 is moved through drill bit guide 106 and extended through drill bit opening 50 in plate 30 of base assembly 14. As drill bit 58 extends though drill bit opening 50 below a lower surface 40 of plate 30 and/or grip pad(s) 34, drill bit 58 begins drilling a pocket hole in the workpiece 12. As the user continues to move handle 154 forward, the drilling assembly 16 continues to be moved rearward and downward along guide rods 90 of drilling guide assembly 18, causing drill bit 58 to drill deeper into workpiece 12. Drilling continues in this manner until extendable brace 950 of stop adjustment assembly 856 of drilling assembly 16 encounters drill stop assembly 514, at which point drilling assembly 16 is prevented from drilling any deeper into the workpiece 12. Upon extendable brace 950 of stop adjustment assembly 856 encountering drill stop assembly 514, the user then moves handle 154 rearward to cause drilling assembly 16 to be moved forward and upward along guide rods 90, thereby retracting drill bit 58 back through drill bit opening 50. With drilling assembly 16 reaches the fully retracted position and user releases switch 1144, lock mechanism 1152 reengages and switch assembly 1450 to turns off drill motor 70.

While arrangements are primarily described with reference to user positioned rearward of system 10 and moving handle 154 forward away from the user to drill a pocket hole, the embodiments are not so limited. Rather, it is contemplated that in one or more arrangements, system 10 may be configured for a user to be positioned in front of system 10 and pull handle 154 toward the user to drill a pocket hole.

### Front Support Assembly 608:

In the example arrangement shown, system 10 includes a front support assembly 608. Front support assembly 608 is formed of any suitable size, shape, and design and is configured to support a front end of system 10, proximate to forward edge 44 of plate 30 in an elevated position above a worktable. Elevation of front end of system 10 may be useful, for example, when drilling pocket holes in narrow workpieces 12. When drilling pocket holes in narrow workpieces 12, it can be difficult to hold system 10 in a stable position with plate 30 flat against workpiece 12.

In the arrangement shown, as one example, front support assembly 608 includes a pair of extendable support legs that can be moved downward to hold the front end of system 10 at a desired height so system 10 is correctly positioned on workpiece 12 for drilling of pocket holes. In this example arrangement, front support assembly 608 includes support legs 612, leg guides 614, and a forward adjustment assembly 616 positioned within front enclosure 1302 of housing 26, among other components.

### Support Legs 612:

Support legs 612 are formed of any suitable size, shape, and design and are configured to move between an extended position and a retracted position and facilitate support of system 10 at an elevated position. In the arrangement shown, as one example, support legs 612 each have an elongated generally rectangular shape having a front 1380, a back 1382, an inner side 1384, and an outer side 1386, extending from an upper end 1388 to a lower end 1390. In the arrangement shown, as one example, outer side 1386 of support legs 612 has beveled edges.

In this example arrangement, front of support legs 612 includes guide channels 1394 formed in the front 1380 and back 1382 to facilitate tight engagement with leg guides 614 and inhibit wobbling. In this example arrangement, guide channels 1394 extend vertically along front 1380 and back 1382 from lower end 1390 to upper end 1388.

In this example arrangement, guide channels 1394 are configured to receive guide features 1408 of leg guides 614 to facilitate guided movement of front support legs 612 along leg guides 614. However, the embodiments are not so limited. Rather, it is contemplated that in one or more arrangements, support legs 612 may utilize of types of guide features and/or such guide features may be omitted.

In the arrangement shown, as one example, support legs 612 have a stop feature 1398 positioned at upper end 1388. Stop feature 1398 is formed of any suitable size, shape, and design and is configured to prevent upper end 1388 of support legs 612 from being removed from leg guides 614 when the system is fully assembled. In the arrangement shown, as one example, stop feature 1398 is a rectangular shaped protrusion that extends inward to the side from inner side 1384 of each support leg 612. In this example arrangement, stop feature 1398 is configured to catch on plate 30 of base assembly 14.

In the arrangement shown, as one example, support legs 612 include a connection feature 1400 positioned on upper end 1388 of support legs 612. Connection feature 1400 is formed of any suitable size, shape, and design and is configured to facilitate operable connection of support legs with bias members 1416 that are configured to move support legs 612 downward in leg guides 614 in absence of an opposing force.

In the arrangement shown, as one example, support legs 612 are formed of a hollow core construction having hollow cells 1402 formed by interconnecting support structures 1404 that extend between front 1380, back 1382, and outer side 1386. Such construction helps to reduce weight and material cost while retaining relatively high compression and sheer properties. However, the arrangements are not so limited. Rather, it is contemplated that in some various arrangements, support legs 612 may be formed of solid core construction without any cells 1402. It is understood that in some various arrangements, various other components of system 10 may similarly be formed with either hollow core construction or solid core construction

### Leg Guides 614:

Leg guides 614 are formed of any suitable size, shape, and design and are configured to facilitate movement of support legs 612 between the extended and retracted positions. In the arrangement shown, as one example, leg guides 614 are generally vertical channels or tracks positioned within side sections 1334 of front enclosure 1302. In this arrangement shown, as one example, leg guides 614 include a track 1406 positioned above openings 1410 in plate 30 through which support legs 612 extend when lowered to the extended position.

In this example arrangement, track 1406 has flange type guide features 1408 configured to engage guide channels 1394 of support legs 612 and thereby hold support legs 612 within track 1406. However, the embodiments are not so limited. Rather, it is contemplated that in some various arrangement may utilize any other method or means to guide support legs 612 upward and/or downward.

### Forward Adjustment Assembly 616:

Forward adjustment assembly 616 is formed of any suitable size, shape, and design and is configured to facilitate movement of support legs 612 between the extended and retracted positions to adjust elevation of the front end of system 10. In the arrangement shown, as one example, forward adjustment assembly 616 includes bias members 1416 and a clamp assembly 1418, among other components.

### Bias Members 1416:

Bias members 1416 are formed of any suitable size, shape, and design and are configured to move support legs 612 downward from leg guides 614 to the extended position in absence of an opposing force. In the arrangement shown, as one example, bias members 1416 are coil compression springs that connect with connection features 1400 on the upper ends 1388 of support legs 612. In this example arrangement, the bias members 1416 place downward force on upper ends 1388 to cause support legs 612 to move downward in absence of an opposing force. However, the embodiments are not so limited. Rather, it is contemplated that in some various arrangements, bias members 1416 may utilize various different mechanisms to move support legs 612 downward including but not limited to, for example, one or more springs, one or more gas pistons, one or more gas springs, one or more hydraulic pistons, one or more actuators, one or more solenoids, one or more pneumatic members, and/or any other force generating means or combination thereof.

### Clamp Assembly 1418:

Clamp assembly 1418 is formed of any suitable size, shape, and design and is configured to facilitate securing of support legs 612 in place at a desired height by a user. In the arrangement shown, as one example, clamp assembly 1418 includes a shaft 1422, a knob 1424 connected on shaft 1422, a set of cams 1426 connected to shaft 1422, and a set of clamp plates 1428 positioned between cams 1426 and support legs 612, among other components.

In this example arrangement, clamp assembly 1418 is configured to press clamp plates 1428 against support legs 612 and thereby clamp support legs in place when knob 1424 is rotated in a first direction. When knob 1424 is rotated in the first direction, shaft 1422 and cams 1426 are rotated. As cams 1426 rotate in the first direction, cams 1426 press against one side of clamp plate 1428 support legs 612, thereby pressing clamp plates 1428 against support legs 612 and thereby clamping support legs 612 in place. Conversely, rotation of knob 1424 in a second opposite direction causes cams 1426 to rotate in the opposite direction and release pressure from clamp plates 1428, thereby unclamping support legs 612.

The use of clamp plates 1428 between cams 1426 and support legs 612 prevents rotation of cams 1426 from moving support legs 612 up or down when being clamped or released. In this example arrangement, clamp plates 1428 are operably connected to housing 26 or other component of system at an upper end 1430 of clamp plates 1428. The connection of clamp plates 1428 to housing 26 prevents clamp plate 1428 from being moved downward or upward by rotation of cams 1426.

In the arrangement shown, as one example, support legs 612 may be moved to and clamped into place at an infinite number of positions between a fully extended position and a fully retracted position. Moreover, in this example arrangement, support legs 612 may be moved to and clamped into place at different heights. The ability to clamp support legs 612 at different heights may be useful for example, to provide stable support on a work bench that is uneven. However, the embodiments are not so limited. Rather, it is contemplated that in some arrangements front support assembly 608 may be configured to move and hold support legs 612 at a set fixed position.

In Operation:

When a user requires the front end of system 10 to be supported in an elevated position above a worktable, the user may simply rotate knob 1424 in the second direction to unclamp support legs 612. Upon unclamping, support legs 612 are extended downward by bias members 1416 until lower ends 1390 encounter the surface of the worktable. The user may then rotate knob 1424 in the first direction to clamp support legs 612 in place, thereby supporting front end of system 10. When support legs 612 are no longer needed, the user may rotate knob 1424 to unclamp support legs 612, move support legs 612 to the retracted position, and rotate knob 1424 to reclamp support legs 612 to hold support legs in the retracted position.

### Alignment Windows 690 and 692:

In one or more arrangements, system 10 includes one or more alignment windows 690. Alignment window(s) 690 are formed of any suitable size, shape, and design, and are configured to facilitate positioning of system 10 for drilling a pocket hole at a desired location on workpiece 12. In the arrangement shown, as one example, system 10 includes a first alignment window 690 having a cutout in rearward edge 46 of plate 30 to provide a view of an edge of the workpiece 12 while the workpiece 12 is positioned under system 10 for drilling.

In this example arrangement, an indicator 694 is positioned on sliding lip member 510 proximate to alignment window 690. In this example arrangement, the indicator 694 is aligned with drill bit 58 and is indicative of the position at which a pocket hole will be formed. In operation, a user may position system 10 on workpiece 12 so that a measurement mark on workpiece 12 (e.g., a pencil mark) is visible in alignment window 690 and is aligned with indicator 694. Indicator 694 may be formed of any suitable size, shape, and design, and is configured to indicate a lateral position at which a pocket hole will be drilled. In the arrangement shown, as one example, indicator 694 is formed by drill bit guide 106 of guide block 88. However, the embodiments are not so limited. Rather, it is contemplated that indicator 694 may be formed of any structure or marking including but not limited to, for example, markings (e.g., arrows, lines, and/or any other marking), engravings, recesses, protrusions, notches, blades, posts, dovetails, rings, recitals, laser or light projection, or any other type of indicator.

In the arrangement shown, as one example, alignment windows 690 additionally has edge indicators 696 provided by stairstep shaped cutouts in rearward edge 46 of plate 30. Edge indicators 696 of the stairsteps may be use, for example, to align a side edge of a workpiece 12 for drilling of pocket holes. For example, in one or more arrangements, edge indicators 696 are positioned and configured to facilitate drilling of pairs of pocket holes on the end of a workpiece 12 at equal distances from side edges of the workpiece 12. Edge indicators 696 may be particularly useful to facilitate alignment of system 10 on a workpiece 12 by touch rather than by sight.

In this example arrangement, system 10 includes a second alignment window 692 having a cutout in forward edge 44 of plate 30 to provide a view of an edge of the workpiece 12 while the workpiece 12 is positioned under system 10 for drilling. In this example arrangement, second alignment window 692 includes edge indicators 696 similar to those included in the first alignment window 690. Having an alignment window 690 and alignment window 692 may be useful to ensure that both the front and rear of system 10 are properly aligned.

As an illustrative example, in one or more arrangements, a user may use alignment window 690 and alignment window 692 to facilitate drilling a pair of pocket holes on an end of a narrow workpiece 12. This is often performed when drilling pocket holes in the end of elongated rails. In this example context, it is desirable to place two equally spaced pocket holes in the ends of the elongated rail. For instance, a user may line up edge indicators 696 on a right side of alignment window 690 and alignment window 692 with one side edge of the workpiece 12 to drill a first pocket hole a distance from a right edge. The user may then line up edge indicators 696 on a left side of alignment window 690 and alignment window 692 with the other side edge of the workpiece 12 to drill a first pocket hole a distance from a left edge

From the above discussion it will be appreciated that the disclosed system and method improves upon the state of the art. That is, in one or more arrangements, a handheld powered pocket hole drilling system and method of use is presented: that is easy to use; that is fast and efficient to use; that is portable; that is light weight; that is handheld; that is cost effective; that forms accurate pocket holes; that is safe to use; that has a durable design; that has a long useful life; that provides additional functionality for pocket hole jigs and pocket hole joinery; that has a wide variety of uses; that has a wide variety of applications; that prevents or reduces relative movement between the pocket hole jig and the workpiece; that avoids the need to clamp to the system to a workpiece; that facilitates the formation of aesthetically pleasing finished products; that forms a pocket hole with a single movement of a handle; that facilitates stable placement when used horizontally; that facilitates stable placement when used vertically; that facilitates easy removal of chips and debris during use; that is comfortable to use; that is more stable than other pocket hole jigs; that improves the ergonomics of use; and/or that easily adjusts to workpieces of various thicknesses among countless other advantages, improvements and features.

It will be appreciated by those skilled in the art that other various modifications could be made to the device without parting from the spirit and scope of this invention. All such modifications and changes fall within the scope of the claims and are intended to be covered thereby.

What is claimed is:

1. A powered pocket hole drilling system, comprising:
a base assembly;
the base assembly extending between a front end and a rear end;
the base assembly having a plate;
the plate having a drill bit opening extending through the plate;
a drilling assembly;
a drill bit connected to the drilling assembly;
a drill guide assembly;
the drill guide assembly operably connected to the base assembly and the drilling assembly;
wherein the drilling assembly is movable along the drill guide assembly to extend and retract the drill bit through the drill bit opening at an angle;
a front support assembly;
wherein the front support assembly includes a set of retractable support legs that can be moved downward between a retracted position and an extended position;
wherein the front support assembly is configured to hold the set of retractable support legs in the extended position to hold the front end of base assembly in a raised position above a worktable.

2. The system of claim 1, wherein the front support assembly is configured to hold the set of retractable support legs in place at an infinite number of positions between the extended position and the retracted position.

3. The system of claim 1, wherein the front support assembly includes a clamp assembly configured to clamp the set of retractable support legs in place.

4. The system of claim 1, wherein the front support assembly includes a clamp assembly configured to clamp the set of retractable support legs to hold the retractable support legs in place and unclamp from the set of retractable support legs to allow the set of retractable support legs to move between the retracted position and the extended position.

5. The system of claim 1, wherein the front support assembly includes a clamp assembly configured to clamp the set of retractable support legs to hold the set of retractable support legs in place and unclamp from the retractable support legs to allow the set of retractable support legs to move between the retracted position and the extended position;
wherein the front support assembly includes a set of bias members configured to move the set of retractable support legs to the extended position when the clamp assembly is unclamped from the set of retractable support legs.

6. The system of claim 1, wherein the set of retractable support legs are configured to separately move between the retracted position and the extended position independent of each other.

7. The system of claim 1, wherein the front support assembly includes a clamp assembly configured to clamp the set of retractable support legs in place;
wherein the clamp assembly includes a cam and a clamp plate positioned between the cam and one of the set of retractable support legs;
wherein rotation of the cam presses the clamp plate against the one of the set of retractable support legs thereby clamping the one of the set of retractable support legs in place.

8. A powered pocket hole drilling system, comprising:
a base assembly;
the base assembly having a plate;
the plate having a drill bit opening extending through the plate;
a lip operably connected to the plate;
a drilling assembly;
a drill bit connected to the drilling assembly;
a drill guide assembly;
the drill guide assembly operably connected to the base assembly and the drilling assembly;
wherein the drilling assembly is movable along the drill guide assembly between an extended position and a retracted position to extend and retract the drill bit through the drill bit opening at an angle;
an actuating assembly operably connected to the drilling assembly;
wherein the actuating assembly includes a lever and a first handle positioned on an upper end of the lever;
wherein when the first handle is moved away from the lip, the lever moves the drilling assembly toward the lip to the extended such that the drill bit extends through the drill bit opening;
a lock mechanism;
the lock mechanism configured to lock the lever in place when the drilling assembly is moved to the retracted position.

9. The system of claim 8, further comprising a first switch positioned on the first handle;
wherein the first switch is configured to unlock the lock mechanism and thereby permit the lever to move the drilling assembly away from the retracted position.

10. The system of claim 8, further comprising a first switch positioned on the first handle;
wherein the first switch is configured to unlock the lock mechanism and thereby permit the lever to move the drilling assembly away from the retracted position;
wherein the drilling assembly includes a motor;
wherein the drilling assembly is configured to turn on the motor when the drilling assembly is moved away from the retracted position.

11. The system of claim 8, further comprising a first switch positioned on the first handle;
wherein the first switch is configured to unlock the lock mechanism and thereby permit the lever to move the drilling assembly away from the retracted position;
wherein the drilling assembly includes a motor;
wherein the drilling assembly is configured to turn on the motor when the drilling assembly is moved away from the retracted position;
wherein when the first switch is pressed, the lock mechanism is configured to move the drilling assembly a distance away from the retracted position sufficient to cause drilling assembly to turn on the motor.

12. The system of claim 8, wherein the lock mechanism includes a guide member positioned in a track;
wherein the guide member is operably connected to a lower end of the lever;
wherein the track includes a lock recess;
wherein the lock recess is configured to prevent the lever from moving when the guide member is positioned in the lock recess.

13. The system of claim 8, wherein the lock mechanism includes a guide member positioned in a track;
wherein the guide member is operably connected to a lower end of the lever;
wherein the track includes a lock recess;
wherein the lock recess is configured to prevent the lever from moving when the guide member is positioned in the lock recess;
wherein the first switch is mechanically connected to the guide member by a link;
wherein when the drilling assembly is in the retracted position, pressing of the first switch causes the link to remove the guide member from the lock recess and releasing of the first switch causes the link to place the guide member into the lock recess.

14. The system of claim 8, further comprising a second switch connected to the first handle;
wherein the second switch is configured to prevent the first switch from being pressed unless the second switch is being pressed.

15. The system of claim 8, further comprising a second handle connected to a rear end of the plate.

16. A powered pocket hole drilling system, comprising:
a base assembly;
the base assembly having a plate;
the plate having a drill bit opening extending through the plate;
a lip operably connected to the plate;
a drilling assembly;
wherein the drilling assembly includes a motor;
a drill bit connected to the motor;
a drill guide assembly;
the drill guide assembly operably connected to the base assembly and the drilling assembly;
wherein the drilling assembly is movable along the drill guide assembly between an extended position and a retracted position to extend and retract the drill bit through the drill bit opening at an angle;
an actuating assembly operably connected to the drilling assembly;
wherein the actuating assembly includes a lever and a first handle positioned on an upper end of the lever;
wherein when the first handle is moved away from the lip, the lever moves the drilling assembly toward the lip to the extended such that the drill bit extends through the drill bit opening;
wherein the drilling assembly includes a switch assembly configured to turn on the motor when the drilling assembly is moved away from the retracted position;
wherein the switch assembly is configured to turn off the motor when the drilling assembly is moved to the retracted position.

17. The system of claim 16, wherein the drilling assembly includes a collar assembly configured to operably connect the motor to the drill guide assembly.

18. The system of claim 16, wherein the drilling assembly includes a collar assembly configured to operably connect the motor to the drill guide assembly;
wherein the collar assembly is configured to clamp onto the motor.

19. The system of claim 16, wherein the drilling assembly includes a collar assembly;
wherein the collar assembly has a lever to facilitate clamping of motor in the collar assembly to operably connect the motor to the drill guide assembly when the lever is moved to a first position;
wherein the collar assembly is configured to release the motor when the lever is moved to a second position, thereby providing easy removal of the motor from the system. wherein the collar is configured to clamp onto the motor.

20. The system of claim 16, wherein the drilling assembly includes a collar assembly operably connected to the drill guide assembly;
wherein the collar assembly has a lever to facilitate clamping of motor in the collar assembly to operably connect the motor to the drill guide assembly when the lever is moved to a first position;
wherein the collar assembly is configured to release the motor when the lever is moved to a second position, thereby providing easy removal of the motor from the system.
wherein the collar is configured to clamp onto the motor.

21. A powered pocket hole drilling system, comprising:
a base assembly;
the base assembly having a plate;
the plate having a drill bit opening extending through the plate;
a drilling assembly connected to the base assembly;
a drill bit operatively connected to the drilling assembly;
a window in the base assembly;
a drill guide assembly;
the drill guide assembly operably connected to the base assembly and the drilling assembly;
wherein the drilling assembly is movable along the drill guide assembly to extend and retract the drill bit through the drill bit opening at an angle;
wherein when the base assembly is placed on a workpiece, the window allows a user to see an area of the workpiece proximate to where a pocket hole will be drilled to facilitate positioning of the base assembly on the workpiece;
wherein the base assembly includes one or more indicators indicative of the position where the pocket hole will be drilled in the workpiece.

22. The system of claim 21, wherein the indicators are configured to facilitate alignment of the indicators with an edge of the workpiece by touch.

23. The system of claim 21, wherein the one or more indicators are provided by cutouts in the plate.

24. The system of claim 21, wherein the one or more indicators are provided by cutouts in the plate;
wherein the cutouts have the shape of a stairstep.

25. The system of claim 21, wherein the window allows the user to see the location where the drill bit enters the workpiece.
